(19) United States
(12) Patent Application Publication
(10) Pub. No.: US 2003/0085562 A1
(43) Pub. Date: May 8, 2003

(54) Modular passenger semi-trailer with pneumatic unipoint suspension

(76) Inventor: James Douglas Sparling, Denver, CO (US)

Correspondence Address: JAMES DOUGLAS SPARLING, PMB 118, 2075 SOUTH UNIVERSITY BOULEVARD, DENVER, CO, 80210, US

(21) Appl. No.: 10/284,939

(22) Filed: Oct. 31, 2002

Related U.S. Application Data
(60) Provisional application No. 60/335,934, filed on Nov. 2, 2001.

(51) Int. Cl. B62D 63/06

(52) U.S. Cl. 280/789

(57) ABSTRACT

A modular passenger semi trailer incorporating a vehicle construction technique in which the assembled passenger and alternate industrial embodiment modules observe structural strength, weight and balance and fail safe design considerations. The modular passenger semi trailer cabin module, including all interior seating and equipment, is assembled as a single unit upon a single, top, flat production joint face of the lower structure module, that module having a plurality of closed box beam compartments. A substantially sized cylinder compartment at the rear of the vehicle houses a pneumatically, reciprocally operative piston assembly containing a unipoint suspension which operates cooperatively with a wheel unit in the lower portion of the compartment. The wheel unit is captively located by a wheel shaft and cam block, swivel block external members, sandwiched, acting cooperatively within a forward and aft set of vertically disposed guideplates, the wheel unit operative along its vertical, longitudinal and lateral axis.

### BACKGROUND—CROSS REFERENCES TO RELATED APPLICATIONS

This application is entitled to the benefit of Provisional Patent Application serial No. 60/335,934 filed Nov. 2, 2001.

### BACKGROUND OF THE INVENTION

The non-provisional application has been submitted on CD and hardcopy program listing versions. The CD files are arranged as follows:

(a) Cross-reference to related applications is ASCCROSS.DOC

(b) Federally sponsored research or development is ASCFEDSP.DOC.

(c) Sequence listing is ASCSEQLT.DOC.

(d) Background of the invention is ASCBACK.DOC.

(e) Brief summary of the invention is ASCSUMM.DOC.

(f) Brief description of the several views of the drawings and drawing reference numbers is ASCDRAW.DOC.

(g) Detailed description of the invention is ASCDESC.DOC.

(h) Abstract of the disclosure is PATABSTR.DOC.

(i) Claims is ASCCLAIM.DOC.

1. Background—Field of Invention

The present invention disclosed and claimed relates to a modular passenger semi-trailer with pneumatic unipoint suspension, especially to the construction thereof wherein the lower structure module, acting as a chassis, and the pneumatic unipoint suspension and wheel unit are all designed as an integral operational unit, supports the vehicle along its centerline and especially to the construction techniques for the semi-trailer cabin structure module, the lower structure module, pneumatic unipoint suspension and wheel unit therefor.

2. Background of the Invention

For purpose of definitions for this background discussion and for the following specifications for this invention, the term “module” refers to a manufacturing technique whereby a major structural assembly which is ready for final assembly will be joined to another major structural assembly which is ready for final assembly at a single, flat production joint location so as to form the final vehicle construct and this specific process is not to be confused with manufacturing techniques whereby numerous, smaller, subassembly ‘modules’ progressively go into the eventual creation of the major structural assembly itself. Further, the term “modular passenger semi-trailer” is very specific in that it refers to a fully operational passenger carrying vehicle which is designed to be towed along a road by a tractor and the modular passenger semi-trailer vehicle is constructed of two major structural modules which are originally mechanically assembled and weldably joined to one another upon a single, flat production joint so as to form the completed vehicle.

The terms “commercial vehicle” and “commercial vehicles” are used interchangeably and specifically and collectively relates to the prior art generally referring to freight semi-trailers, passenger semi-trailers, motorcoach busses, regular length and mini-busses and articulated busses. The background discussion will also focus in on one or more of these commercial vehicle types as certain prior art design features are explored.

The term “conventional suspension hardware” refers to the mechanical means by which a conventional suspension apparatus is attached to the vehicle chassis and/or to any other vehicle structure member by the use of conventional hardware such as nuts, bolts, studs, rivets, pins of various descriptions or axle attachment means of various descriptions, welds and any other mechanical devices or methods, any one of which might be used by any conventional suspension apparatus to attach itself to the vehicle chassis.

The term “conventional suspension apparatus” includes, but is not limited to, a wide range of prior art suspension components which may be generally described as leaf springs, coil springs, coil spring and shock absorber combinations, small air springs, air bags, flexible air diaphragms, torsion bars, various axle support mechanisms, pivotal hangar mechanisms, and any other suspension means, any one of which can be manufactured and formed from any combinations of metal, composites, rubber, other flexible materials or other non-flexible materials, which can functionally serve as a conventional suspension apparatus for the vehicle. By first meeting the test for using conventional suspension hardware, the continuing operational test for the identification of a conventional suspension apparatus would prove positive if a single wheel or dual wheel group would independently drop into a pothole in the road as it passes aver it. The term “non-conventional suspension apparatus” specifically relates to a suspension apparatus that collectively does not use any conventional suspension apparatus and does not use any conventional suspension hardware. By first meeting the test for not using conventional suspension hardware, the continuing operational test for the identification of a non-conventional suspension apparatus would prove positive if a single wheel or dual wheel group would not independently drop into a pothole in the road as it passes over it.

The terms “fixed axle” or “fixed through-axle” are used interchangeably and refers to an axle that is inflexibly supported by some vehicle structure, the axle providing the means for the installation of a commercially available brake unit, wheel(s) and tire(s).

The terms “pendulous longitudinal axis” and “datum line” are used interchangeable. The datum line for both the preferred and alternate embodiments refers to a design reference line that extends from the forward located oversized diameter king pin which is centrally positioned within the forward overhanging towplate portion of the vehicle, the vertical point of the datum line being the height of the flat plate contact of the fifth wheel device where it contacts the lower surface of the towplate portion of the semi-trailer, whereby the datum line extends to the rear of the vehicle at a height which is parallel to the ground surface. The comparable datum line for prior art articulated busses, motorcoach busses and regular length and mini-busses is a relative design reference line that runs parallel to the ground surface for the length of the vehicle and whose height is established by the highest vertical point where the conventional suspension apparatus is mechanically attached to the vehicle chassis by conventional suspension hardware. As a matter of procedure, the vertical center of gravity point for the vehicle is compared to its position relative to the vehicle datum line, thereby establishing whether the vertical center of gravity point is in an unstable position above the datum line or whether the vertical center of gravity point is in a stable position below the datum line.

The terms “weight and balance” and “center of gravity” are used interchangeably. A vehicle weight and balance checking procedure is designed to locate a center of gravity point which is a theoretical single reference balance point that occurs somewhere within the volume envelope of the vehicle. The center of gravity point for a fully assembled and equipped vehicle can be different from that of a fully assembled and equipped vehicle with a full passenger load, the first situation defining a manufacturing weight and balance objective while the second situation defining an operational weight and balance objective for the vehicle. In either case, the center of gravity will be located at an intersecting point somewhere along the vehicle longitudinal roll axis which has a front-to-back direction, somewhere along the vehicle lateral axis which has a sideways direction, and somewhere along the vehicle vertical axis which has a bottom-to-top direction. The center of gravity point for the vehicle may be identified by mathematical means or by actual weight and balance means by use of scales, commercial weight and balance equipment or by other mechanical weight measurement means.

Much like the manufacturing procedures used in commercial aviation manufacturing, the land vehicle manufacturing process has the opportunity to evaluate each structural and equipment component before it goes into the construction of a land vehicle. Vehicle components and structural members can be physically weighed before it is assembled or installed so as to progressively determine the weight and balance characteristics of the vehicle and it associated center of gravity point as it develops during the manufacturing process. During both the manufacturing and operational phases, a perfectly balanced vehicle could be theoretically supported at the finalized center of gravity point and the vehicle lower surface would remain parallel to the ground.

The terms “fail-safe”, “crashworthy”, “crashworthiness” and “alternate path loading” are a variety of commercial aviation design and manufacturing terms that are used interchangeably by these specifications and are closely related in a very practical sense. Fail-safe denotes an original design protocol which anticipates the failure of certain components, systems and structural portions of a vehicle in that once the anticipated failure actually occurs, a backup component, system or alternate structural loading path is already in place so as to handle the unexpected failure event. The term “alternate path loading” specifically defines a structural fail-safe procedure whereby should a primary load bearing member fail to carry its designed load, an alternate structural member will be available in an adjacent structure which will assume the loading, thereby preventing a vehicle failure. Having an increasing number of fail-safe features originally incorporated into a vehicle makes the vehicle increasingly crashworthy, a term that is also commonly used in the commercial aviation design and manufacturing industry.

The terms “braking recoil”, “acceleration recoil” and “operational recoils” all refer to an operational characteristic of conventional suspension apparatus whereby when a vehicle is braked to a stop and once the wheels of the vehicle have stopped rotating, the vehicle chassis and the upper structure that the suspension supports, continues to spring forward for a short distance and then recoil backwards once the mechanical forward limit of the suspension is reached. In the alternate situation for conventional suspension apparatus, when a vehicle is accelerated and due to the inertia of the vehicle chassis and the upper structure that the suspension supports, the vehicle recoils in a forward direction once the mechanical aft limit of the suspension is reached. The recoil characteristic is best visualized with a city bus loaded with standing passengers who are jolted either forward or aft during either braking or acceleration events.

The term “passenger semi trailer prior art” specifically relates to U.S. Pat. No. 1,226,958, Fageol, U.S. Pat. No. 1,226,595, Fageol, U.S. Pat. No. 1,588,394, Winn, U.S. Pat. No. 1,814,640, Slade, U.S. Pat. No. 1,917,396, Schantz, U.S. Pat. No. 1,964,778, Yost, U.S. Pat. No. 1,980,613, Curtiss and U.S. Pat. No. 2,315,688, Crawford. The terms “articulated bus prior art” refers to U.S. Pat. No. 4,342,370, Hagin and U.S. Pat. No. 5,452,912, Boucquey.

3. Prior Art

In all, this subclass has been substantially inactive and the design features for these passenger vehicles are effectively outdated with the possible exception of U.S. Pat. No. 5,452,912, Boucquey, which was patented in 1995.

The existing prior art has not improved on the problem of high vehicle centers of gravity. One example of a semi-trailer with a high vertical center of gravity point would be U.S. Pat. No. 4,397,496, Drygass III, which is designed as a combination passenger and automobile transport vehicle. Fully occupied motorcoach busses suffer a similar operational problem where the passenger seating is higher, e.g. a center of gravity point which may be five to six feet above the road surface as compared a regular bus and articulated bus configurations which have a somewhat lower center of gravity point. Motorcoaches, for example, many having a maximum 56 passenger seating capacity, would have a 9800 pound passenger load, the center of gravity for that maximum passenger loading occurring approximately 26 inches above the floorline of the vehicle, and so, the empty manufactured vehicle weight and the operational vehicle weight considerations are not addressed by commercial vehicle patent specifications and claims. Two prior art semi-trailer designs, U.S. Pat. No. 1,917,396, Schantz and U.S. Pat. No. 2,315,688, Crawford, both briefly allude to a low vehicle center of gravity based due to the low vehicle floor, however the claims do not specify this design feature and the concept presented by both inventors only relates to an empty manufactured vehicle.

For purposes of computational comparison, the Federal Aviation Administration (FAA) sets a 175 pound weight standard for the average passenger for the purposes of computing weight and balance characteristics of an aircraft, both during the manufacturing and operational phases. Using that same average passenger weight standard for passenger semi-trailers, articulated busses, motorcoach busses and regular busses, we can calculate the passenger load by the number of seats within the vehicle. Further, the average location of the center of gravity for a seated passenger occurs at the waist line, thus the total passenger load and the average location of the center of gravity for that passenger load is now a known factor which will produce an updated weight and balance analysis for a fully occupied passenger vehicle. Therefore, the empty vehicle cited by U.S. Pat. No. 1,917,396, Schantz, has a passenger seating capacity of 31 which would amend the operating center of gravity for the vehicle substantially upward due to the 5425 pound passenger load. An identical operating weight amendment for U.S. Pat. No. 2,315,688, Crawford, must also be made for the 21 seating arrangement which would amend the operating center of gravity for the vehicle substantially upward due to the 3675 pound passenger load.

Both prior art groupings do not utilize high strength bulkheads which could be an important component in a cabin rollcage structure, all of which could act as redundant structures should the cabin portions of the vehicle experience a rollover event, further the two prior art groups do not employ high strength cabin sideplates which will provide a higher level of crashworthiness in side impact events. Notably, the lightweight vehicle frame structure design criteria as illustrated by U.S. Pat. No. 5,577,793, Kobasic, is not crashworthy. Another example of a lightweight vehicle cabin structure is illustrated by U.S. Pat. No. 5,066,067, Ferdows, is also not crashworthy. In both patents, there is no high strength internal rollover structure which includes high strength cabin formers, high strength cabin bulkheads and no high strength cabin sideplates, any of which are mentioned in either the specifications or the claims of those two patents.

Further, lightweight passenger vehicle frame construction is easily prone to lengthwise torsional distortions for a vehicle that is largely manufactured of formed transverse, vertical and lengthwise sheetmetal channel members as described in U.S. Pat. No. 4,254,987, Leonardis, a design which is equally not a crashworthy. Even high strength, heavy structural steel channel members, such as are found on the chassis of semi-trailer tractor units, are specifically designed to normally and substantially flex under torsional loading, thus, a comparatively lightweight load bearing amalgam of sheetmetal channel member(s) that is central to the overall strength of a passenger cabin structure is marginally effective at best. Continuing, the articulated omnibus U.S. Pat. No. 4,342,370, Hagin et al, also fails to mention a crashworthiness design criteria in its specifications and claims.

Additionally, since the floor members of commercial vehicles forms the major load bearing structure for the entire vehicle, the top view of an articulated bus chassis frame of U.S. Pat. No. 5,452,912, Boucquey, clearly illustrates this lightweight floor construct concept. Here, we see a lightweight vehicle construction which features a latticed floor structure, a major portion having projecting and unsupported cantilever members. Although this is a successful design in that it is very low to the ground for ease of passenger access, it can also be prone to vehicle length torsional distortions that can easily exceed the design criteria of its rotary junction member. Yet, as the background discussion clearly indicates, such a low-level floor design feature restricts the structural strength of the vehicle, hence the crashworthiness of this passenger vehicle is not addressed in either the specifications or the claims. U.S. Pat. No. 5,934,739, Waldeck, describes a vehicle skeleton frame which has two upper cabin vehicle-length channel beams that acts as structural members and the summary portion of the patent notes the rollover contingency. However, since formed lightweight sheetmetal channel beams are easily subject to lengthwise torsional distortions and the vehicle structure, as described in the patent, lacks any mention of high strength cabin formers, high strength cabin bulkheads and high strength cabin sideplates in the specifications and claims, the vehicle does not have a fail-safe, crashworthiness design.

Further, much like the semi-trailer prior art and articulated bus prior art, the vehicle-length sidewall modules in Waldeck limit the vehicle design to the conventional straight sided cabin and do not provide a method for creating variable contoured exterior profiles for the vehicle cabin. Waldeck also employs a novel series of extruded vehicle length push-fit assembly joints which require expensive tooling to create, rather than employing a single, flat production joint face for creating a vehicle. In a similar straight sided cabin design, U.S. Pat. No. 4,254,987, Leonardis, displays a modular cell building-block concept whereby a passenger bus may be constructed to any length by the progressive attachment of cells, one to another. In this arrangement, the joined cells form a box section hoop, the junction of which is equivalent to a strong cabin former member. Integral with the floor portion of the box section hoop is a open-sided box section floor portion that is about one-third the width of the floor dimension. Although the floor box section is vehicle-length, its narrow construct does not extend laterally and support the transverse end frames at their lowermost attachment to the lower longitudinal stringer for that cell. What is most obvious with this narrow box beam floor construction is that the outboard sections of the floor structure where seats should be placed simply does not provide any obvious structural attachment points for those seats which puts the issue of crashworthiness for that patent into serious question. Since the transverse end frame is not covered by a high strength lower cabin sideplate for side impact events, such an event would cause the cabin structure, stiffened by its roof members, to collapse in a sideways ‘trapezoidal’ fashion. Further, a vehicle rollover event could also cause a similar sideways cabin collapse.

Further still, a head-on collision event could cause a cabin collapse in a ‘domino’ fashion due to the weak lower transverse end frame joints. Additionally, this vehicle frame design lacks cabin bulkheads that would act as redundant structures in side impact events. Although each box section hoop is tied one to another with two upper vehicle length curved sheetmetal longitudinal members, there are no high strength vehicle length rolltubes that project through and are weldably attached to each box section hoop which would negate the need for the illustrated plurality of low strength formed sheetmetal members and their joints that presently stiffen both the box section hoops and its roof structure.

Finally, because there is no vehicle wide floorplate nor are there any high strength cabin sideplates which would essentially form a vehicle length channel stiffening structure to which the box section hoops could be welded, the vehicle is prone to longitudinal twisting much like any other lightweight vehicle frame. Although the eight prior art examples of semi-trailers do not give mention to a vehicle length closed box beam chassis structure in either their specifications or claims, that particular construct would be the optimum structure in that it would be immune to vehicle length twisting and bending distortions. Although it would be heavier than the prior art for commercial vehicles, it would totally eliminate the continual problems with chassis structural failures since all prior designs have focused on lightweight vehicle frames.

The attempts to design out chassis bending and lateral twisting problems are demonstrated by two prior art semi-trailer chassis designs by having a suspended structure at about the midway portion of the flatbed surface. Another modular semi-trailer vehicle would be U.S. Pat. No. 3,841,511 which requires a specially constructed tractor which accepts the first of two freight modules while the second freight module is connected with a simple tow bar, devoid of any anti-jacknife restraint system. One U.S. Pat. No. 2,346,130, Evans, describes an under-bed truss structure that is about one third the width of the flatbed which supports it. Created as a sleeping area for the truck driver for long trips, it has a minimal structural effect as compared to a preferred vehicle length closed box beam chassis structure. U.S. Pat. No. 3,884,502, Wagner, illustrates a mid-vehicle, open sided box beam member that is also suspended from the semi-trailer floorbed. In this instance, the box beam section is used to support a semi-trailer during an extended storage layover where the box beam section is held in location by ground block-type supports while the aft wheel unit is removed from the vehicle by the overinflation of the suspension air bags installation at the rear of the trailer. The semi-trailer chassis design for this invention is not a vehicle-length, closed box beam structure, consequently this chassis design is prone to bending at the junction where the flat-bed portion joins the central box beam portion of the vehicle with heavy loads. Further, because the flat-bed portion of the semi-trailer supports wheel units at each end, the conventional suspension apparatus used by those wheel units will exert both bending and torsional distortions upon the flat-bed portions of the vehicle, especially when it is heavily loaded and is travelling over uneven road surfaces.

One patent that comes closest to an optimally rectangularly cross-sectioned chassis having a vehicle length closed box beam chassis would be U.S. Pat. No. 3,254,914, Steck. With this vehicle, the cross-sectional design is a narrow depth, wide-span closed box beam structure which functions as the foundation for a mobile home. However, since the mobile home closed box beam underframe is only about a foot in height and all current versions of this design can range from 12 to 16 feet in width and up to 80 feet in length, it can be understood that this substantially sized structure can easily be distorted by uneven road surfaces even if it were constructed of metal members. This fact is confirmed in that virtually all mobile home foundational vehicle designs have one set of supporting wheels that are mounted at the midway point of the vehicle so as to not cause distortional damage as the mobile home is towed from place to place. As the drawings for Steck shows, the design has two vehicle-length internal ‘I’ beam spars, however it is designed as a lightweight vehicle chassis only which is not produced to withstand any extensive over-the-road operations without incurring a variety of structural failures. Even though the specifications claim an improved strength-to-weight ratio for the vehicle chassis, the specifications neglect to mention the presence of an alternate path, fail-safe construction design should two of its four primary longitudinal members of the vehicle chassis fail to meet their design loads.

The prior art further acknowledges semi-trailer chassis torsion problems as evidenced by U.S. Pat. No. 4,640,528, Boyles et al, and U.S. Pat. Nos. 5,611,570/5,722,688, Garcia. The Boyles and the two Garcia designs have an operating center of gravity point of the semi-trailer which is substantially above the surface of the road making this high center of gravity problem, coupled with the designed-in chassis flexibility, a problematical situation. Particularly so with the Garcia designs where the combination of chassis flexibility and high vertical center of gravity points can only lead to vehicle instability on turns and uneven road surfaces, particularly where the load can oscillate in a lateral fashion. This is an undesirable operating characteristic which can lead to rollover accidents, much like those accidents which are associated with cylindrical tanker semi-trailer designs which also have a high vertical center of gravity point, in spite of their stiffened chassis design. In both Garcia patents, because chassis flexibility is at the heart of the patent, both the lightweight lateral and horizontal members which constitute the open box beam construction, or unibeam frame, the specifications in both Garcia patents do not indicate any redundant stiffening reinforcing doublers for all of the various openings found on the unibeam structure in order to conserve on overall vehicle weight, a weight saving design criteria much like that found on other lightweight vehicle frames constructed such as various articulated busses and other bus designs.

Further, the specifications for Garcia fail mention a fail-safe alternate path structural loading design should any of its primary load bearing members fail to support their design load. Exemplified by Boyles, this semi-trailer chassis was specifically created to carry large, heavy and unusually dimensioned loads and the unique design of the semi-trailer chassis acknowledges the continuing problem of semi-trailer chassis distortion. Nevertheless, because of the extraordinarily flexible and unique structural makeup of the Boyles vehicle, it is equally incapable of safely carrying regular freight or tanker fluid loads and is therefore not of a crashworthy design in those respects. Another fail-safe design feature that is not evident with commercial vehicles are the manufacturing considerations for a longitudinal weight and balance design as the vehicle is initially manufactured and later operated, said weight and balance procedures being specifically designed to appropriately distribute the loaded weight. In the case of an occupied passenger semi-trailer or loaded freight semi-trailer, said vehicle weight must be appropriately distributed between the tractor rear wheels and semi-trailer rear wheels so as to be in conformance with both federal and state MWC regulations which were designed for both minimizing road wear while equally acknowledging vehicle bridge loading considerations.

This consideration of the longitudinal weight and balance aspects of the vehicle addresses during both the manufacturing procedure and operational phases of the vehicle were not evident in the eight examples of prior art passenger semi-trailer patents and one of the two prior art articulated bus patents in either their specifications or claims. One articulated bus U.S. Pat. No. 4,342,370, Hagin et al, did properly take into account the longitudinal weight and balance question during the manufacturing phase but did not address the subject during the operational phase. In this articulated bus design, the bus engine, a very heavy component, is mounted at the very rear of the vehicle which would normally take sufficient weight off of the mid-vehicle drive wheels due to pivotal action at the rear wheel location, however the cited formula for the distance between the two wheel bases for the bus seems to correct this contingent mid-wheel traction problem. However, from an operational point of view, the inventor did not take into consideration a most common situation with articulated busses of this type which are now in operation in most large communities. There are instances where an articulated city bus can be completely empty while there still can be nine to ten passengers gathered at the very rear of the bus cabin. In that particular instance, an additional 1600 pounds of weight, acting as a counter balance at the very rear of the bus, would tend to obviate the empty longitudinal weight and balance considerations for the mid-vehicle drive wheel traction subject when the vehicle was in the initial manufacturing process. The patent specifications and claims for U.S. Pat. No. 4,342,370, Hagin et al, do not mention this operational longitudinal weight shift problem which could cause possible loss of traction at the drive wheels. Since this design is a towed vehicle identical to that of a towed semi-trailer, a reduction of towing traction, particularly during turns or during icy road conditions, could cause a jackknifing event. In any case, U.S. Pat. No. 4,342,370 specifications and claims makes no mention for any structural provision for the installation of an anti-jacknifing restraint apparatus and a anti-jacknifing apparatus in either the forward or aft bus unit.

Another fail-safe design feature that is not evident with commercial vehicles are the considerations for the lateral weight and balance design as the vehicle is manufactured and later operated, said lateral weight and balance procedures being specifically designed to appropriately distribute the weight for either the occupied or loaded semi-trailer equally along either side of the vehicle longitudinal axis. Although many commercial vehicles are structurally manufactured in a laterally equivalent manner, there are some that are not as illustrated by the top view of the articulated bus chassis in U.S. Pat. No. 5,452,912, Boucquet. In this particular drawing, we notice that the heavy engine or motor is placed well to the right of the longitudinal axis of the bus as is the cardan shaft which powers the mid-vehicle drive wheels. Since the rear portion of the bus actually pushes the forward portion of the bus, as opposed to the forward portion of the bus towing the rear portion much like a semi-trailer, it can also be seen that there is no anti-jacknife apparatus installed that might connect to either the forward or aft portion of the vehicle chassis. It can also be seen that the rotary junction apparatus contains an anti-buckle device which only restrictively works while the bus is reversing direction thereby preventing excessive angles of rotation between the forward and aft portions of the bus by electrically applying the bus brakes once that point is reached and sensed by an electrical switch. In any case, U.S. Pat. No. 5,452,912, Boucquey, specifications and claims makes no mention for any structural provision for the installation of an anti-jacknifing restraint apparatus and a anti-jacknifing apparatus in either the forward or aft bus unit. A second failure mode is the conventional suspension apparatus whereby the mechanical failure of the conventional suspension apparatus or its related chassis attachment hardware which structurally attaches to the vehicle chassis and other vehicle members can cause serious vehicle control problems which can easily lead to accidents and passenger injuries.

From the viewpoint of conventional suspension apparatus for the passenger semi-trailer prior art and articulated bus prior art, the subjects of vehicle braking recoil and acceleration recoil has not been addressed in either the specification or claims in that the suspension systems for those vehicles was a secondary consideration for the vehicle body construction. However, from practical and safety standpoints, the subject of operational recoils are a natural outgrowth of the methods of construction for conventional suspension apparatus which has not been substantially addressed by conventional suspension apparatus prior art, especially where the conventional suspension apparatus directly supports the vehicle axle. Another operating characteristic of conventional suspension apparatus prior art is the subject of vehicle movement along its longitudinal axis where the vehicle rolls in the direction of the road camber which is the angular tilt of the road that is created by curved cross sectional profile of road surface. Because land vehicles which utilize conventional suspension apparatus are designed to ride level to a level reference surface, namely the road surface, the vehicle will also naturally roll along its longitudinal axis to operate in a parallel manner, to what is in effect, a tilted road surface. If the vehicle has a high operational vertical center of gravity point, it is predisposed to a potential rollover event, more so if the suspension is won on the side of the vehicle tilt and the suspension on that side is incapable of meeting its intended load requirements. This operational problem has been addressed by the suspension prior art which offered a wide array of complex vehicle self-leveling systems and apparatus, however, the passenger semi-trailer prior art and the articulated bus prior art does not address nor incorporate any self-leveling suspensions in either their specifications or their claims. One of the more common methods of solving the vehicle tilt problem is the use of air bags or air springs which mechanically connected to the vehicle chassis or axle and are either operationally inflated or deflated to compensate for tilt along the longitudinal and lateral axis of the vehicle.

With those prior art air spring self-leveling designs, normally high air pressure is required so as to compensatingly move a heavily laden vehicle in such a manner that the suspensions on the side of an unevenly laterally loaded vehicle or the forward or aft axles of a longitudinally unevenly loaded vehicle are afforded a newly redistributed load configuration. Instead or utilizing a high air volume and low air pressure suspension apparatus, the low air volume, high air pressure prior art designs can lead to component failures. As with a large majority of conventional suspension apparatus, air bag suspensions can fail if any of the hoses that supply air pressure leak or if the air bags themselves develop leaks, therefore the suspension prior art does not address future failure modes for their particular suspension designs and are therefore, not fail-safe designs. One example of a failure prone multiple air bag suspension design is found in U.S. Pat. No. 2,896,964, Cornwall. From the conventional suspension apparatus point of view for the passenger semi-trailer prior art and the articulated bus prior art, these vehicles have not incorporated a fail-safe suspension in either their specifications or claims.

Another method of addressing the vehicle tilt problem has been prior art suspensions where the vehicle is suspended along its centerline and not at the various outboard locations along the length of the chassis. Two very old U.S. Pat. No. 159,492, Blair and U.S. Pat. No. 241,443, Tainter have centrally located ball socket designs, however, the king bolt which mechanically retains the ball and socket as an operational unit is a critical element should it fail in any manner. In these two designs, a king bolt failure would cause separation of the suspension from the chassis. A similar design problem is demonstrated by U.S. Pat. No. 2,232,549, McNamara in which a ball socket, or unipoint suspension is used for an early axle steering invention.

Other pneumatic suspensions that centrally support the vehicle are mechanically attached to the chassis and use a plurality of large flexible diaphragms which bear the weight of the vehicle, two examples being U.S. Pat. Nos. 2,838,321 and 2,882,067, both by Gouirand. Using either single or dual air chambers, any cracks or tears in any of the flexible diaphragms would cause a collapse of the suspension apparatus which is not of a fail-safe design. Both of these patents extensively relies on a wide variety of conventional suspension hardware along with a variety of valves and other complex mechanisms, any of which, when failed, will cause suspension malfunction, especially the cable support feature which is created to address unequal lateral loading of the vehicle. Although centrally disposed suspension apparatus can address the problems of laterally disposed suspensions along the chassis frame, the semi-trailer prior art and the articulated bus prior air does not mention such suspension apparatus in either their specifications or their claims.

### BRIEF SUMMARY OF THE INVENTION

To achieve the foregoing and other advantages, the present invention, briefly described, provides a novel modular passenger semi-trailer which consists of the two major modular components, the first component being the semi-trailer cabin structure module and the second being the lower structure module, both modules being manufactured with strength, weight, balance and fail-safe design criteria, all of these features effectively merging proven aviation construction technology with land vehicle technology. The preferred embodiment is an all-steel welded construction for the structural members of the vehicle, however a welded and bolted and or alternate materials assembly technique are also acceptable construction techniques.

The modular passenger semi-trailer, being composed of two major module assemblies, the upper vehicle length, enclosed semi-trailer cabin structure module and the lower structure module, the lower structure module having a vehicle length closed box beam construction consisting of a plurality of compartments. Three compartments, generally disposed at the rearmost portion of the semi trailer, act cooperatively, namely, the forward guideplate, cylinder and aft guideplate compartments, each of the three compartments providing the mechanical constructs for the reciprocally operative, pneumatic unipoint suspension and the wheel unit that are collectively contained in the three compartments. The cylinder compartment is opened at its lower surface to accept installation of the pneumatic unipoint suspension, the truncated hemisphere and the wheel unit. The forward guideplate compartment is opened at its vertically disposed rear face to accept the extending portions of the wheel unit shaft cam block and swivel block members. The aft guideplate compartment is opened at its vertically disposed forward face to accept the extending portions of the wheel unit shaft cam block and swivel block members.

The pneumatic unipoint suspension consists of a piston assembly and a truncated hemisphere. Pressurized by an on-board air pressure source, the substantially sized piston assembly operates at a high air volume and a low air pressure. Located in the upper portion of the cylinder compartment, the air chamber is the sealed portion of the cylinder compartment, the provided air pressure acting upon the upper face of the piston assembly, thereby urging the piston assembly downward upon the unipoint suspension and the wheel unit below it, thereby raising the aft end of the vehicle to its operating height.

The piston assembly is a substantially sized piston that fits and operates reciprocally within the upper portion of the cylinder compartment having a centrally disposed, downwardly facing concaved piston socket on its lower horizontal surface which functions to accept the convexed upper portion of the truncated hemisphere which operates rotatably within the piston socket. The truncated hemisphere, having a flat lower surface, operates slidably upon the flat upper face of the wheel unit platform plate and is always being compressively sandwiched in its position within the piston socket. This simple, rugged ball socket arrangement always insures that no torque is ever imposed upon the vehicle as the wheel unit moves along its vertical, longitudinal and lateral axis as it is pushed along the road by its contacts with the lower structure module.

Functioning cooperatively within the three compartments, the unipoint suspension and the wheel unit, along with its integral wheel unit shaft and the external cam block and swivel block members, do not utilize any conventional suspension apparatus nor do these major components utilize any conventional suspension hardware. By the avoidance of both the conventional suspension apparatus and the various forms of hardware that is normally used to attach the suspension apparatus to a conventionally designed vehicle chassis, the present invention bypasses all of the mechanical weaknesses of that conventional design mentality that has dominated all land vehicle designs up to this point in time.

The wheel unit is held positionally captive in its location in the lower portion of the cylinder compartment while still being allowed to operate along the three wheel unit axis. The forward and aft guideplate compartments each have a set of centralized, spaced apart, vertically disposed guideplates, the guideplates being affixed to the lower, horizontally disposed surface of the cabin floorplate and to the upper, horizontally disposed surfaces of the respective lower structure module baseplates. The wheel unit shaft forward and aft cam blocks and swivel blocks, being pivotally installed on the forward and aft projections of the wheel unit shaft, are respectively sandwiched between the front and aft sets of guideplates and operate in a slidable manner. Because of the two vertically disposed grooves in each of the forward and aft cam blocks, each cam block nests into the vertically disposed contact faces of each guideplate, thereby insuring that the wheel unit is capitively positioned and held in precise longitudinal alignment with the semi trailer pendulous longitudinal axis datum line. Held in this captive position within the lower structure module, the wheel unit will always precisely track as it is pushed along the road by the aft set of guideplates.

Each cam block groove has a vertically disposed, convexed shaped face which allows the wheel unit to raise along its vertical axis or rotate along its lateral axis, or any combination thereof while still being held positionally captive within the lower portion of the cylinder compartment. Since the operational clearances between each of the four cam block cam faces and their respective guideplate contact surfaces are sufficient for efficient operation of the wheel unit along each of its three axis, the close relationships of these contact surfaces eliminates any braking or acceleration recoil that is normally associated with conventional suspension apparatus.

Since the wheel unit shaft is locationally positioned along the wheel unit longitudinal axis, is centrally positioned within the wheel unit and is supported at four points within the wheel unit by internally disposed antifriction bearings, the wheel unit operates freely along its wheel unit longitudinal roll axis while still freely operating along its wheel unit vertical axis and wheel unit lateral axis.

The wheel unit, much like the lower structure module, is a closed box beam construct which employs a three fixed through-axle design which is simple and rugged. Operationally, this fixed axle design can normally pass over the common potholes that are found in all roads and not have any of its six wheel groups drop into the potholes. By virtue of this feature, the wheel unit avoids the constant impacts and damages that are normally associated with conventional suspension apparatus which, by virtue of a common independent suspension design, will allow individual wheels or wheel groups to drop into the potholes thereby inflicting eventual damage to the collective of tires, wheels, axles, suspensions and suspension hardware along with immediate damage to the road surface itself.

By virtue of the three compartments and the operational characteristics of the unipoint suspension and the wheel unit, the lower module structure is a unique, fail safe construct that allows the vehicle to operate in a self leveling manner due to limited movement along the semi trailer pendulous longitudinal axis datum line. Mechanically supported in the conventional manner at the front end of the semi trailer by the tractor fifth wheel plate and by the unipoint suspension at the generally rearmost portion of the vehicle, a fully occupied and equipped semi trailer will always ride level regardless of road cambers.

Using a commercial aviation design principle of weight and balance, the fully operational semi trailer will always have a vertical center of gravity point that is below the semi trailer pendulous longitudinal axis datum line. Although the manufacturing tradeoff is a heavier but more crashworthy vehicle, this weight and balance design feature, acting cooperatively with the wheel unit shaft mechanical intervention with the lower structure module, substantially lessens the possibility that the vehicle will experience rollover events which are a major design problem for both semi trailers in general and other passenger busses such as motorcoach busses where the passenger seating is at a higher level than that of conventional passenger busses.

The lower structure module is specifically constructed with a single, top, flat production joint face which will accept various upper module designs, in this particular embodiment which is a semi trailer passenger structure module and in the alternate embodiment industrial versions, one example being a flat bed semi trailer. In the case of the passenger version of the vehicle, the passenger structure module is manufactured as a completed unit which includes all of the interior seating and other interior equipment and systems installations. Once completed, the entire passenger structure module is placed upon the production joint face of the lower structure module and affixed into position thereby creating a closed box beam construct for the plurality of compartments of the lower structure module. Welding or a combination of welding and mechanical attachments are the preferred techniques for joining both vehicle modules. Once joined, the completed semi trailer offers a variety of mechanical and operational features that are created for the safety of its occupants.

The semi trailer cabin structure module is first framed by employing a vehicle length rollcage construct that produces the exterior form of the semi trailer while, at the same time, forms the interior compartments of the vehicle. Using vehicle length rolltubes as a starting point for the rollcage design, various cabin former assemblies and various cabin bulkhead members, all having suitably placed rolltube assembly holes, are slidably placed along the length of the rolltubes and then affixed into position, thereby providing the first stage structural framing for the cabin structure module. The rolltubes, spaced apart and generally located near the upper portion of the cabin ceiling, act in cooperation with the variety of cabin former assemblies and cabin bulkhead members, thereby allowing the creation of a passenger structure module. By using any combination of cabin former assemblies and cabin bulkhead members, a vehicle can be constructed which can have a variety of cabin interior arrangements.

Further, because the interior and exterior profiles of the cabin former assemblies and cabin bulkhead members can be reconfigured for special purpose uses, a cabin structure module can be created which may have a compound exterior surface utilizing various curved and angled exterior surfaces, a design feature which may be applied to both passenger and industrial semi trailer vehicle types.

The second stage of construction for the rollcage is the attachment of the vehicle length right and left cabin sideplates, the sideplates being nested flush into provided recesses in the vertically disposed side portions of each cabin former assembly and cabin bulkhead member. In the preferred embodiment, the right cabin sideplate has two cutout areas which will allow the installation of a forward and aft cabin door. Both sideplate members, being finally affixed to the vehicle length cabin floorplate, completes the cabin rollcage structure. As fail safe features, both cabin sideplates are manufactured of high strength steel to guard against side impact events while each cabin bulkhead member acts as a redundant structure for the cabin former assemblies to resist cabin collapse during unexpected impact events. The rollcage frame structure, in general, also collectively acts to resist cabin collapse during unexpected impact events.

The vehicle length, rigid cabin covering material provides the enclosure containing all of the various external windows and doors for the semi trailer cabin structure module. Secured and firmly attached to the outside profiles of the cabin former assemblies and cabin bulkhead members of the rollcage structure, the cabin structure module assumes its final exterior shape. A forward closed cabin bulkhead one encloses the forward end of the cabin structure module while the end cabin door bulkhead encloses the aft end of the cabin structure module.

The semi trailer cabin structure module has a interior compartment arrangement consisting in a front-to-rear arrangement, a closed forward compartment accessible externally by a forward closed compartment access door, a forward cabin compartment, a main cabin compartment and an aft cabin compartment, these last three compartments being internally accessible by door cutouts in various cabin bulkhead members.

The forwardmost closed box beam towplate compartment is a shallow depth, overhanging the aft end of the tractor and its tractor fifth wheel plate. Designed as a high strength, fail safe compartment, it has a cylindrically shaped king pin collar which is reinforced by four, vertically disposed, internal diagonal planks, each nesting within the respective internal comers of the compartment. The king pin collar has a central hole, tapered at the top to accept an oversized diameter king pin which, once installed, is downwardly projecting so as to be mechanically and pivotally connected to the tractor fifth wheel plate. The forward baseplate, acting as the floor of the compartment, has a radiused portion and thereafter, a vertically disposed portion which acts as the forward transverse member for the forward spar compartment.

The closed box beam forward spar compartment has a basic frame consisting of a floor portion created by the mid baseplate, the exterior right and left lower sideplates and the two centralized, spaced apart internal ‘I’ beam spars, each longitudinal member constituting a primary structure. Constructed with a fail safe, alternate path loading criteria, any two primary longitudinal spar compartment members may structurally fail without causing a mechanical collapse of the forward spar compartment of the lower structure module. Using a variety of compartment length right angle shaped members, selected for their weight, the built-up right and left sideplates become inwardly facing channel members and both forward spars become ‘I’ beam members, each collectively adding to the low vertical center of gravity point for the completed vehicle. Further, four longitudinally placed spar planks, juxtaposed to the respective interior and exterior lower surfaces of the two forward spars and affixed in place, provides the requisite final counterweights to complete the vehicle weight and balance requirements.

The closed box beam aft spar compartment has a basic frame consisting of a floor portion created by the aft baseplate, the exterior right lower sideplate with its juxtaposed right internal doubler plate, the exterior left lower sideplate and its juxtaposed left internal doubler plate, both reinforced constructs comprising two of the four primary compartment length longitudinal structures. The two centralized, spaced apart aft spars, built up with vehicle length right angle members constitute the final two primary longitudinal compartment members, all four members having the identical alternate path loading criteria as the forward spar compartment primary longitudinal members. The aft spar compartment is framed at its forward end by the transverse aft spar compartment bulkhead and framed at its aft end by the transverse aft spar compartment end bulkhead. The right and left aft spars are spaced apart enough to permit the installation of the cylinder compartment compressor equipment. Ventilating air flow is provided in a front-to-rear direction by the provision of a generator air inlet opening in the aft spar bulkhead and generator exhaust slots constructed within the aft spar compartment access door, itself installed within the aft spar compartment end bulkhead.

The commercially available cylinder compartment compressor equipment, disposed in the central cavity portion of the aft spar compartment, has a gasoline powered electrical generator unit that powers an electrical powered air compressor. The air pressure output of the air compressor is communicated by a series of air hoses which communicates through the aft spar bulkhead and into a hole disposed in the aft cylinder wall of the cylinder compartment. A second hole disposed in the aft cylinder wall and a series of air hoses communicating back through the aft spar bulkhead and into the central cavity portion of the aft spar compartment senses the air pressure in the air chamber in the cylinder compartment. A low air pressure switch, either opening or closing by the activation of a predetermined air pressure either activates or deactivates the electrical powered air compressor, thereby maintaining proper extension of the pneumatic unipoint suspension without operator intervention.

The cylinder compartment, being approximately as wide as the lower structure module and as approximately as long as the wheel unit below it, is substantially sized and operates at a very high air volume and a very low air pressure, this low air pressure being contained in the sealed air chamber above the piston assembly by redundant upper and lower piston air seals. The compartment is framed by the longitudinal right and left internal doubler plates and by the transverse members, the forward and aft cylinder walls. Each cylinder compartment internal corner has an installed and affixed rounded cylinder corner, the exterior dimensions and top sectioned profile of the piston assembly operating within the compartment being congruent in shape to that of the interior top sectioned profile of the cylinder compartment.

Reciprocally operative within the cylinder compartment, the piston assembly is constructed of a generally horizontally disposed plate, the topmost face containing an upper seal carrier and upper piston seal and a lower seal carrier piston skirt and lower piston seal. The fail safe features of low operating air pressure and redundant piston seals creates a simple and rugged construct that is fully capable of supporting the anticipated vehicle loads.

The cylinder compartment is opened at its lower portion so as to accept installation of the pneumatic unipoint suspension, the truncated hemisphere and the wheel unit.

A substantially sized resilient material pad, deposed and securely affixed to the top face of the piston plate functions as a fail safe feature during air chamber depressurizations in that the aft end of the vehicle is supported by the pad while six, spaced apart stop blocks, deposed along the edges of the pad, having a top surface lower than the top surface of the pad, prevent the crushing of the pad during depressurization events.

For both the preferred passenger embodiment and for the various industrial embodiments of the vehicle, the forward end of the two forward spars will offers an attachment provision for a restraint apparatus which will be a component of a future anti-jacknife restraint system while the captively located wheel unit situated within the bottom portion of the cylinder compartment has an operational characteristic which offers the opportunity for the installation of a future anti-jacknife detection apparatus.

This invention has as its primary objective the provision of a new and novel preferred embodiment modular passenger semi-trailer and alternate industrial semi trailer embodiments, all of which are equipped with a new and novel pneumatic unipoint suspension system, wheel unit, wheel unit shaft and its external members all integrated within three compartments of the lower structure module and all functioning as a single operational unit.

Accordingly, besides the objects and advantages of the modular passenger semi-trailer with pneumatic unipoint suspension in my above patent, several additional objects and advantages of the present invention are:

A further object is to provide a semi-trailer cabin structure module structure that may have more than one cabin unit assembled upon the cabin Doorplate and that this multi-cabin configuration can be applicable to both passenger and industrial embodiments of the vehicle.

A further object is to provide the cabin floorplate member, which when weldably attached to the single, top production joint face of the lower structure module, closes the top portion of the cylinder compartment, thereby sealing the cylinder compartment at its top portion thereby creating the air chamber area portion of the cylinder compartment.

A further object is to provide a vehicle-length passenger cabin design that, by the weldable assembly of the right and left cabin sideplates to the cabin floorplate, creates a vehicle-length channel structure which stiffens the final assembled semi-trailer cabin structure module before its assembly upon the lower structure module.

A further object is to provide a modular passenger semi-trailer which utilizes high strength cabin former assemblies, consisting of two cabin former plates, a cabin exterior profile bar and a cabin interior profile bar, being of sandwiched design, provides the interior and exterior profiles for the vehicle.

A further object is to provide a closed box beam forward spar compartment having a generally rectangularly cross-sectional shape consisting of four compartment-length longitudinally disposed primary compartment beam members, all incorporating a redundant, fail-safe alternate path loading design in which any two of the primary structures may experience structural failure while the two remaining primary compartment beam members will continue to successfully support the modular passenger semi-trailer.

A further object is to provide a forward closed box beam forward spar compartment which will provide the structural means of mounting a future anti-jacknife restraint apparatus which will be mechanically joined to the interior, forward portions of the two forward compartment spars and that the connecting member of the anti-jacknife restraint apparatus will mechanically join the modular passenger semi-trailer to the towing tractor by the provision of an appropriate opening in the vertical section of the forward baseplate member.

A further object is to provide a closed box beam front guideplate compartment having an aft-facing opening being laterally reinforced by the forward cylinder wall which is affixed to the forward set of vertically disposed guideplates at the typical guideplate cylinder wall cutouts, a closed box beam aft guideplate compartment having a forward-facing opening being laterally reinforced by the aft cylinder wall which is affixed to the aft set of vertically disposed guideplates at the typical guideplate cylinder wall cutouts.

A further object is to provide longitudinal reinforcing for the bottom opening of the closed box beam cylinder compartment which is narrowed at the right wheel cutout location and narrowed at the left wheel cutout location, reinforcing provided by the right internal doubler plate and left internal doubler plate.

A further object is to provide a substantially sized piston assembly consisting of a horizontally mounted piston plate having a redundant, fail-safe piston seal design whereby an upper seal carrier is mounted on the top horizontal face of the piston plate, the upper seal carrier providing a circumferential groove which accepts the installation of the upper piston seal and a lower seal carrier piston skirt is mounted on the bottom horizontal face of the piston plate, the lower seal carrier portion providing a circumferential groove which accepts the installation of the lower piston seal.

A further object is to provide a substantially sized piston assembly which has a substantially sized piston resilient material pad attached to the top horizontal face of the piston plate which, when acting as a fail-safe design feature, will cushion any road shocks transmitted to the lower surface of the cabin Doorplate as the piston assembly seats upon that surface during any underpressure events within the air chamber above the piston assembly.

A further object is to provide a substantially sized piston assembly consisting of a lower seal carrier piston skirt, the external face of the piston skirt member being formed so as to be juxtaposed and slidably operative along the internal face of the cylinder wall member, the disposed member faces collectively acting to produce a smooth reciprocal motion of the piston assembly as it operates within the cylinder compartment.

A further object is to provide a lower seal carrier piston skirt portion of a substantially sized piston assembly where an alternate embodiment could contain various mechanical adjustment means placed upon the internal face of the piston skirt portion allowing manual field adjustments for a leaking lower piston seal.

A further object is to provide a captively located wheel unit operating in the lower portion of the cylinder compartment, the wheel unit being urged along the road by the contact faces of the vertically disposed set of aft guideplate members of the lower structure module, the wheel unit performing three major operational functions,

(a) the wheel unit supports the weight imposed upon it by the pneumatic unipoint suspension members, that load being centrally placed upon the top platform plate of the wheel unit by the flat lower face of the slidably operative truncated hemisphere, and

(b) the wheel unit structural members distribute and transmit that imposed vehicle loading to the three fixed through-axles and thereafter to the six wheel units with have contact with the road surface, and

(c) the wheel unit centrally locates and longitudinally joins the wheel unit shaft and its external members within the confines of the wheel unit structure.

A further object is to provide a modular passenger semi-trailer that is a self-leveling vehicle which does not rely on any complex self-leveling system, all of which operates along a pendulous longitudinal axis or datum line and is self-leveled by a manufactured low vertical center of gravity point for the entire vehicle, the datum line originating at the vertical surface level of the tractor fifth wheel plate at the forward end of the vehicle and terminating at the vertical apex point of the convexed truncated hemisphere which rests upon the top platform plate face of the supporting wheel unit.

A further object is to provide a captively located wheel unit having a longitudinal wheel unit centerline which is always precisely positioned in lateral alignment with the vehicle datum line by four mechanical dispositions of the wheel unit shaft and its external members:

(a) the interlocking coupling of the two forward cam block grooves relative to the two forward guideplates, and

(b) the interlocking coupling of the two aft cam block grooves relative to the two aft guideplates, and

(c) the slidable motions of the forward swivel plate as it works in its sandwiched position in between the front set of vertically disposed guideplates, and

(d) the slidable motions of the aft swivel plate as it works in its sandwiched position in between the aft set of vertically disposed guideplates.

A further object is to provide a wheel unit that encloses a pivotally mounted wheel unit shaft that is disposed parallel to the wheel unit centerline, the wheel unit providing longitudinal mechanical supports for the wheel unit shaft in the form of internally mounted anti-friction roller bearings, each anti-friction roller bearing being individually supported by various internal transverse bearing mount plates and other transverse support plates, all of these members comprising the major portion of the interior structure of the wheel unit.

A further object is to provide a wheel unit that encloses a pivotally mounted wheel unit shaft which, when during braking events, will never be subjected to tensional loading in that the braking force will always be initially transmitted by the parting face between the wheel unit end plate and the flat face of the aft cam block and thereafter the braking force being mechanically transmitted by the two typical aft cam block cam faces of the aft, which urge upon the left aft guideplate contact surface and right aft guideplate contact surface, these constructional and operational features being a fail-safe design criteria for the wheel unit shaft.

A further object is to provide a source of air pressurization for the cylinder compartment, the purpose of which is to urge the piston assembly to move downward in the cylinder compartment, thereby raising the aft end of the modular passenger semi-trailer to its operating height, a process that can be accomplished by alternate embodiments of the invention which may be either a manually controlled on-board air pressure tank or bottle or by a manually controlled external air pressure source, in either case, the air pressure source being connected by appropriate air hoses that communicate through the provided access holes in the aft bulkhead and the aft cylinder wall so as to direct the flow of air into the cylinder compartment.

A further object is to provide a selection of preferred materials which will be used to configure the various members of the modular passenger semi-trailer, the preferred structural materials being cold-rolled steel and other high-strength steels along with a variety of alternate, lightweight non-structural materials for the remaining portions of the vehicle, the weight of all selected materials being a function of the overall weight, balance and strength criteria for the modular passenger semi-trailer.

A further object is to provide industrial use versions of the invention which may consist of a modular freight semi-trailer version where the flat-bed design of the vehicle which can accept both modular freight containers or Quonset-hut shaped fluid containers, all connected to the flat-bed portion of the vehicle by appropriately provided quick disconnect fittings designed for both speedy onloading and offloading of the industrial cargo.

A further object is to provide industrial use versions of the invention which may consist of a modular freight semi-trailer being a flat-bed design which is capable of carrying conventional freight on its top face while the forward spar compartment can be appropriately sealed and equipped with appropriate plumbing so as to create a fluid carrying compartment in the lower portion of the vehicle.

Further objects and advantages will allow it to be safely towed over a roadway by a tractor, the semi trailer having superior braking characteristics and passenger ride comfort features. Still further objects will become apparent from a consideration of the ensuing description and drawings.

### BRIEF DESCRIPTION OF THE SEVERAL VIEWS OF THE DRAWINGS

FIG. 1 is a side perspective view of tractor 60 and modular passenger semi-trailer 62 combination.

FIG. 2 is a perspective side view of the tractor 60 and a phantom perspective side view of the modular passenger semi-trailer 62

FIG. 2A is an enlarged perspective view of wheel unit 84 in the circled region 2A of the preferred embodiment of the invention shown in FIG. 2.

FIG. 3 is a perspective side view of the left side of the fully assembled modular passenger semi-trailer 62.

FIG. 4 is a pre-assembly perspective side view of the right side of semi-trailer cabin module 150 which is the preferred embodiment and lower structure module 152. The wheel unit 82 is not shown for illustrative clarity. The top flat production joint surface 548 of the lower structure module 152 is also shown. Also shown are the six compartments (262, 264, 182, 184, 186, 188) of the lower structure module (152).

FIG. 5 is a pre-assembly perspective side view of the right side of the alternate embodiment semi-trailer flatbed module 340 and the lower structure module 152. The wheel unit 82 is not shown for illustrative clarity. The top flat production joint surface 548 of the lower structure module 152 is also shown. Also shown is the cylinder compartment (184) of the lower structure module (152)

FIG. 6 is a perspective side view of the right side of the fully assembled modular passenger semi-trailer 62. The wheel unit 82 is not shown for illustrative clarity. The top portion of the cabin covering material 106 has a breakaway section illustrating the internal rollcage structural details.

FIG. 7 is a fragmented orthographic expanded top view of the rear portion of the lower structure module 152. The piston assembly 366 and the wheel unit 84 are not shown for purposes of illustrative clarity.

FIG. 7A is an enlarged top orthographic view of the circled region 7A of the preferred embodiment of the invention shown in FIG. 7 which shows the details of the cylinder compartment compressor equipment 516.

FIG. 7B is an end orthographic view of the modular passenger semi-trailer 62 showing the end cabin door bulkhead 154 with its aft cabin door 80 along with the aft spar compartment end bulkhead 222.

FIG. 8 is a fragmented orthographic expanded top view of the forward portion of the lower structure module 152. The piston assembly 366 and the wheel unit 84 are not shown for purposes of illustrative clarity.

FIG. 8A is an enlarged orthographic side view of end bulkhead 222 and the aft spar compartment access door 156 with its generator exhaust slots 158 of the circled region 8A of the preferred embodiment of the invention shown in FIG. 11.

FIG. 8B is an enlarged orthographic side view of aft cylinder wall 218 and the aft cylinder wall air pressure supply hole 312 of the circled region 8B of the preferred embodiment of the invention shown in FIG. 11.

FIG. 8C is an enlarged orthographic side view of towplate compartment 262 and the king pin collar and two of its supporting forward diagonal planks 324, 326 in the circled region 8C of the preferred embodiment of the invention shown in FIG. 11.

FIG. 9 is an orthographic side view of the oversized king pin 160 and the king pin tapered section 160.

FIG. 10 is a top orthographic breakaway view of cabin interior details of the semi-trailer cabin structure module 150. The top breakaway view illustrates a typical passenger seat 362 and an optional seating arrangement with 34 seats along with structural details of the interior rollcage design with its two vehicle-length rollover tubes 164, 166 and the various assembled cabin formers and cabin bulkheads.

FIG. 11 is a side orthographic sectioned side view of the lower structure module 152 taken on line 11-11 of the preferred embodiment shown in FIG. 7 and FIG. 8. FIG. 11. The piston assembly 366, the wheel unit 84 and the cylinder compartment compressor equipment 516 are not shown for purposes of illustrative clarity.

FIG. 12 is a perspective top view of the piston assembly 366 which shows piston plate 190 and the six stop blocks 194, 196, 198, 200, 202 and 204. The piston resilient material pad 476 is not shown for purposes of illustrative clarity.

FIG. 13 is a perspective top view of the piston assembly 366 with the piston resilient material 476.

FIG. 14 is a perspective bottom view of the piston assembly 366, the centrally affixed piston socket 376 and the redundant piston seals 372 and 374. The bottom view also illustrates the contingent access to the lower piston seal 374 for manual field adjustment of the seal.

FIG. 15 is a fragmented perspective sectioned top view of a selected portion of lower structure module 152 illustrating structural portions of the forward spar compartment 264, the cabin floorplate 360, the piston assembly 366, the unipoint piston socket 376 and its sandwiched truncated hemisphere 96, the wheel unit 84 and aft guideplates 210 and 212. The six wheel groups 126, 128, 130, 86, 88, 90, wheel unit shaft 424 and the aft shaft swivel block 402 are not shown for purposes of illustrative clarity.

FIG. 15A is a perspective top bracketed view of the two functional members of the pneumatic unipoint suspension (114).

FIG. 16 is a fragmented orthographic top view of the cylinder compartment 184 portion of semi-trailer lower structure 150 with the cabin floorplate 360 removed for the purpose of illustrative clarity. The top view shows the wheel unit 84 with its six wheel groups 126, 128, 130, 86, 68, 90 and the installed wheel unit shaft 424 and its forward and aft camblocks 406, 408, forward and aft shaft swivel blocks 402, 404 and their centralized positioning between the forward guideplates 206, 208 and the aft guideplates 210, 212 all of which holds the wheel unit locationally captive within the cylinder compartment 184. Also shown is the wheel unit longitudinal axis 98 and its precise alignment with the pendulous longitudinal axis 116 or datum line of the modular passenger semi-trailer 62.

FIG. 17 is a fragmented expanded orthographic detailed side view of wheel unit 84 and the surrounding structure of lower structure module 152. The cabin Doorplate 360 is shown in this view which creates the closed upper air chamber 500 in the cylinder compartment 184 which provides the high volume, low air pressure for the operation of the unipoint suspension system.

FIG. 17A shows a typical wheel shaft roller bearing 460.

FIG. 18 is a fragmented expanded orthographic detailed side view of wheel unit 84 and the surrounding structure of lower structure module 152. The cabin floorplate 360 is shown in this view which creates the closed upper air chamber 500 in the cylinder compartment 184 which provides the high volume, low air pressure for the operation of the unipoint suspension system. A symbolic brake system air supply line 526 is shown for the six wheel air brake units (not shown) which are contained in the wheel unit 84.

FIG. 19 is a proportional enlarged sectioned, alternated top and bottom views of the forward cam block 406 and the aft cam block 408. The sectioned view of each cam block shows the typical forward cam block cam face 488 and the typical aft cam block cam face 524.

FIG. 20 orthographic enlarged cross sectional views the wheel unit 84 encountering a vehicle-wide depression in road surface 192 taken on line 11-11 of the preferred embodiment shown in

FIG. 21 orthographic enlarged cross sectional views the wheel unit 84 encountering a vehicle-wide snowpacked road surface 472 taken on line 11-11 of the preferred embodiment shown in FIG. 11. The cabin floorplate 360 is shown in this view which creates the closed upper air chamber 500 in the cylinder compartment 184 which provides the high volume. low air pressure for the operation of the unipoint suspension system

FIG. 22 is a perspective enlarged side view of piston assembly 366 details taken in circled region 22 of the preferred embodiment of the invention shown in FIG. 20. Shown are the cabin floorplate 360, the aft cylinder wall 218, the aft cylinder wall air supply hole 312, the piston plate 190, and details of the redundant piston seals 372, 374 with their respective seal carriers 368 and 370. Also shown are one of the stop blocks 202 and the piston resilient material pad 476.

FIG. 23 is an orthographic end sectional view taken on line 23-23 in FIG. 17. The view shows the structural details of the lower structure module 152 and the wheel unit 84. The view also illustrates a typical off-center vertical load 478 along with a typical right tangential shaft force 480 and a typical left tangential shaft force 484. The wheel unit is depicted travelling over a level road surface 168.

FIG. 24 is an orthographic end sectional view taken on line 23-23 in FIG. 17. The view shows the structural details of the lower structure module 152 and the wheel unit 84. The wheel unit is depicted travelling over a banked road surface 172.

FIG. 25 is an orthographic breakaway end cross-sectional view of cabin former assembly one 348 taken on line 25-25 of the preferred embodiment shown in FIG. 10. Shown are the hole for left cabin rollover tube 492 and the hole for right cabin rollover tube 494. Also shown is an end cross-sectional view of the lower module 152 structural details on the same line 25-25 of FIG. 10.

FIG. 25A is an orthographic rotated cross sectional top view of one side of the assembled vertical members of cabin former assembly one 348 taken on line 25A-25A of the preferred embodiment shown in FIG. 25.

FIG. 26 is an orthographic end cross section of cabin former assembly one 348 which shows the typical cabin interior profile 508 which is created by the cabin interior profile bar 512 that is sandwiched between the two typical cabin former plates 506 and cabin exterior profile which is created by the cabin exterior profile bar 510 that is sandwiched between the two typical cabin former plates 506. Also shown for the typical cabin former plate 506 are the two recesses 496, 498 for the cabin side plates 110, 112 and the two holes for the cabin rolltubes 164 and 166.

FIG. 27 is an orthographic cross sectional end view of aft cabin door bulkhead 358 taken on line 27-27 of the preferred embodiment shown in FIG. 10. Also shown are the cross-sectional structural details of the aft spar compartment 188.

FIG. 28 is an orthographic cross sectional end view of forward closed cabin bulkhead one 342 taken on line 28-28 of the preferred embodiment shown in FIG. 10. Also shown are structural details of the towplate compartment 262.

FIG. 29A is a schematic of the pneumatic unipoint suspension system pneumatic, electrical and mechanical components as they relate to an underpressure mode.

FIG. 29B is a schematic of the pneumatic unipoint suspension system pneumatic, electrical and mechanical components as they relate to a normally pressurized mode.

FIG. 29C is a schematic of the pneumatic unipoint suspension system pneumatic, electrical and mechanical as they relate to a momentary underpressure mode during a rapid as the wheel unit drops into a vehicle-wide depression in the road.

### REFERENCE NUMBERS FOR PARTS

60 tractor

62 modular passenger semi-trailer

64 modular freight semi-trailer

66 tractor drive wheels

68 large window one

70 large window two

72 large window three

74 large window four

76 forward closed compartment access door

78 forward cabin door

80 aft cabin door

82 air supply line hose

84 wheel unit

86 wheel group two

88 wheel group four

90 wheel group six

92 right side wheel cutout

94 tractor fifth wheel plate

96 truncated hemisphere

98 wheel unit longitudinal axis or roll axis

100 wheel unit lateral axis

102 forward cam apex to aft cam apex distance

104 forward guideplate contact surface to aft guideplate contact surface distance

106 cabin covering material

108 king pin collar

110 right side cabin segmented sideplate

112 left side cabin sideplate

114 pneumatic unipoint suspension

116 pendulous longitudinal axis or datum line

118 forward baseplate

120 mid baseplate

122 aft baseplate

124 air sense line hose

126 wheel group one

128 wheel group three

130 wheel group five

132 left side wheel cutout

134 aft cam block groove one

136 wheel unit vertical axis

138 large window five

140 large window six

142 large window seven

144 large window eight

146 small window one

148 small window two

150 semi-trailer cabin structure module

152 lower structure module

154 end cabin door bulkhead

156 aft spar compartment access door

158 generator exhaust slots

160 oversized king pin

162 center of gravity below pendulous longitudinal axis

164 left cabin rollover tube

166 right cabin rollover tube

168 level road surface

170 king pin lower groove

172 banked road surface

174 left aft spar

176 right aft spar

178 left aft spar web

180 right aft spar web

182 forward guideplate compartment

184 cylinder compartment

186 aft guideplate compartment

188 aft spar compartment

190 piston plate

192 depression in road surface

194 stop block one

196 stop block two

198 stop block three

200 stop block four

202 stop block five

204 stop block six

206 left forward guideplate

208 right forward guideplate

210 left aft guide plate

212 right aft guide plate

214 forward spar bulkhead

216 forward cylinder wall

218 aft cylinder wall

220 aft spar bulkhead

222 aft spar compartment end bulkhead

224 aft upper angle one

226 aft upper angle two

228 aft upper angle three

230 aft upper angle four

232 right lower sideplate

234 left lower sideplate

236 right internal doubler plate

238 left internal doubler plate

240 cylinder corner one

242 cylinder corner two

244 cylinder corner three

246 cylinder corner four

248 gasoline powered electrical generator unit

250 electrical powered air compressor

252 low air pressure switch

254 electrical generator power cable

256 low air pressure switch power cable

258 sense air pressure line

260 supply air pressure line

262 towplate compartment

264 forward spar compartment

266 aft lower angle one

268 aft lower angle two

270 aft lower angle three

272 aft lower angle four

274 forward lower angle one

276 forward lower angle two

278 forward lower angle three

280 forward lower angle four

282 forward lower angle five

284 forward lower angle six

286 spar plank one

288 spar plank two

290 spar plank three

292 spar plank four

294 forward plank

296 closing plank

298 forward upper angle one

300 forward upper angle two

302 forward upper angle three

304 forward upper angle four

306 forward upper angle five

308 forward upper angle six

310 aft cylinder wall air pressure sense hole

312 aft cylinder wall air pressure supply hole

314 aft spar bulkhead air pressure sense hole

316 aft spar bulkhead air pressure supply hole

318 air supply line check valve

320 forward baseplate king pin hole

322 forward diagonal plank one

324 forward diagonal plank two

326 forward diagonal plank three

328 forward diagonal plank four

330 left forward spar

332 right forward spar

334 left forward top spar cap

336 right forward top spar cap

338 forward baseplate radius

340 semi-trailer flatbed module

342 forward closed cabin bulkhead one

344 forward closed cabin bulkhead two

346 forward cabin door bulkhead

348 cabin former assembly one

350 cabin former assembly two

352 cabin former assembly three

354 cabin former assembly four

356 cabin former assembly five

358 aft cabin door bulkhead

360 cabin floorplate

362 typical cabin passenger seat

364 generator air inlet

366 piston assembly

368 upper seal carrier

370 lower seal carrier piston skirt

372 upper piston seal

374 lower piston seal

376 piston socket

378 typical guideplate cylinder wall cutout

380 axle tube one

382 axle tube two

384 axle tube three

386 wheel unit platform plate

388 wheel unit forward angled plate

390 wheel unit aft angled plate

392 wheel unit right sideplate

394 wheel unit left sideplate

396 wheel unit forward plate

398 wheel unit end plate

400 wheel unit bottom plate

402 forward shaft swivel block

404 aft shaft swivel block

406 forward cam block

408 aft cam block

410 forward shaft nut tapered pin

412 aft shaft nut tapered pin

414 forward shaft nut

416 aft shaft nut

418 wheel axle one

420 wheel axle two

422 wheel axle three

424 wheel unit shaft

426 shaft bearing one

428 shaft bearing two

430 shaft bearing three

432 shaft bearing four

434 bearing plate one

436 bearing plate two

438 bearing plate three

440 bearing plate four

442 internal support plate one

444 internal support plate two

446 forward shaft upper stop

448 aft shaft upper stop

450 shaft tubular spacer one

452 shaft tubular spacer two

454 shaft tubular spacer three

456 forward shaft threaded end

458 aft shaft threaded end

460 typical antifriction roller bearing

462 roller bearing outer race

464 roller bearing inner race

466 typical roller bearing shaft hole

468 pothole in road surface

470 level surface for wheel group one

472 snowpacked road surface

474 aft cam block groove two

476 piston resilient material pad

478 off-center vertical load

480 right tangential shaft force

482 forward cam block shaft hole

484 left tangential shaft force

486 forward cam block groove one

488 typical forward cam block cam face

490 king pin tapered shaft section

492 hole for left cabin rollover tube

494 hole for right cabin rollover tube

496 typical recess for right side cabin segmented sideplate

498 typical recess for left side cabin sideplate

500 air chamber

502 king pin tapered hole

504 common electrical ground

506 typical cabin former plate

508 typical cabin interior profile

510 cabin exterior profile bar

512 cabin interior profile bar

514 cabin interior door cutout

516 cylinder compartment compressor equipment

518 forward shaft tapered hole

520 aft shaft tapered hole

522 aft cam block shaft hole

524 typical aft cam block cam face

526 brake system air supply line

528 closed forward compartment

530 forward cabin compartment

532 main cabin compartment

534 aft cabin compartment

536 left forward guideplate contact surface

538 right forward guideplate contact surface

540 left aft guideplate contact surface

542 right aft guideplate contact surface

544 forward cam block groove two

546 cabin end bulkhead door

548 single, top, flat production joint face

550 typical left aft spar cap

552 typical right aft spar cap

554 rollover bend point

556 left forward spar web

558 right forward spar web

560 typical cabin exterior profile

562 typical level movement along wheel unit vertical axis

564 cabin rollcage structure

### DETAILED DESCRIPTION OF THE INVENTION

Before explaining the present invention in detail, it is to be understood that the present invention is not limited or restricted in any way in its application or uses relative to the details of construction and arrangement of parts as illustrated in the accompanying drawings, because the present invention is capable of other embodiments and variations and of being practiced or carried out in various ways. Furthermore, it is to be understood that the phraseology or terminology employed here is for the purpose of description and Illustration only, and not for the purpose of limitation or restriction.

Considering that there is only a total of eight semi-trailer prior art examples along with an unusual hiatus of some sixty years since the last passenger semi-trailer was patented, the opportunity to improve on a wide variety of design features for this vehicle type is substantial. In an equally limited activity for the articulated bus prior art, there are only two examples. In all, this subclass has been substantially inactive and the design features for these passenger vehicles are effectively outdated with the possible exception of one patent which was patented in 1995. Nevertheless, the land vehicle design in this subclass is essentially obsolete from a number of important standpoints. From a broader design perspective, the proven modem design and manufacturing techniques that have been successfully used for commercial aviation aircraft generally emerged in 1959 with the introduction of the first commercial passenger jet aircraft. These technologies have yet to be effectively integrated into land vehicle design, particularly so with the passenger semi-trailer prior art.

Further, the suspension systems found on both the passenger semi-trailer prior art and the articulated bus prior art have progressed little since the first patent was issued in 1917. With both groups of vehicles, the use of conventional suspension apparatus and their independently active wheels have been continually accepted with little consideration from land vehicle designers, hence, all of the inherent problems that have been experienced with conventional suspension apparatus has led to a substantial number of patents down through the years, all of which are improvements over prior designs that have had persistent problems of one kind or another.

Further, the conventional suspension apparatus used by commercial vehicles have not taken advantage of the proven commercial aviation design and manufacturing procedures such as component, system and structural fail-safe design concepts, the combination of which produces a vehicle with an increasingly higher lever of crashworthiness which is critical to any passenger carrying vehicle. With the possible exceptions of two brief mentions of vehicle weight and balance in the passenger semi-trailer prior art, the slow acknowledgement by land vehicle designers to come to the conclusion that the subject of vehicle center of gravity as an important consideration has been reflected in a substantially growing number of highway accident statistics, particularly with vehicle rollover accidents. Since both prior art types are towed vehicles, the allied subject of semi-trailer jackknifing events is an important subject for a semi-trailer which will transport passengers.

Since the passenger semi-trailer prior art is so limited, related subjects that are functionally applicable to freight semi-trailers are relevant to the background discussion. From this broad perspective, prior art commercial vehicle designs have been routinely compartmentalized over the years in that all prior art utility patents that have been issued for the vehicle and its associated chassis have, with a very few exceptions, viewed the associated conventional suspension apparatus as a necessary adjunct to the overall vehicle design under consideration and therefore the conventional suspension apparatus is secondarily and symbolically presented in the patent specifications and claims. Conversely, all prior art utility patents that have been issued for conventional suspension apparatus have, with a very few exceptions, viewed the associated vehicle and chassis as a necessary adjunct to the overall suspension system design under consideration and therefore the vehicle and its associated chassis is secondarily and symbolically presented in the patent specifications and claims.

Restated, a large volume of off-the-shelf suspension components and chassis attachment hardware for that conventional suspension apparatus has been the basic building blocks for both prior art commercial vehicles and their associated conventional suspension apparatus. Contrarily, there has been no specific design efforts demonstrated by prior art patents for commercial vehicles where a new non-conventional suspension apparatus was initially designed to be an integral part of the new vehicle design and, in that specific case, the new non-conventional suspension apparatus accordingly avoided the use off-the-shelf suspension components and chassis attachment hardware. Therefore, there is no prior art for commercial vehicles, and especially for passenger semi-trailers and articulated busses, where the new vehicle and its associated chassis contains a specific integral feature which combines the new vehicle design, while at the same time, also makes integral structural provisions for the installation of a non-conventional suspension apparatus which operationally supports the vehicle along its centerline as part of the overall vehicle design itself.

Further still, there is no prior art for commercial vehicles, and specifically for passenger semi-trailers and articulated busses, where there are advance structural provisions in the issued patent which provides for the future installation for an anti-jacknifing restraint apparatus and an installation for a anti-jacknifing detection apparatus which addresses the persistent semi trailer jackknife problem. Further still, one of the broad design failings of the prior art for commercial vehicles is the non-recognition of weight and balance criteria in the original manufacture of the vehicle as well as the all-important daily operating characteristics of the vehicle which has inevitably lead to chronic rollover problem that has yet to be addressed by commercial vehicle designers. National highway safety statistics attests to this important issue which is particularly applicable to freight ‘box’ semi-trailers and tanker semi-trailers in which a fully loaded vehicle can have a center of gravity point some five to seven feet above the road surface level.

Fully occupied motorcoach busses suffer a similar operational problem where the passenger seating is higher, e.g. a center of gravity point which may be five to six feet above the road surface as compared a regular bus and articulated bus configurations which have a somewhat lower center of gravity point. Motorcoaches, for example, many having a maximum 56 passenger seating capacity, would have a 9800 pound passenger load, the center of gravity for that maximum passenger loading occurring approximately 26 inches above the floorline of the vehicle, and so, the empty manufactured vehicle weight and the operational vehicle weight considerations are not realistically addressed by commercial vehicle patent specifications and claims.

For purposes of computational comparison, the Federal Aviation Administration (FAA) sets a 175 pound weight standard for the average passenger for the purposes of computing weight and balance characteristics of an aircraft, both during the manufacturing and operational phases. Using that same average passenger weight standard for passenger semi-trailers, articulated busses, motorcoach busses and regular busses, we can calculate the passenger load by the number of seats within the vehicle. Further, the average location of the center of gravity for a seated passenger occurs at the waist line, thus the total passenger load and the average location of the center of gravity for that passenger load is now a known factor which will produce a realistically updated weight and balance analysis for a fully occupied passenger vehicle.

Another broad design failing of the prior art for commercial vehicles is the non-recognition in the patent specifications and claims where future failure modes for the invention are not addressed, thus avoiding any mention of a number of distant operational design problems. Such design omissions have a direct impact upon passenger safety specifically regarding passenger semi-trailers, motorcoach busses, articulated busses and regular busses. One failure mode would be the example where the vehicle cabin and vehicle chassis structure are not originally designed to have a fail-safe standard of crashworthiness with regard to cabin structural integrity during rollover events and straight-on impact events or with regard to cabin structural integrity during side impact events. This long-held prior art design criteria for passenger semi-trailers, busses and articulated busses is primarily formulated to create a lightweight vehicle structure which offers a higher vehicle fuel economy due to its lower weight. Yert, in a most practical sense, the ongoing costs of vehicle collision and liability insurance must be pragmatically added to the ongoing costs of fuel since the consistently high accident rates upon the highways of this nation is very substantial, thus the subject of vehicle crashworthiness must be realistically approached in new land vehicle designs and specifically with commercial passenger semi trailer vehicle designs

First, as a comprehensive preamble to the following detailed descriptions which are to follow, it is important to consider the well established principals of land vehicle design which have been selectively improved for both the constructional and operational features of the semi-trailer cabin structure module (150) and the lower structure module (152) all of which have been equally and uniquely merged with selected commercial aviation vehicle design principals, namely, the concept of vehicle weight and balance considerations, the concept of the single, top, flat production joint face (548) assembly methodology along with other vehicle safety design concepts, such as component, system and structural redundancies, otherwise known as fail-safe design principles in the aviation industry. Because the preferred embodiment is a passenger carrying vehicle, as the number of fail-safe design features increase with the construction of these two major modules, (150, 152) the overall level of vehicle crashworthiness increases proportionally.

Further, both the preferred and alternate embodiments of this invention have advanced structural provisions for the future installation of an anti-jacknifing sensing and restraint system.

Secondly, minding the following detailed descriptions which are to follow, it is important to consider that a novel pneumatic unipoint suspension system has been uniquely and inherently operationally merged with the lower structure module (152) design in which three integral compartments, namely the forward guideplate compartment (182), cylinder compartment (184), aft guideplate compartment (186), have all been specifically incorporated to receive the two pneumatic unipoint suspension (114) components within the top portion of the cylinder compartment as well as a novel wheel unit (84), its wheel unit shaft (424) along with the wheel unit shaft forward and aft external members which captively locate the wheel unit (84) within the lower portion of the cylinder compartment (184) of the vehicle.

Thirdly, equally noting the following detailed descriptions which are to follow, it is important to consider that the collective novel design of the two pneumatic unipoint suspension (114) components as well as a novel wheel unit (84), its wheel unit shaft (424) along with the wheel unit shaft forward and aft external members which captively locate the wheel unit (84) within the confines of the cylinder compartment (184) portion of the vehicle, in no way, utilizes any prior art conventional suspension apparatus and, in no way, utilizes any prior art conventional suspension hardware. Finally, further noting the following detailed descriptions which are to follow, it is important to consider the redundant structural design features of the two major modules (150, 152) which have alternate path loading provisions for major structural members should any other related prime load-bearing member fail in any number of ways.

The preferred materials used to construct the cabin rollcage structure (564) upon which the semi-trailer cabin structure module (150) is eventually fully assembled and the preferred materials used to construct the lower structure module (152) can be primarily cold-rolled steel in combination with various other high strength steels such as chrome-moly steel as one example. In any case, maintaining the priority high strength design requirements for both the cabin rollcage structure (564) and the lower structure module (152) while still maintaining the overall key design objective a properly apportioned weight and balance for each of the two major vehicle modules (150, 152) calls for diligent efforts to creatively explore other alternate material opportunities thereby merging the aforementioned structural steel construction techniques in concert with other alternate structural techniques which employ materials such as various types of aluminum, carbon fibre materials, fiberglass or any other suitable alternate materials for both the structural and non-structural portions of the preferred and alternate embodiments of the invention. In all of the cases of alternate materials for both the structural and non-structural aspects of the modular passenger semi-trailer (62), the appropriate and approved assembly methods for each of these alternate materials will be observed during the manufacturing phase of the vehicle. In any case, the suggested exclusive use of various steels in the manufacturing of the vehicle is used herein for discussion purposes only and the structural portions of each of the two major vehicle modules (150, 152) must not be limited or restricted exclusively to the various forms of steel.

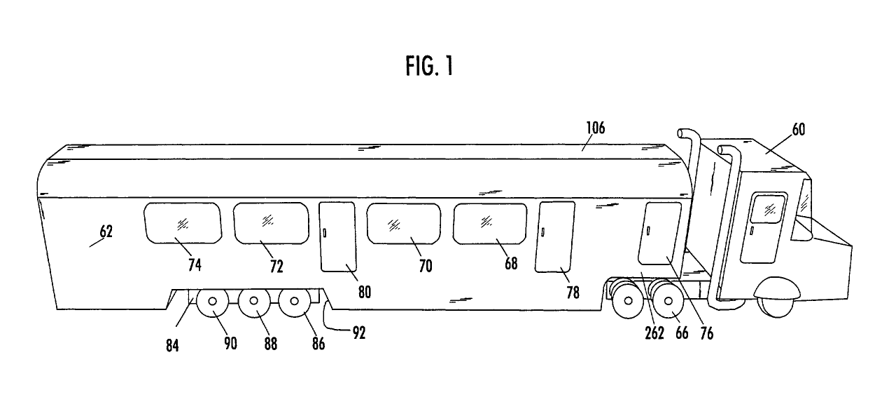

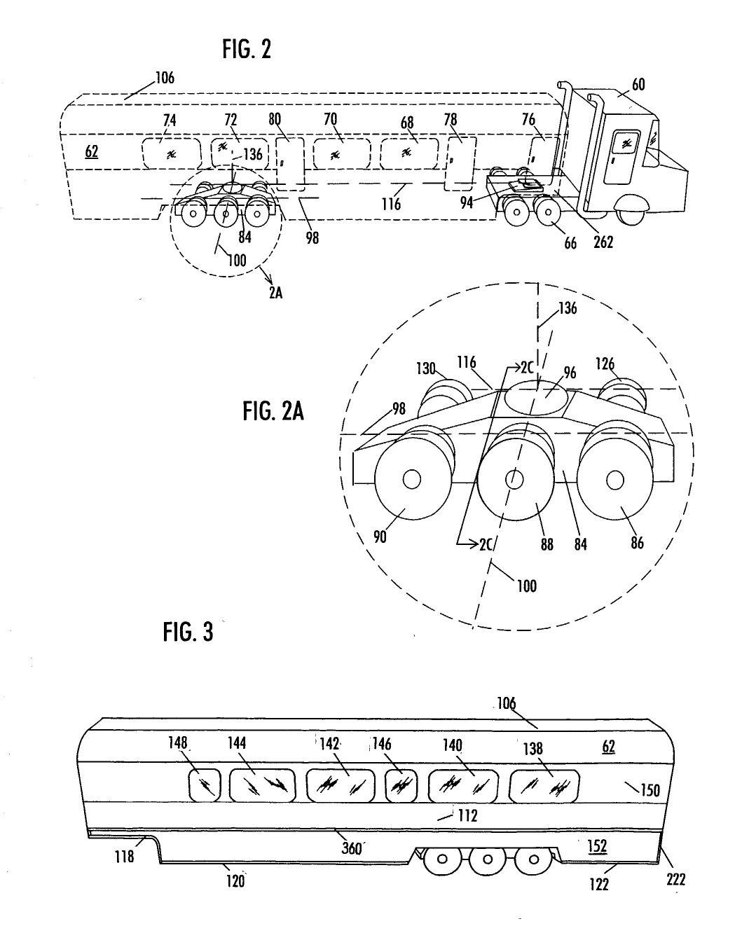

The following descriptions relate to both the preferred and alternate embodiments of the invention, one being a modular passenger semi-trailer (60) and the other being a modular freight semi-trailer (64). In both instances, each vehicle type is towed down the road by what is commonly known as a Class 8 tractor However, it must be understood that each vehicle type, whether it is a passenger or freight configuration, may be towed by an appropriately DOT approved tractor and the invention must not be limited or restricted to a Class 8 tractor specifically. In that regard, a typical tractor (60) approved for towing the vehicle is shown in FIG. 1 and FIG. 2. whereby the weight of the forward portion of the depicted passenger semi-trailer (62) is transmitted to the usual tractor fifth wheel plate (94) and thereupon that weight is distributed to the tractor drive wheels (66).

As with other semi-trailer configurations, this semi-trailer is mechanically and pivotally connected to the tractor fifth wheel plate (94) by a downwardly projecting king pin beneath the forward overhanging portion of the vehicle, in this case, the towplate compartment (262). In both the preferred and alternate embodiments, an oversized diameter king pin (160), having a diameter of at least two times that of a standard industry approved king pin, is thusly depicted in FIG. 9. By having an oversized diameter king pin (160), the vehicle combination of tractor and semi-trailer has an added operational fail-safe design feature in that all of the shear and bending forces normally imposed upon the king pin is effectively handled by the substantially larger cross-sectional area afforded by this particular king pin design.

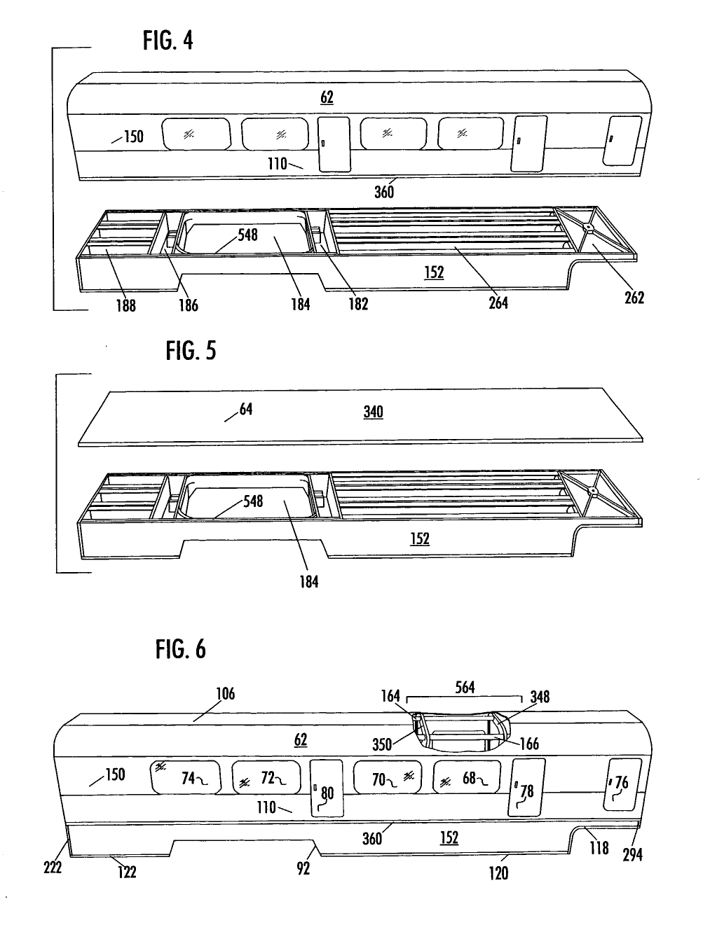

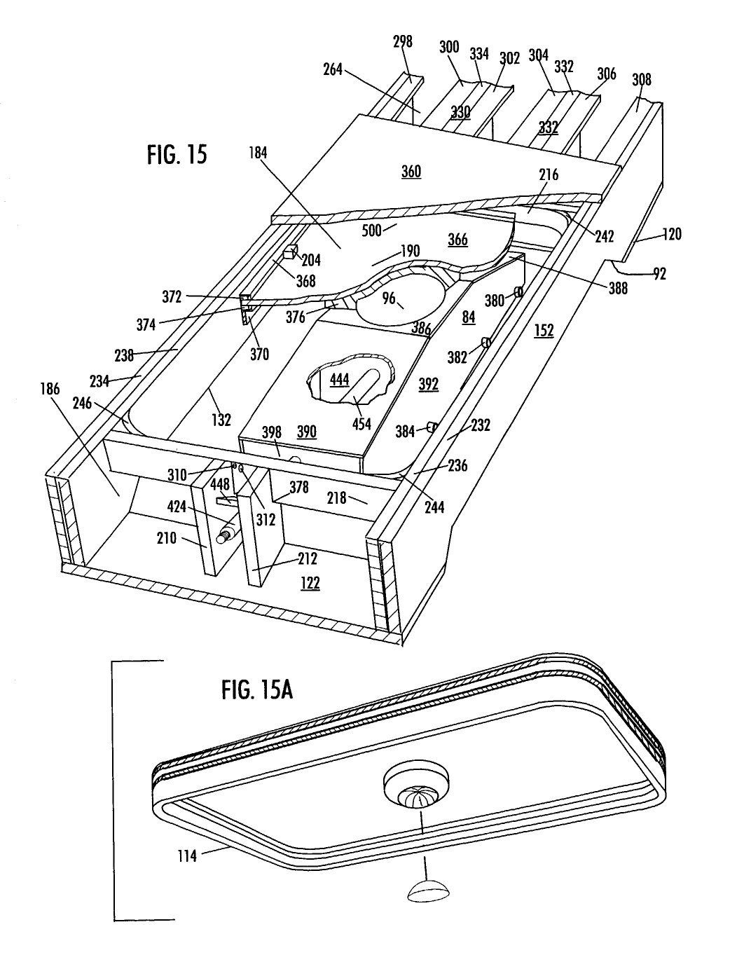

FIG. 2 illustrates the novel means of centrally suspending the entire weight of the passenger semi-trailer by showing the pendulous longitudinal axis or datum line (116) also succinctly referred to in these specifications as the datum line. In this design, which is equally used by both the preferred and the alternate embodiments of the invention, the entire vehicle is supported at a single point at its forward end, the tractor fifth wheel plate (94) and at a single point at the generally rear portion of the vehicle by the truncated hemisphere (96). FIG. 15A shows the mechanical relationships between the two functional members of the pneumatic unipoint suspension system (114) which operates within the cylinder compartment (184) which is located at the generally rear portion of the lower structure module (152), the empty cylinder compartment (184) being illustrated in FIG. 4 for the preferred embodiment and in FIG. 5 for the alternate embodiment.

FIG. 15 gives a more detailed, fragmented, breakaway top view of the two functional members of the unipoint suspension system along with other design features contained within the cylinder compartment (184). The first functional member of the unipoint suspension system is the piston assembly (366) which is accommodated within the cylinder compartment and operates in a slidable and vertically reciprocal fashion. The piston assembly (366) is not affixed to any portion of the cylinder compartment (184) by any conventional suspension hardware. FIG. 14 thereafter depicts the lower face of the piston assembly (366) showing the centrally affixed piston socket (376). Therefore, the second functional member of the unipoint suspension system consists of both the piston socket (376) which is centrally affixed to the lower horizontal face of the piston assembly (366) and its compressively sandwiched truncated hemisphere (96).

FIG. 15 once again shows the dome-shaped upper face portion of the truncated hemisphere (96) as it is compressively sandwiched within the concaved portion of the piston socket (376) while the flat lower face portion of the truncated hemisphere (96) is rotatably and slidably operative upon the flat, top portion of the wheel unit (84), also illustrated in FIG. 15 which is indicated as the wheel unit platform plate (386). Thereafter, the weight of the rearmost portion of the vehicle is transmitted downwardly throughout the various structural members of the wheel unit (84) and thereafter to the three fixed through-axles, axle one (418), axle two (420), axle three (422) and thereafter to each of the six wheel groups, namely wheel group one (126), wheel group two (86), wheel group three (128), wheel group four (88), wheel group five (130) and wheel group six (90) and thereafter to road surface.

Because the unipoint suspension system centrally supports the weight of the passenger semi-trailer (62) in alliance with the tractor fifth wheel plate (94), this novel suspension design shows that there is no conventional suspension apparatus used to support the vehicle nor is there any conventional suspension hardware used to connect the two unipoint suspension members (114) or the wheel unit (84) and its wheel unit shaft (424) and its forward and aft external components to any portion of the lower structure module (152). The design is extremely simple, rugged, operationally flexible in that the wheel unit (84) is captively contained within the cylinder compartment (184) yet freely moves along its combined vertical, lateral and longitudinal axis as shown by FIG. 21, FIG. 22 and FIG. 24. Further, because of its substantially sized cylinder compartment (184) and the substantially sized piston assembly (366) operating within that compartment, the suspension system operates at an extremely low air pressure because of the extremely high air volume contained within the air chamber (500), all of these proportional relationships again being illustrated by FIG. 15.

The modular passenger semi-trailer (62) is designed with weight and balance and basic structural criteria that is effectively followed during both the manufacturing phase and later on, during the operational road phase. Objectively, the lower structure module (152) must always weigh more than the semi-trailer cabin module structure (150) so as to achieve a low vertical center of gravity point for the assembled vehicle, both during the manufacturing phase and thereafter, during the operational road phase. Although the preferred embodiment as illustrated in FIG. 4 illustrates a completed semi-trailer cabin module structure (150) in its fully assembled modular pre-assembly phase, the manufacturing procedures described herein are designed to be generally descriptive and must not be construed to be limiting in any way in that a variety of manufacturing procedures may be successfully employed regarding the semi-trailer cabin module structure (150) and its eventual attachment to the lower structure module (152). Nevertheless, the fully assembled semi-trailer cabin structure module (150) is the preferred manufacturing technique for a production line environment.

In that preferred procedure, all of the interior seating is installed in addition to all of the other interior equipment so as to produce a complete the module assembly. Regardless of the assembly procedures employed to create the semi-trailer cabin structure module (150), it will always eventually be placed upon the single, top flat production joint face (548) of the lower structure module (152), a preferred manufacturing procedure that is shown by both FIG. 4 and FIG. 5.

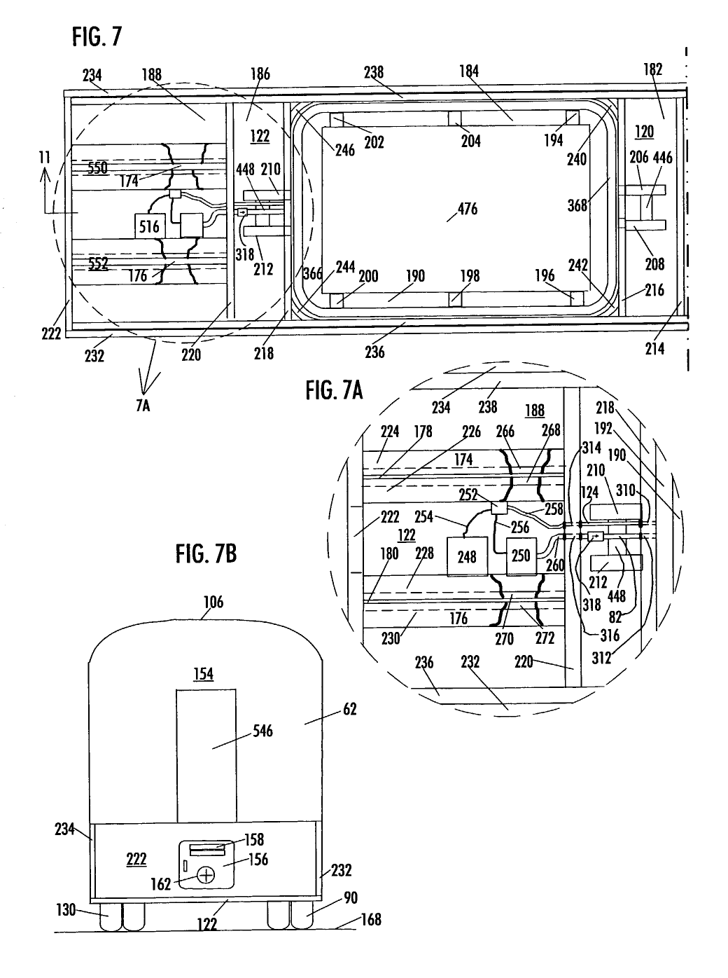

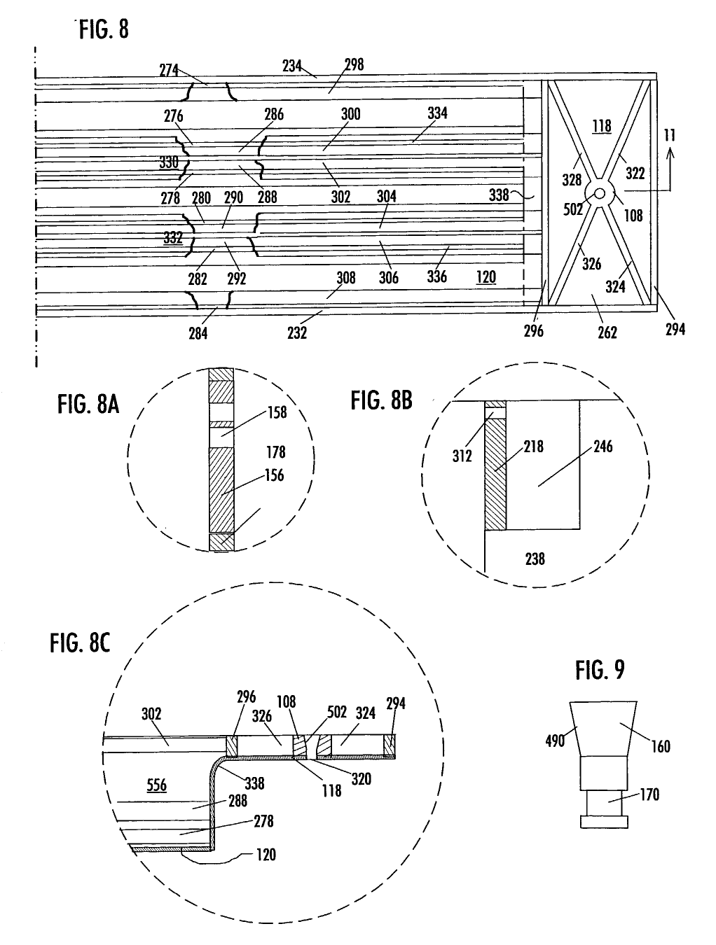

The lower structure module (152) has various structural members which provide transverse stiffening to that module (152), along with the required weight to accomplish a low vertical center of gravity point for the module. The forward end transverse stiffening structures are specifically shown in FIG. 8, the towplate compartment (262), forward plank (294), the four diagonal planks (322, 324, 326, 328) and the closing plank (296). The forward spar compartment (264) has transverse stiffening at its forward end by the vertically disposed section of the forward baseplate (118) and at its aft end by the forward spar bulkhead (214) as shown in FIG. 7. This drawing also shows the transverse stiffening members for the remaining compartments, specifically the forward cylinder wall (216), aft cylinder wall (218), aft spar bulkhead (220) and the aft spar compartment end bulkhead (222). The lower structure module is also longitudinally and transversely stiffened by the forward baseplate (118) and mid baseplate (120) as depicted in FIG. 8 and the aft baseplate (122) as depicted in FIG. 7. The final longitudinal and transverse stiffening of this module (152) is completed with the assembly of the cabin Doorplate (360) which is eventually weldably attached to the single, top flat production joint face (548) of the lower structure module (152).

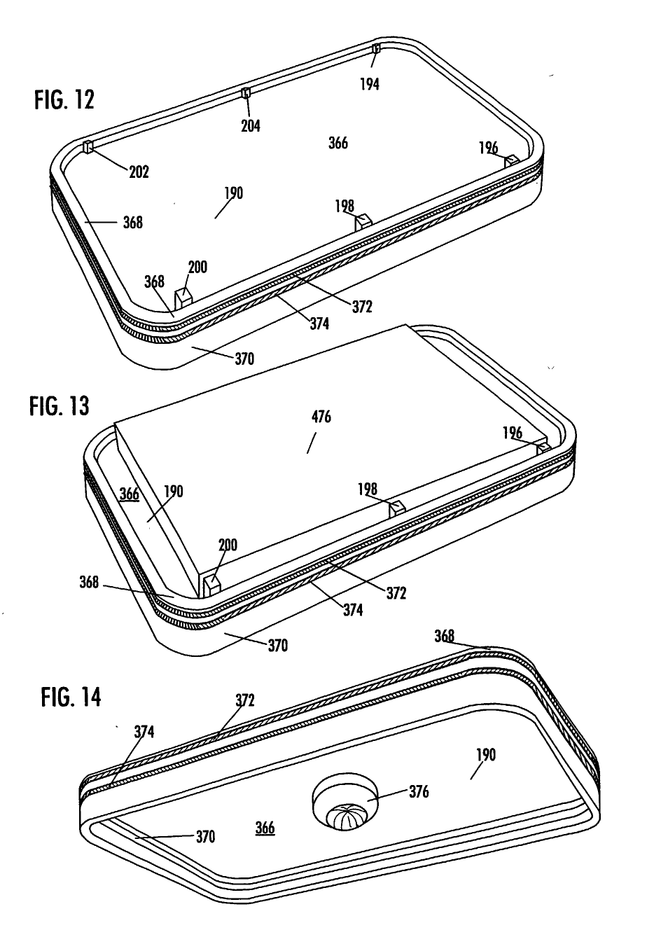

The single, top flat production joint face (548) manufacturing procedure for this invention simplifies the final assembly process and it opens up the possibility for the creation of a wide variety of vehicle designs which do not limit it to the modular passenger semi-trailer (62) configuration as described herein. In the alternate embodiment illustrated in FIG. (5), the substitution of a simple flat plate upon the single, top flat production joint face (548) quickly changes the vehicle into an industrial configuration by the installation of the semi-trailer flatbed module (340) shown in FIG. 5 which can carry regular freight on its flatbed surface and a fluid cargo in a sealed and plumbing-equipped forward spar compartment (264) which can be easily visualized as illustrated in the cross-sectional view of FIG. 11. With a lower fluid compartment in use, the alternate embodiment industrial version of the vehicle will always have a low vertical center of gravity point which is a major advantage when considering rollover accidents for conventional tanker semi-trailers. In the alternate embodiment illustrated in FIG. 5, although the illustrated embodiment there has shown one configuration of an industrial form of the vehicle, the invention should not be limited or restricted to this illustrated embodiment in that many versions of an industrial vehicle can be designed with the single, top flat production joint face (548) procedure.

As an example, one alternate embodiment depicted by FIG. 5, a modular freight semi trailer can consist of a flatbed (340) portion of the vehicle which can be outfitted with special quick-disconnect fittings along its length so as to accept modular freight container loads or Quonset-hut shaped fluid containers, all of which can be quickly loaded and off-loaded from the freight semi-trailer flatbed portion of the vehicle. Further, the front spar compartment (264) has the capability of being sealed, have an installation of internal plumbing and valves and become a fluid carrying compartment for the vehicle depicted in FIG. 5, the filled fluid compartment achieving a low vertical center of gravity for the vehicle.

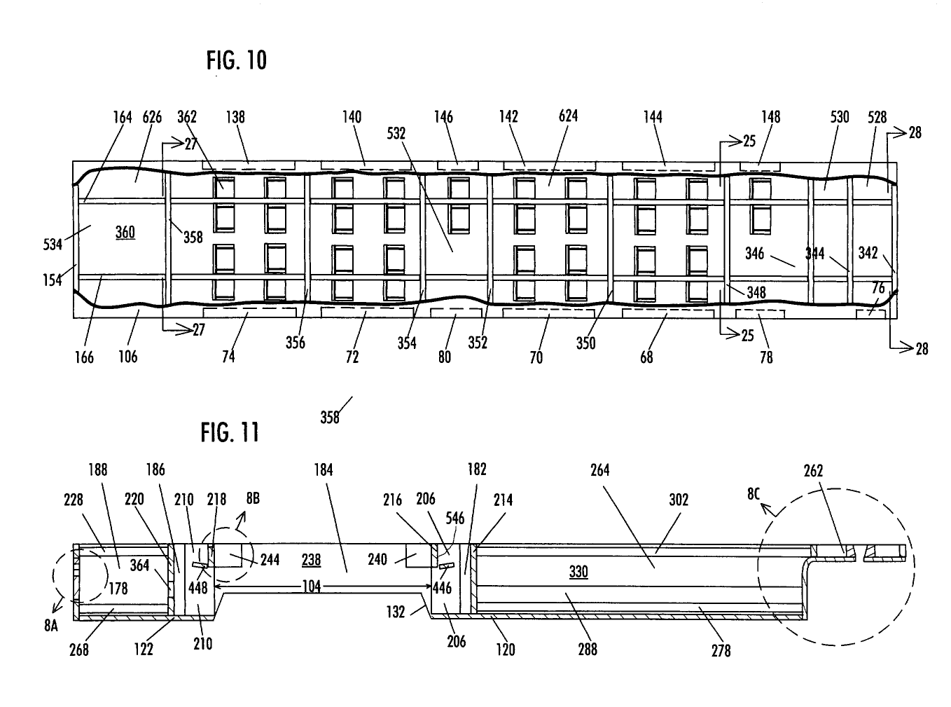

FIG. 10 is a symbolic illustration of a typical cabin interior arrangement. This breakaway top view of the semi-trailer cabin structure module (150) shows a suggested compartmentalization of the vehicle along with structural and interior details of the passenger semi-trailer. At the forward end of the vehicle, the closed forward compartment (528) is depicted, which is adjacent to the forward cabin compartment (530), which is adjacent to the main cabin compartment (532), which is adjacent to the aft cabin compartment (534) being located at the aft end of the passenger semi-trailer. Although FIG. 10 shows a typical cabin passenger seat (362) amongst a typical 36 seating arrangement, the invention should not be limited or restricted to this particular cabin compartmentalization format or to the typical seating arrangement shown in the drawings in that many versions of cabin compartments and cabin seating arrangements are possible with this invention.

Of particular interest is the interior rollcage structure (564) which is illustrated by both FIG. 10 also offers a vehicle-length top view of the cabin Doorplate (360). The cabin Doorplate (360) forms the foundation upon which all structural members, interior seats and other interior equipment are placed and affixed in place. Dimensionally, the cabin Doorplate (360) will always completely overlay the total top face area of the lower structure module (152) and the ideal production situation would be to receive a single plate from the steel supplier that would meet those dimensional requirements, however should his not be possible, the cabin Doorplate (360) may be also constructed of smaller plates of appropriate dimensions and welded together to form the proper final dimension prior to the assembly to the lower structure module (152).

FIG. 10 and FIG. 6 provides two views on how this constructional concept has the organizational ability to create interior cabin compartments with the utilization of the various types of cabin bulkheads available in this invention. With regard to the fail-safe cabin rollcage structure (564), it can be seen that FIG. 6 offers a demarcated sectionalized top breakaway view of some of the components of this interior structure arrangement, namely the left cabin rollover tube (164), the right cabin rollover tube (166), cabin former assembly one (348) and cabin former assembly two (350). FIG. 10 provides a more detailed, vehicle-length overview of all of the cabin rollcage structure (564) in a front-to-rear order, namely the forward closed cabin bulkhead one (342), forward closed cabin bulkhead two (344), forward cabin door bulkhead (346), cabin former assembly one (348), cabin former assembly two (350), cabin former assembly three (352), cabin former assembly four (354), cabin former assembly five (356), aft cabin door bulkhead (358) and the end cabin door bulkhead (154). Although FIG. 10 offers a top view of the locations of the various external windows and doors, FIG. 3 best illustrates the window arrangements for the left side of the passenger semi-trailer while FIG. 6 illustrates the door and window arrangements on the right side of the vehicle. Starting at the forward end of the vehicle, FIG. 6 illustrates the forward closed compartment access door (76), forward cabin door (78), aft cabin door (80), large window one (68), large window two (70), large window three (72), large window four (74) while FIG. 6 collectively illustrates large window five (138), large window six (140), large window seven (142), large window eight (144), small window one (146) and small window two (148). Finally, FIG. 7B depicts the exterior cabin end bulkhead door (546). It is to be understood that all of the exterior door and exterior window arrangements collectively illustrated in FIG. 3, FIG. 6 and FIG. 7B should not be limited or restricted to the illustrated embodiments in that many versions of external door and external window shapes and arrangements can be employed for a wide range of different exterior designs for the modular passenger semi-trailer (62) as well as any other alternate embodiment of the invention.

FIG. 6 also illustrates the vehicle-length cabin covering material (106) which completely encloses the top portion of the passenger cabin and wraps down on both sides of the vehicle and extends down to the level of the bottom window line for both sides of the passenger semi-trailer. As both FIG. 3 and FIG. 6 both show, there are appropriate openings in the cabin covering material (106) so as to accommodate the various openings for all of the various exterior side windows and side doors for the vehicle. The cabin covering material (106) may consist of sheet aluminum, sheet stainless steel, sheet or molded composite material, sheet or molded fiberglass or any other material or combinations of materials that properly provide a vehicle-length enclosure for the preferred embodiment passenger cabin or appropriate enclosures for any alternate embodiment combination of cabins.

Although FIG. 3 and FIG. 6 do not specifically depict any passenger emergency escape hatches on the top, flat portion of the cabin covering material (106), it is to be understood that several DOT approved passenger emergency escape hatches or other proprietary designed passenger emergency escape hatches must, by DOT regulation, be positioned at various and appropriately DOT approved locations flush within the top portion of the cabin covering material (106) along the length of the vehicle. The internal cabin rollcage structure (564) first starts to take shape with the preliminary assembly of the two cabin rolltubes, the various cabin former assemblies and the various types of cabin bulkheads.

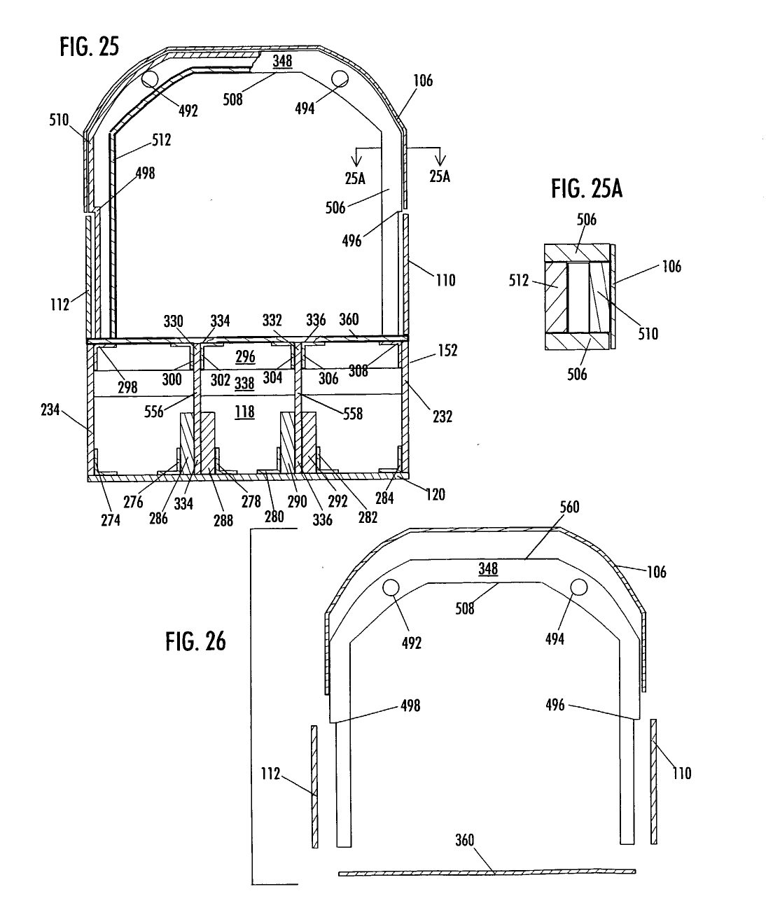

FIG. 25, FIG. 25A and FIG. 26 all collectively illustrate the basic cabin former assembly and its eventual relationship with the lower structure module (152). FIG. 25 is a cross-sectioned end view of a typical cabin former assembled over the lower structure module (152) which also shows a breakaway section to demonstrate the internal structure of the cabin former assembly. As with each typical cabin former plate (506) and each cabin bulkhead type, each has an assembly hole for the left cabin rollover tube (492) and a hole for the right cabin rollover tube (494) into which are inserted the vehicle length left cabin rollover tube (164) and the right cabin rollover tube (166). Each rolltube assembly hole is precisely located on the various cabin former assemblies and the various cabin bulkheads so as to properly execute a precision assemblage of those structural members.

As the breakaway portion of FIG. 25 illustrates, each high strength cabin former assembly is of a sandwiched construct consisting of two outside typical cabin former plates (506) with a single cabin exterior profile bar (510) and a single cabin interior profile bar (512) properly placed in the interior portion of the assembly and all members being welded one to another to form the completed cabin former assembly. FIG. 25A is a rotated, top cross-sectioned view of the constructional relationships of the assembled two typical cabin former plates (506), the cabin exterior profile bar (510), the cabin interior profile bar (512) and the outside portion of the cabin covering material (106) as it is eventually attached to each cabin former assembly. The vehicle-length cabin rolltube assembly procedure offers three important advantages over the prior in that, (a) it provides a simplistic assembly procedure for the creation of the cabin portion of the vehicle, and (b) it offers a highly flexible design options wherein various internal cabin compartments can be quickly created by the slidable assembly of various types of cabin bulkheads and cabin former assemblies at various locations along the vehicle-length of the two rolltubes, and (c) the two rolltubes, as they project through each cabin former assembly and cabin bulkhead unit, even this preliminary stage of the assembly of structural members, quickly and simply produces a very strong, self-standing assemblage once all members are properly positioned. Once all members are eventually welded one to another, the welded members, particularly at all of the various welded junctions of the rolltubes, cabin formers and cabin bulkheads, establishes a highly stiffened structure that is very resistant to a ‘domino’ type of cabin collapse.

Once the preliminary cabin rollcage structure (564) is assembled, it is thereafter welded to the right side cabin segmented sideplate (110) and the left side cabin sideplate (112). Thereafter, all of the lower portions of the various cabin formers, the lower portions of the various cabin bulkheads, along with the lower portions of the right side cabin segmented sideplate (110) and the lower portions of the left side cabin sideplate (112) are all subsequently welded to the cabin Doorplate (360) which finalizes the high-strength cabin rollcage structure (564). It is to be understood that each cabin sideplate member, functioning as part of the vehicle length rollcage structure (564), acts as a longitudinal fail safe member should any primary structural member of the lower structure module fail.

It is upon the vehicle length rollcage structure (564) that all of the other external and internal non-structural members are attached to complete the finalized semi-trailer cabin structure module (150). In keeping with the weight and balance design criteria, a plurality of non-structural materials will be selected so as to achieve the lightest practical weight while maintaining sufficient strength characteristics for a particular external or internal member or construction of any piece of internal equipment within the semi-trailer cabin structure module (150).

The present semi-trailer cabin structure module (150) utilizes the right side cabin segmented sideplate (110) and the left side cabin sideplate (112) so as to properly address that longstanding design oversight as illustrated by FIG. 3, FIG. 4 and FIG. 6. Both FIG. 25 and FIG. 26 depict the cross-sectional profile of the cabin covering material (106) and how it slips over the vehicle-length exterior profile of the semi-trailer cabin structure module (150). FIG. 25 illustrates as to how a typical cabin former assembly can be attached to the cabin floorplate (360) along with its assembled relationship to the lower structure module (152). Also illustrated are the typical recess for right cabin segmented sideplate (496) and typical recess for left cabin sideplate (498) which is a common design feature for all cabin former assemblies and all cabin bulkheads. The two recesses for each unit provides a flush nest for the insertion of the respective cabin sideplates for precision assembly purposes and once the sideplates are welded into place onto each cabin former assembly and onto each cabin bulkhead, the right and left sideplates substantially longitudinally stiffen the cabin rollcage structure (564) prior to its eventual attachment to the cabin floorplate (360).

It is important to understand that the illustrated embodiments for the typical cabin interior cabin profile (508) and the typical cabin exterior profile (560) must not be limited or restricted exclusively to the profiles shown in the drawings in that the novel design flexibility for this invention can offer many dimensional and profile variations for both the interior and exterior portions of the vehicle and that these variations can occur on each respective cabin former assembly and each cabin bulkhead which can ultimately produce a cabin enclosure having a variety of compound curves and various other dimensional variations so as to meet specific cabin design requirements for the both preferred and alternate embodiments of the invention. In all cases where variable external and internal profiles and dimensions are employed to create a cabin construct that does not necessarily have a conventional straight-line vehicle-length exterior and interior appearance, each modified cabin former assembly and each modified cabin bulkhead type will always have identical hole locations for the installation of the vehicle-length cabin rolltubes (164, 166). Further, because of the unique combination of the vehicle-length modified rolltube and modified cabin bulkhead design features, the illustrated embodiments shown in FIG. 1, FIG. 2, FIG. 3 and FIG. 6, all of which illustrates the passenger cabin portion of the preferred embodiment, must not be limited or restricted to a vehicle-length, single cabin design concept as illustrated in the specification drawings.

Indeed, the opportunity exists where two or more independent cabin units can be welded or otherwise affixed upon the cabin Doorplate (360) and then the fully assembled module subsequently being placed upon the length of the lower structure module (152). Although this configuration is not shown in the drawings, this described alternate embodiment is completely within the realm of easy vehicle redesign. In keeping with a multi-cabin design, one possible alternate embodiment that is not shown in the drawings could be a configuration where two cabins are welded or otherwise affixed to the cabin Doorplate (360), such a vehicle serving as a mobile medical semi-trailer, a variant modular design whereby one cabin unit could serve as a surgical operating room and the second cabin unit serving as a post-operative recovery room.

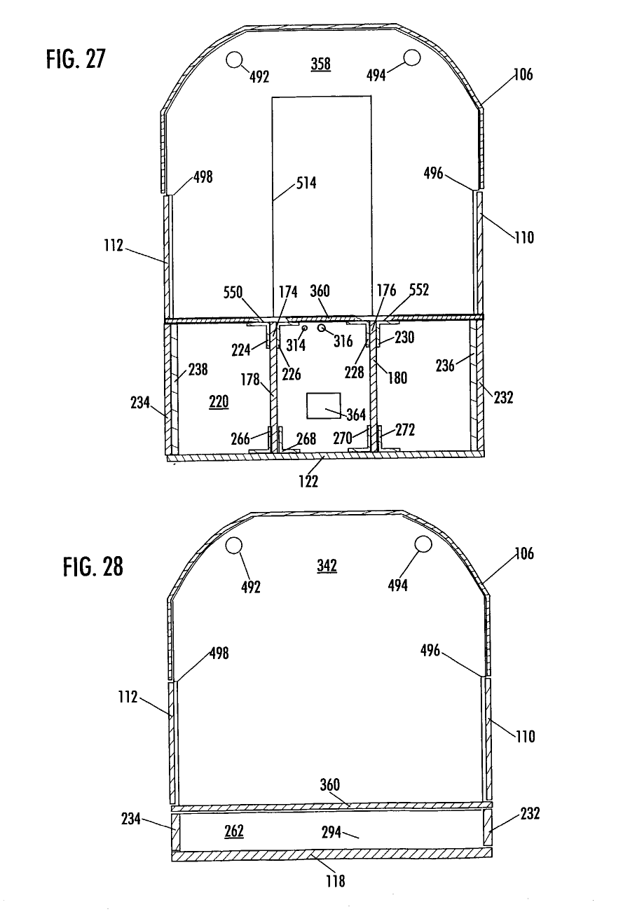

Besides serving as a means of cabin compartmentalization, the cabin bulkhead types shown in FIG. 27 and FIG. 28 offer a more substantive function in that they serve as fail-safe or redundant structural members should any cabin former assembly fail during either a side impact event or rollover event during a vehicle accident. For the instant invention described here, FIG. 27 depicts a typical cabin door bulkhead with its cabin interior door cutout (514), two examples of which describe the various semi-trailer cabin structure module (150) cabin interior bulkheads which provide inter-compartment access, namely the forward cabin door bulkhead (346) and the aft door cabin bulkhead (358) while the end cabin door bulkhead (154) serves as the exterior closing bulkhead for the aft end of the semi-trailer cabin structure module (150). From a structural point of view, as the two types of bulkheads illustrated in FIG. 27 and FIG. 28 are either welded or affixed to the cabin Doorplate (360), in addition to the welded connections to the right and left cabin sideplates (110, 112) and the two upper rolltubes (164, 166), the installed bulkhead offers a substantial lateral stiffening of the passenger cabin structure which is a key element in the crashworthiness criteria for this invention.

Further, because each of the five illustrated cabin former assemblies (348, 350, 352, 354, 356) are equally welded to the right and left cabin sideplates (110, 112), the rollover bend point (554) for each cabin former assembly vertical member is raised to the top edge of each cabin sideplate which is, for this particular vehicle design, estimated to be some 36 inches above the surface of the cabin floorplate (360) which further substantially adds to the structural integrity of the passenger cabin for this modular passenger semi-trailer (62). In effect, the two cabin sideplates (110, 112) when welded to the cabin Doorplate (360) structurally acts like a large channel section which longitudinally stiffens the vehicle. The top edge of both the right and left cabin sideplates (110, 112) also serves as the lower window line for all of the windows depicted in the various illustrations for this invention. The closed bulkhead depicted in FIG. 28, i.e., the forward closed cabin bulkhead one (342) and the forward closed cabin bulkhead two (344) can create structurally strong closed cabin compartments which can be easily accessed by an external door as evidenced by the forward closed compartment access door (76). Each of the bulkhead types depicted in the illustrations can be of a single thickness construction, the material thickness being dictated by both the weight and balance and fail-safe design criteria for the passenger semi-trailer, however, the constructional details for any cabin bulkhead must not be limited or restricted to the illustrated embodiments in that a variety of bulkhead constructional features may be accomplished in both the preferred embodiment and in the various alternate embodiments of the invention.

The second major module of both the preferred and alternate embodiments is the lower structure module (152) which is a vehicle-length closed box beam structure. The lower structure module (152) is comprised of six compartments which are, in a forward to aft sequence, the towplate compartment (262), the forward spar compartment (264), the forward guideplate compartment (182), the cylinder compartment (184), the aft guideplate compartment (186) and the aft spar compartment (188).

The following description of the towplate compartment (262) follows. FIG. 4 and FIG. 5 provides proportional illustrations of the six compartments of the lower structure module (152), one being the forward towplate compartment (262). FIG. 8 is a top view of the towplate compartment (262), showing its various internal members such as the forward baseplate (118), the kingpin collar (108), forward diagonal plank one (322), forward diagonal plank two (324), forward diagonal plank three (326), forward diagonal plank four (328), the forward plank (294) and the closing plank (296).

FIG. 8C is a cross-sectioned side view of this same compartment which provides further structural details such as the king pin tapered hole (502) that exists within the kingpin collar (108) and the horizontal and vertical dispositions of the forward baseplate (118). The horizontal disposition of the forward baseplate (118) serves as a floor for the towplate compartment (262), the forward baseplate radius (338) creates a smooth directional transition thereby eliminating square comer stresses or welded seams which could fail while the vertical disposition of the forward baseplate (118) serves as a forward transverse closing bulkhead for the forward spar compartment. The bottom portion of the forward baseplate (118) vertical segment is accordingly welded to the forward edge of the mid baseplate (120), this particular baseplate serving as the floor for the forward spar compartment (264).

The towplate compartment (262) is specifically designed as a heavy duty, fail-safe structure which is operationally described as follows. All of the four diagonal planks (322, 324, 326, 328) are welded to the horizontal top face of the forward baseplate (118) as well as to their inboard contact points which abut the king pin collar (108), all of the diagonal planks acting to collectively center and mechanically support the kingpin collar (108) which is also welded to the horizontal top face of the forward baseplate (118). Each of the outboard portions of the four diagonal planks (322, 324, 326, 328) are respectively nested into the four inside corners of the towplate compartment as depicted by FIG. 8 and each single plank is welded to its respective compartment corner, all comers being formed by the following member assemblage as shown in FIG. 8; the forward necked portion of the right lower sideplate (232), the forward necked portion of the left lower sideplate (234), the transverse forward plank (294) and the transverse closing plank (296), both of these transverse compartment planks (294, 296) equally being welded to the top horizontal face of the forward baseplate (118) and to the vertical abutting faces of the two sideplates (294, 296).

One detail of the final manufacturing and assembly process for the towplate compartment would involve the cabin floorplate (360) installation, that member having an appropriate number of small holes drilled into it, all of the drilled holes being above all of the four diagonal planks so as to afford the creation of a number of spot weld points from above which will weldably affix the cabin floorplate (360) to the four diagonal planks below it. Since the forward portion of the semi-trailer cabin structure module (150) was previously and precisely installed over the towplate compartment and was earlier welded to the single, top flat production joint face (548) of that portion of the semi-trailer, the closed box beam section construct for this particular compartment will have been completed.

Although the drawings do not illustrate an appropriately sized king pin clearance hole over the center of the king pin collar (108), the embodiment as illustrated, must not be limited or restricted to omit such a clearance hole in the cabin floorplate which would accommodate the installation of the oversized diameter king pin (160) after the cabin Doorplate (360) installation is completed. During the king pin installation process, the king pin is hammered into place which forces the king pin tapered shaft section (490) to firmly fit into the king pin tapered hole (502) portion of the king pin collar (108). Once installed in this manner, the pin can be spot welded onto the king pin collar (108) which will secure it into position. Other means of securing the king pin in its seated position may also be employed in addition to the normal spot welds described above. This fail-safe structural arrangement is specifically designed to far exceed any multi-directional road forces that are always imposed on the oversized diameter king pin (160) which is another fail-safe safety feature, all mechanical features of this compartment being designed so as to insure that there will be no bending or shearing of the oversized diameter king pin (160) during normal or abnormal passenger semi-trailer operations as can be the case with the present industry-standard small diameter semi-trailer king pins. The heavy duty towplate compartment (264) structure with its oversized diameter king pin (160) are collectively designed to anticipate the future installation of an anti-jacknife detection and restraint system which will be installed on both the preferred and alternate embodiments of the invention.

A description of the forward spar compartment (264) follows. FIG. 4 and FIG. 5 provides proportional illustrations of the six compartments of the lower structure module (152), one being forward spar compartment (264) which is just aft of the forward towplate compartment (262). This compartment is the longest compartment within the lower structure module (152) and, as such is designed to withstand the downward and sideward bending forces imposed upon it during over-the-road and turning events. A preferred cross-sectional dimension for this compartment would be about the maximum width allowed by the DOT for semi-trailers, while the preferred height of the compartment would be the depth of the cylinder compartment containing its wheel unit, both dimensions producing an approximate rectangular closed box beam structure which will resist the previously mentioned operational bending forces imposed upon it.

It must be understood that the lower structure module (152) and all of its six compartments of the invention should not be limited or restricted to the various illustrated embodiments and suggested dimensions discussed in that many versions and arrangements of the six compartments for this major module are possible with this invention. As illustrated by both FIG. 8 and FIG. 25, the longitudinal stiffening for this front spar compartment (264) is achieved by the four primary compartment beam structures, the right lower sideplate (232), the right forward spar (332), the left forward spar (330) and the left lower sideplate (234). Each primary structure is further stiffened by the addition of compartment-length angles at both the top and bottom locations. The cross-sectional end view of FIG. 25 best illustrates the various angle attachments to the four primary structures as follows.

The first primary compartment beam structure, is created by three assembled components, the right lower sideplate (232) which is top stiffened by forward upper angle six (308) and bottom stiffened by the forward lower angle six (284). The second primary compartment beam structure, the right forward spar (332) is created by seven assembled components, the right forward spar web (558) which is top stiffened by forward upper angle five (306) and forward upper angle four (304), the combination of web (558) and angles (306, 304) creating the right forward top spar cap (336). The right forward spar web (558) is bottom stiffened by the assemblage of forward lower angle five (282), spar plank four (292), spar plank three (290) and forward lower angle four (280). The third primary compartment beam structure, the left forward spar (330), is created by seven assembled components, the left forward spar web (556) which is top stiffened by forward upper angle three (302) and forward upper angle two (300), the combination of web (556) and angles (302, 300) creating the left forward top spar cap (334). The left forward spar web (556) is bottom stiffened by the assemblage of forward lower angle by forward lower angle three (278), spar plank two (288), spar plank one (286) and forward lower angle two (276). The fourth primary compartment beam structure, the left lower sideplate (234), is top stiffened by forward upper angle one (298) and bottom stiffened by forward lower angle one (274).

Although steel channels approximating these configurations could be purchased from a steel supplier which would speed up the manufacturing process, the use of a variety of assembled angles allows for a flexible design with regard to the preferred and alternate embodiments, both embodiments achieving the overall total weight, balance and strength requirements for the lower structure module (152). In this specific regard, it can be seen that manufacturing procedure which employs angles of various weights and dimensions can be accurately selected by the vehicle designer. Since a passenger semi-trailer has specific design objectives that are consistent with its own total weight, balance and strength requirements, it is to be understood that an industrial version of this vehicle can have differing total weight, balance and strength objectives than its passenger counterpart, hence all of the components that comprise the four primary compartment structures can achieve these variable and selective design objectives with a custom assemblage of components. Further, another fail-safe feature of the invention focuses in on the subject of structural redundancy, specifically the principal of alternate path loading for each of these four primary compartment structures. With this fail-safe concept, a design process that has been successfully used in the commercial aviation manufacturing industry, two of the four primary compartment structures may fail in various ways in their support of the semi-trailer cabin structure module (150) which spans the forward spar compartment (264) while the two remaining primary compartment structures will continue to successfully bear the weight of that module (150) during that particular failure mode.

Because the forward spar compartment (264) is dimensionally the largest of all of the six compartments, its structure provides a large portion of the necessary weight for the lower structure module (152) which ultimately provides the low vertical center of gravity point for the entire vehicle. As illustrated by FIG. 25, the central characteristic of the weight and balance design of the invention focuses on the use of the four spar planks that are installed at the lowest point in the forward spar compartment (152), specifically spar plank one (286), spar plank two (288), spar plank three (290) and spar plank four (292). As illustrated, all four spar planks provide a modified lower spar cap configuration for the right and left forward spars (330, 332) as opposed to the more conventional spar cap configuration illustrated by left forward top spar cap (334) and right forward top spar cap (336).

During the manufacture of the lower structure module (152), the selection of material thickness for the various structural members that ultimately comprise that module (152) will properly achieve the low vertical center of gravity point for the eventually assembled vehicle, however, with the installation of the semi-trailer cabin structure module (150) with all of its seats and interior equipment already installed, it is expected that there will be some lateral imbalances for the completely assembled vehicle, consequently inboard planks, spar plank two (288) and spar plank three (290) offer the designer of the vehicle with counterweights that can offset any lateral imbalance in the completely assembled vehicle. For example, the leftmost affixed inboard spar plank, spar plank two (288) would be heavier than the rightmost affixed inboard spar plank three (290) thereby offsetting any right lateral imbalance that might be produced by the manufacturing process. In this manner, the low vertical center of gravity point is achieved while, at the same time, the newly manufactured vehicle achieves a close lateral balance condition which is paramount to its self-leveling characteristic during over-the-road operations.

The lateral positioning of the spars (334, 336) shown in FIG. 25, along with the illustrated affixed spar planks (286, 288, 290, 292) should not limit or restrict the invention in that the lateral positioning of each individual forward spar (334, 336) within the forward spar compartment (264) and the manner in which the spar planks may or may not be affixed to any structural member within the forward spar compartment (264) are all functions of any number of a variety of constructional arrangements that may be applied to either the preferred or to the alternate embodiments of the invention. One example of a constructional revision would show that the two spars could be relocated in close proximity to each other in order to form a centrally located keel beam for the vehicle, such a relocation of spars (334, 336) producing larger right and left cavities within the forward spar compartment (264) which would act as baggage holds for the preferred embodiment. In this constructional revision, spar plank two (288) could be affixed to the outboard side of the left forward spar (330) while spar plank three (290) could be affixed to the outboard side of the right forward spar (332). Properly dimensioned spar planks, affixed in this revised manner would also counterbalance any manufacturing lateral imbalances thereby leaving the two remaining spar planks (286, 292) to be respectively applied in a movable fashion in the right and left forward spar compartment cavities so as to compensate for expected passenger load lateral imbalances.

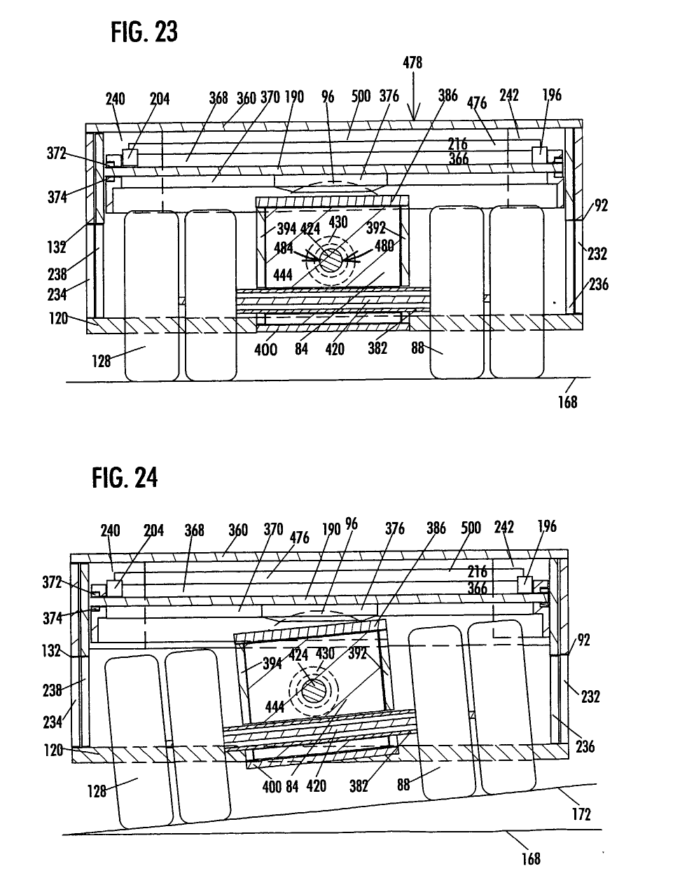

Positioned in a flat disposition while being centrally and longitudinally located on the floor surface of each compartment cavity, each plank could be mechanically or hydraulically shifted to either the right or to the left of its respective compartment cavity, either individually or collectively, in reaction for the expected passenger load lateral imbalances as the vehicle operates during its daily routine. With this constructional revision and in keeping with the fail-safe design of the four primary compartment beam structures, the right lower sideplate (232) and the left lower sideplate (234) can safely allow for cargo door cutouts so that the two compartment cavities under discussion may function as passenger baggage compartments. A typical operational lateral imbalance situation is illustrated in FIG. 23 where an off-center vertical load (478) is indicated along with the shifting forces which act tangentially at the wheel unit shaft (424) centerline as indicted by the right tangential shaft force (480) and the left tangential shaft force (484). The forward spar compartment (264) structure can be quickly and easily adapted to a future anti-jacknife retention apparatus which is a novel design feature of the invention.

The future anti-jacknife retention apparatus will be installed in a forward position in the space between the right forward spar (332) and the left forward spar (330), the future position of the apparatus being best visualized by the top view of the forward section of the front spar compartment (264) as illustrated in FIG. 8. The future anti-jacknife retention apparatus will utilize a connecting member which will join the modular passenger semi-trailer (62) with the towing tractor (60) and that this connecting member will project through an appropriately provided opening in the vertical segment of the forward baseplate (118) as best visualized by the cross-sectional drawing of the towplate compartment (262) as found in FIG. 8C.

A discussion of the cylinder compartment (184) and its related two guideplate compartments (182, 186) follows. The next three compartments in the lower structure module (152), namely the forward guideplate compartment (182), the cylinder compartment (184) and the aft guideplate compartment (186), all work cooperatively with regard to the pneumatic unipoint suspension (114) system and the wheel unit (84) which is captively located within the bottom portion of the cylinder compartment (184). Both the preferred and alternate embodiments could not function as a useful vehicle employing its pneumatic unipoint suspension (114) without the unique combinations of these three compartments (182, 184, 186) in that the cylinder compartment (184) controls the movement of the wheel unit (84) along its wheel unit vertical axis (136) while the two guideplate compartments (182, 186) controls the movement of the wheel unit (84) along its wheel unit longitudinal axis roll axis (98) and the wheel unit lateral axis (100). FIG. 15 is a fragmented view of the cylinder compartment (184) and an open-ended view of the aft spar compartment (186) with its two aft guideplates (210, 212) and its aft shaft upper stop (448). Collectively, all three compartments (182, 184, 186) have fail-safe design features which directly relate to the wheel unit (84) and its continued operation during various failure modes.

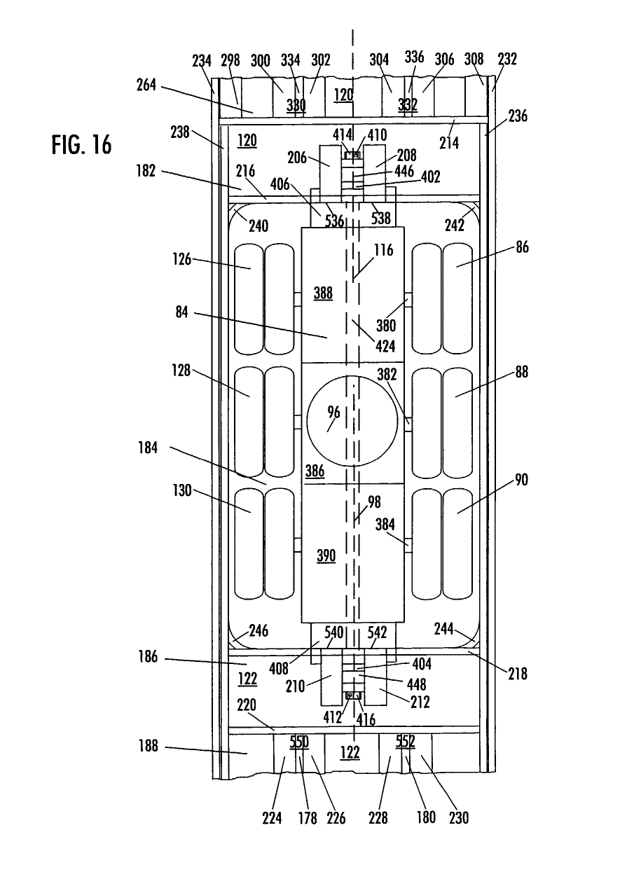

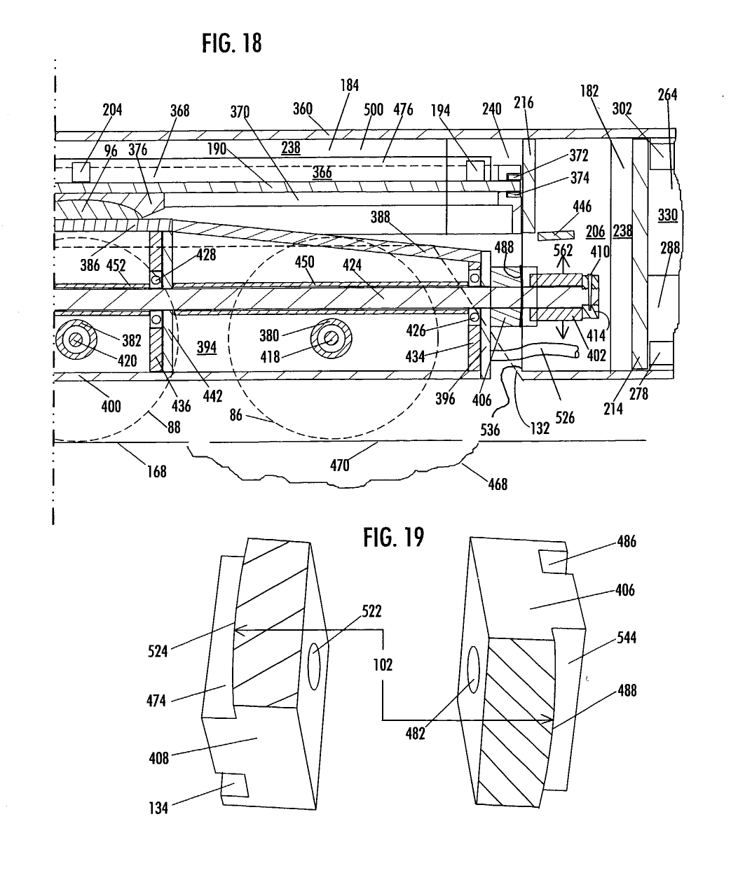

To obtain an overview of these functional relationships, FIG. 16 provides a unobstructed top, fragmented view of the cylinder compartment and its installed wheel unit (84) as it is captively located within the bottom portion of the cylinder compartment (184) in addition to top views of each guideplate compartment (182, 186) each having a set of centralized, vertically positioned parallel guideplates (206, 208, 210, 212) which mechanically centers the wheel unit longitudinal axis roll axis (98) in precise alignment with the modular passenger semi-trailer (62) centerline, herein defined as the pendulous longitudinal axis or datum line (116). Although captively located in the bottom portion of the cylinder compartment (184), the mechanical attributes of all three compartments (182, 184, 186) cooperatively allow the wheel unit (84) to operate freely along its wheel unit vertical axis (136), the wheel unit longitudinal axis roll axis (98) and the wheel unit lateral axis (100). FIG. 18 shows the novel operational feature of the fixed axle design of the wheel unit (84) as wheel group two (86) rolls over a pothole in road surface (468) as compared to the level surface of wheel group one (470) which supports that wheel group as well as the remaining four wheel groups.

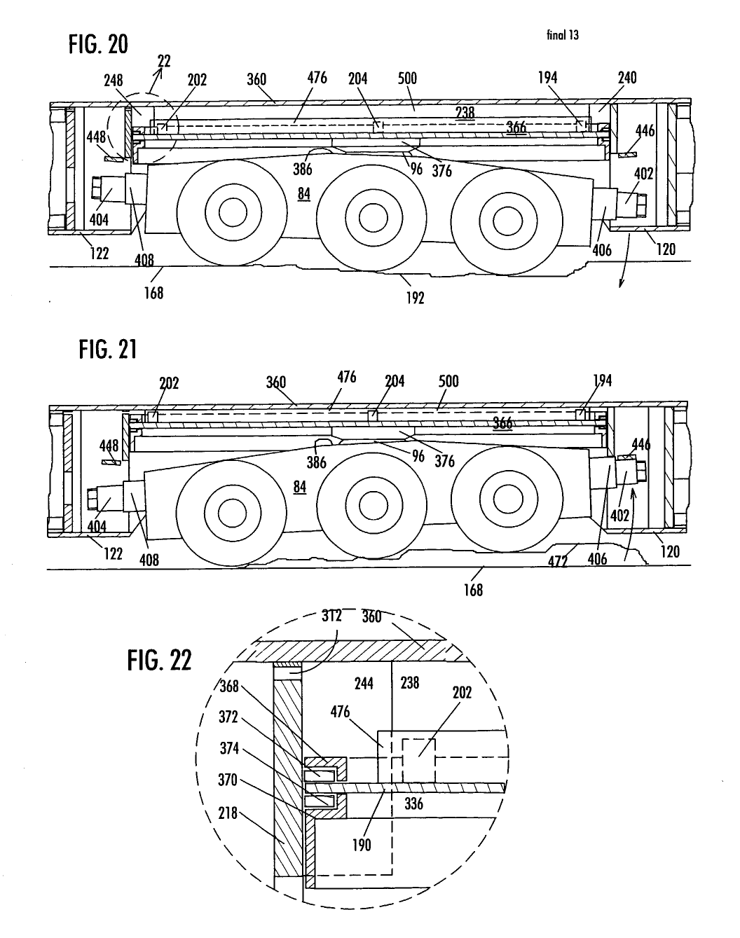

Because all of the six wheel groups are not independently suspended by conventional suspension apparatus, the entire wheel unit (84) will not collapse into individual potholes in the road which prevents damage to the wheel unit (84) the modular passenger semi-trailer (62) and to the road surface. FIG. 20 and FIG. 21 are cross-sectional views of the wheel unit (84) as it operates about its wheel unit lateral axis (100) as it encounters two typical road conditions, one being a vehicle-wide depression in road surface (192) and the other, a vehicle-wide snowpacked road surface (472). Both illustrations show how the forward baseplate (118) face in the forward guideplate compartment (182) and aft baseplate (122) face in the aft guideplate compartment (186) mechanically limits the downward movement of the wheel unit (84) while the forward shaft upper stop (446) in the forward guideplate compartment (182) and the aft shaft upper stop (448) in the aft guideplate compartment (186) mechanically limits the upward movement of the wheel unit (84). In both drawings, the right forward guideplate (208) and the right aft guideplate (212) are removed so as to better show the positional relationships of the wheel shaft forward and aft external members (402, 406, 408, 404).

FIG. 24 illustrates how the wheel unit (84) operates along its wheel unit longitudinal axis roll axis (98) as it rolls over a banked road face (172). Although the illustrated embodiment does not depict any mechanical stops which would limit either the clockwise or counterclockwise wheel unit longitudinal axis roll axis (98), the invention should not be limited or restricted since various arrangements for the inclusion of mechanical stops for the longitudinal axis roll axis are possible. Another fail-safe design feature connected with both guideplate compartments (182, 186) is the elimination of wheel unit (84) recoil during both vehicle braking and vehicle acceleration events, a feature that is created by the close mechanical fit between the forward and aft cam block cam faces and the vertical contact faces of all four guideplates.

FIG. 11 portrays the forward guideplate contact face to aft guideplate contact face distance (104) which is slightly larger than the forward cam apex to aft cam apex distance (102) as shown in FIG. 19. In practice, there will be about a sufficient operating clearance between these two distances (104, 102) regardless of the laterally rotational position or the vertically level position of the wheel unit (84) within the cylinder compartment (184). FIG. 19 also shows the sectioned cutaway portion of the forward cam block (406) and the sectioned cutaway portion of the aft cam block (408), each sectioned area respectively unveiling the typical forward cam block cam face (488) and the typical aft cam block cam face (524). Each cam block cam face (488, 524) has an appropriately formed curvature so as to always maintain the previously mentioned close tolerance distances (104, 102) during the various movements of the wheel unit (84) that occur along its wheel unit vertical axis (136), again respectively illustrated by FIG. 20 and FIG. 21.

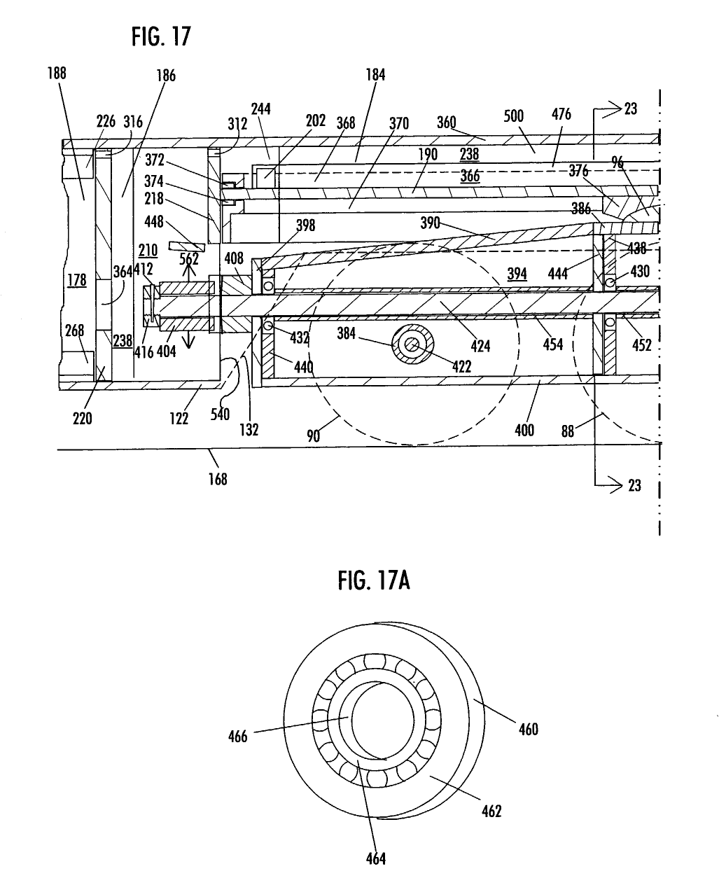

The wheel unit (84) can also travel vertically in a manner where it is always parallel to the level road surface (168) as illustrated in both FIG. 17 and FIG. 18. These two drawings show how this typical level movement along the wheel unit vertical axis (562) can occur. During these level vertical movements of the wheel unit (84) within the cylinder compartment (184), the previously mentioned close tolerance distances (488, 102) will always be maintained as they are during wheel unit movements about its wheel unit lateral axis (100). Another fail-safe design feature connected with both guideplate compartments (182, 186) is the positive directional control of the wheel unit (84) during tire failures.

As illustrated in FIG. 16, because the wheel unit (84), (a) uses a three fixed through-axle design which always keeps the wheel unit (84) level during a tire failure event, and (b) the wheel unit (84) is always directionally and positively held in precise longitudinal alignment with the modular passenger semi-trailer (62) centerline by the mechanical interventions of the wheel shaft forward and aft external members (402, 406, 408, 404), all of these members working in concert with the forward and aft guideplates (206, 208, 210, 212), a tire failure will not create a loss of directional control of the wheel unit (84). The unobstructed top view given in FIG. 16 shows the interlocking relationships between the forward cam block (406) and its interconnecting left forward guideplate (206) and its interconnecting right forward guideplate (208). An identical interlocking relationship exists between the aft cam block (408) and its interconnecting left aft guideplate (210) and its interconnecting right aft guideplate (212). FIG. 19 gives a close-up view of the four cam block grooves, namely forward cam block groove one (486), forward cam block groove two (544), aft cam block groove one (134) and aft cam block groove two (474). FIG. 16 illustrates how the forward cam block grooves (486, 544) nest into the two forward guideplates (206, 208) making contact upon the left forward guideplate contact face (536) and upon the right forward guideplate contact face (538). An identical arrangement illustrates how the aft cam block grooves (134, 474) nest into the two aft guideplates (210, 212) making contact upon the left aft guideplate contact face (540) and upon the right aft guideplate contact face (542).

Wheel unit directional control is also maintained by the two swivel blocks which are centered between each pair of guideplates as is also shown in FIG. 16. In this illustration, the forward shaft swivel block (402) is mechanically centered between the left forward guideplate (206) and the right forward guideplate (208). An identical mechanical relationship is depicted by the aft shaft swivel block (404) as it is mechanically centered between the left aft guideplate (210) and the right aft guideplate (212). FIG. 20 and FIG. 21 both illustrate how the two cam blocks (406, 408) and the two swivel blocks (402, 404) slidably operate between the two sets of guideplates as the wheel unit operates along its wheel unit lateral axis (100). Although FIG. 17 has the right aft guideplate (212) removed for visual clarity and FIG. 18 has the right forward guideplate (208) removed for visual clarity, both drawings give a close-up view of the basic mechanical relationships of the two cam blocks (406, 408) and two swivel blocks (402, 404) as they slidably operate upon the inside faces of the front set of guideplates (206, 208) and the aft set of guideplates (210, 212). FIG. 20 illustrates an overview of the final assembly of the wheel unit shaft (424) as it is installed within the wheel unit (84).

It is to be understood that the following description is a simplified procedure and that in actual practice, as can be seen in more detail in both FIG. 17 and FIG. 18, all of the wheel shaft external units and all of the wheel unit internal units must be mechanically and properly supported in place while the wheel unit shaft (424) is slid forward into place from within the aft spar compartment (188) and thereafter through the generator air inlet (364) opening in the aft spar bulkhead (220) and thereafter through the interior of the wheel unit (84). The simplified assembly is as follows; the wheel unit shaft (424) is installed into the wheel unit (84), the aft cam block (408) and the aft shaft swivel block (404) are slid are slid onto the aft end of the shaft and the aft shaft nut (416) is tightened and safetied into place by the installation of the aft shaft nut tapered pin (412). At the forward end of the shaft, the forward cam block (406) and the forward shaft swivel block (402) are slid onto the forward end of the shaft and the forward shaft nut (414) is tightened and safetied into place by the installation of the forward shaft nut tapered pin (410). FIG. 19 depicts typical shaft external member assembly holes, namely the forward cam block shaft hole (482) and the aft cam block shaft hole (522). Both FIG. 17 and FIG. 18 provide a closer view of the assembled shaft.

During the shaft assembly process, the final nut tightening pulls all of the external and internal shaft members together so that the mating face of the aft swivel block (408) firmly contacts the mating face of the wheel unit end plate (398) and a similar tensioning procedure occurs with the mating face of forward cam block (406) which firmly contacts the mating face of the wheel unit forward plate (396). This tightening procedure takes all of the slack out of the assembled shaft and its various external and internal members while still allowing the cam blocks and swivel blocks to pivotally operate upon the shaft upon which they are mounted.

One of the fail-safe features of this wheel unit shaft (424) and its assembled members is that the shaft is never subjected to tension stress during the operation of the vehicle, therefore both shaft nuts and the threaded ends of the shaft are never loaded and subjected to shearing failure which would thereafter cause the wheel unit shaft and all of its external and internal members to disassemble. Further, the wheel unit shaft is of sufficient diameter so as to withstand any bending or shear forces that may be imposed upon it during turning events during normal vehicle operations. Due to the weight and balance requirements for the assembled modular passenger semi-trailer, the operational low center of gravity point will always be a sufficient weight occurring at the level of the centerline of the wheel unit shaft (424).

Viewing the aft end of the modular passenger semi-trailer (62) in FIG. 7B, the estimated center of gravity below the pendulous longitudinal axis or datum line (162) is indicated by the circled cross. One of the fail-safe design features of both the preferred and alternate embodiments is the mechanical intervention of the wheel unit shaft (424) and its external units with the two sets of guideplates (206, 208, 210, 212) in that the wheel unit shaft mechanically prevents any vehicle roll. As shown by FIG. 23, the presence of any right tangential shaft force (480) or the presence of any left tangential shaft force (484) is effectively resisted by the presence of the wheel unit shaft (424) in that the wheel shaft is centrally affixed within the interior of the wheel unit (84) which independently weighs approximately 2500 pounds while, at the same time, the wheel unit (84) is always loaded with a portion of the modular passenger semi-trailer (62) weight, this total weight substantially resisting any limited tangential forces which might divert the wheel unit (84) from its normally towed position upon the road. Therefore, the combination of the manufactured and operational low center of gravity points for the vehicle, combined with the shaft mechanical intervention with the lower module structure, will prevent both the preferred and alternate embodiments from rolling.

The wheel unit (84) has three primary functions; (a) to support the weight of the pneumatic unipoint (114) suspension members above it, and (b) to thereafter distribute that vehicle loading to each of the six wheel groups that roll along the road surface, and (c) to centrally affix the wheel unit shaft (424) within the interior of the wheel unit (84), a subject previously described. The method of transmitting these loads is first applied to the wheel unit platform plate (386) which then distributes that load throughout all of the wheel unit (84) external and internal structural members and thereafter to the three axle tubes and thereafter to the three axles and thereafter to the six wheel groups that roll along the road surface. FIG. 17 and FIG. 18 depicts axle tube one (380), axle tube two (382), axle tube three (384), wheel axle one (418), wheel axle two (420) and wheel axle three (422). FIG. 16 depicts wheel group one (126), wheel group two (86), wheel group three (128), wheel group four (88), wheel group five (130) and wheel group six (90). For the purposes of drawing simplicity, there are no wheel bearings depicted in FIG. 17, FIG. 18, FIG. 23 and FIG. 24 for all of the wheel axles.

The wheel unit (84) does not utilize any conventional suspension apparatus in that which mechanically supports, in any way, the novel pneumatic unipoint suspension (114), the wheel unit (84) does not utilize any individually suspended wheels or wheel groups and, the wheel unit (84) does not utilize any conventional suspension hardware which might connect it with any lower structure module (152) member.

As the modular passenger semi-trailer (62) is towed down the road by the tractor (60), the wheel unit (84), due to its aft loading position, is always being pushed along the road by its continual contact with both aft guideplates (210, 212) as can be viewed in FIG. 16. During braking events, the wheel unit (84), by virtue with its continual contact with both aft guideplates (210, 220), slows the vehicle down until the tractor operator releases the braking action. Although the wheel unit (84) is captively located in the bottom portion of the cylinder compartment (184), it still has a sufficient built-in operating clearance which keeps it from physically contacting the forward guideplates (206, 208).

During towing events where neither the tractor or the trailer brakes are being applied, there are particular operational conditions where the wheel unit (84) can be free to overrun or roll forward within its aft loaded captive location in the cylinder compartment (184) for operational clearance and therefore make either momentary or continual contact with the forward guideplates (206, 208), particularly so when the vehicle is travelling down an inclined road.

One aspect of this invention is a novel capability for the installation of a future anti-jacknife detection apparatus which is applicable to both the preferred and alternate embodiments. In the situation of a semi-trailer overrunning event, the characteristic capability of the wheel unit (84) to quickly shift from its normal aft loaded position within the cylinder compartment (184) and contact the front guideplates (206, 208) provides the opportunity for the design of a future novel anti-jacknife warning apparatus which could both warn the driver and also automatically apply appropriate braking pressure so as to quickly return the king pin back to its normal aft face tensional loading condition.

FIG. 15 provides a fragmented perspective view of some of the wheel unit (84) external and internal structural members; the wheel unit platform plate (386), wheel unit right sideplate (392), wheel unit end plate (398), wheel unit aft angled plate (390), axle tube one (380), axle tube two (382), axle tube three (384) and a breakaway view of internal structural members internal support plate two (444) and shaft tubular spacer three (454). FIG. 17 and FIG. 18 give further details on the external and internal structural members; wheel unit left sideplate (394), wheel unit forward plate (396), wheel unit forward angled plate (388) and the wheel unit bottom plate (400). The internal structural members which centrally affix the wheel unit shaft (424) are; bearing plate one (434), bearing plate two (436), bearing plate three (438), bearing plate four (440), internal support plate one (442), shaft bearing one (426), shaft bearing two (428), shaft bearing three (430), shaft bearing four (432), shaft tubular spacer one (450), shaft tubular spacer two (452). In the instance of all three shaft tubular spacers (450, 452, 454), the spacers prevent all four shaft bearings (426, 428, 430, 432) from moving out of their respective bearing plate (434, 436, 438, 440) holes. FIG. 17A depicts a typical antifriction roller bearing (460), its roller bearing outer race (462), roller bearing inner race (464) and the typical antifriction roller bearing shaft hole (466). Additional wheel unit shaft (424) constructional details are also shown, the forward shaft threaded end (456), forward shaft nut (414), forward shaft tapered hole (518), forward shaft tapered pin (410), aft shaft threaded end (458), aft shaft nut (416), aft shaft tapered hole (520) and the aft shaft tapered pin.

Also illustrated is the brake system air supply line (526). Although the illustrated embodiment does not show any internal wheel unit (84) details concerning the required six pneumatic air brakes and all of their associated plumbing and valves and other brake installation details, the invention should not be limited or restricted in that various air brake supply and distribution lines and all of the required air brake components, along with their specific installation details are possible with this invention.

FIG. 12 and FIG. 13 both illustrate the piston assembly (366) with its various component members. Since the lower structure module (152) is expected to be approximately as wide as the lower structure module, the piston assembly (366) is expected to be approximately as long as the wheel unit producing an estimated piston area of about 14,000 square inches. Because of this substantial piston area, the operating air pressure in the sealed air chamber (500) area above the piston assembly (366) will be very low while the air volume will be very high. One fail-safe feature of this low operating air pressure is that there is an extremely low air pressure differential across the two piston seals (372, 374) which would result in a slow leakdown of air pressure in the event of any seal failures. The upper piston seal (372) acts as the primary air seal while the lower piston seal (374) acts as the redundant piston seal. Each piston seal has its own individual seal carrier, the upper seal carrier (368) being affixed to the flat horizontal top face of the piston plate (190) while the lower seal carrier piston skirt (370) is affixed to the flat horizontal bottom face of the piston plate (190).

As illustrated by both FIG. 15 and FIG. 22, the piston skirt portion of the lower seal carrier operates slidably upon the vertical portions of the cylinder compartment (184) walls insuring that the piston assembly (366) operates parallel to the cylinder walls in smooth reciprocal movements without any mechanical binding. Since the lower seal carrier piston skirt inner contours are physically available from the ground as shown by FIG. 14, the opportunity to have a number of mechanical adjustment means manufactured within the piston skirt portion of the lower seal carrier whereby the lower piston seal (374) could be manually adjusted from the ground in the event of a lower seal leak is within the capability of the invention and should not be limited by the illustrated embodiment of the lower seal carrier piston skirt arrangement. Each piston seal (372, 374) shown in the illustrated embodiment should not be limited or restricted in that any sealing material or any sealing device that is found to be appropriate for the specific needs of the invention are possible.

The illustrated embodiment of the piston assembly (366) should not be limited or restricted to a particular size or to a particular top cross-sectional profile or to a particular side cross-sectional shape in that various piston assembly designs are possible with this invention.

Another fail-safe feature of the piston assembly (366) is that there is a piston seal redundancy, the upper piston seal (372) and the lower piston seal (374). A further fail-safe feature of the piston assembly (366) is the piston resilient material pad (476) which sits atop the flat horizontal top face of the piston plate (190). This pad (476) is mounted within the enclosed air chamber (500) and is removed from any deteriorating influences from the outside weather. In the event of a persistent loss of air pressure in the sealed air chamber (500), the piston assembly (366) will rise to the top of the cylinder compartment (184) and come to a cushioned stop when it contacts the lower face of the cabin floorplate (360). From that point on, the piston resilient material pad (476) will absorb road shocks until the problem can be repaired. In the event that the piston resilient material pad (476) compresses beyond its designed limit of compressibility, the piston assembly (366) has six stop blocks affixed on the flat horizontal top face of the piston plate (190), namely stop block one (194), stop block two (196), stop block three (198), stop block four (200), stop block five (202) and stop block six (204).

The cylinder compartment (184) and its adjoining guideplate compartments (182, 186) are illustrated by an unobstructed, fragmented top view of the lower structure module where the cabin Doorplate (360) and the piston assembly (366) are removed for illustrative clarity. In this view, it can be seen that the cylinder compartment, forward guideplate compartment and aft guideplate compartments (182, 184, 186) have a reinforced structure with the presence of the right internal doubler plate (236) which is affixed to the left lower sideplate (234) and the left internal doubler plate (238) which is affixed to the right lower sideplate (232). The two internal doubler plates are redundant, fail-safe structures which reinforce the sides of the vehicle due to the removed material areas of the right side wheel cutout (92) and the left side wheel cutout (132). Both wheel side cutouts (92, 132) are design features which facilitate ground access for expected wheel, tire and other maintenance tasks that will take place within the confines of the cylinder, forward and aft guideplate compartments (182, 184, 186).

The cylinder compartment structure is completed by the forward cylinder wall (216) and aft cylinder wall (218). The four curved cylinder wall comers have a twofold function, (a) the cylinder comers provide a smooth directional transition which allows the two piston seals (372, 374) to have a matching curvature which avoids square seal comers thereby avoiding early seal failures, and (b) the cylinder comers, once weldably installed, provides a stiffening of the cylinder compartment (184). A top view of the installed cylinder assembly (366) is shown in FIG. 7 in addition to the cylinder comers which are cylinder corner one (240), cylinder comer two (242), cylinder comer three (244) and cylinder comer four (246). The fragmented perspective view of the cylinder compartment (184) constructional details and the aft guideplate compartment (186) constructional details are also shown in FIG. 15.

Of further interest is the intersecting constructional detail depicting the typical guideplate cylinder wall cutout (378) where both cylinder walls (216, 218) are dimensionally nested flush into these typical cutouts in each guideplate and then welded into place. Although each guideplate compartment is a closed box beam structure, the open ends of each guideplate compartment (182, 186) are structurally stiffened both vertically and laterally by this intersectioned construction of cylinder wall to guideplate which is another fail-safe design feature of both the preferred and alternate embodiments of the invention.

The pneumatic unipoint suspension (114) consists of the piston assembly (366), the piston socket (376) and the truncated hemisphere (96). As illustrated by FIG. 15A and FIG. 14, the piston socket (376) is centrally affixed upon the lower horizontal face of the piston plate (190) which precisely centralizes the vertical loading imposed upon the piston assembly (366) as it operates reciprocally within the cylinder compartment (184). The upper curved face of the truncated hemisphere (96) fits within the concaved portion of the piston socket (376), is compressively sandwiched into that piston socket (376) location and operates in a rotable manner within the piston socket location while its bottom, flat faced portion either sits flat upon the wheel unit platform plate (386) or operates in a slidable fashion upon the wheel unit platform plate (386) as shown in FIG. 15, FIG. 15A, FIG. 17, FIG. 18, FIG. 20, FIG. 21, FIG. 23 and FIG. 24.

Also, FIG. 20, FIG. 21 and FIG. 24 all illustrate how the truncated hemisphere (96) rotates within the piston socket (376) location while its flat lower portion slidably moves upon the wheel unit platform plate (386) face as the wheel unit (84) moves along its wheel unit longitudinal axis roll axis (98) and along the wheel unit lateral axis (100) or any combination thereof. The flat, lower face area of the truncated hemisphere (96) which supports the rear-end weight of the modular passenger semi-trailer (62) is equal or greater than that of the flat face area of the tractor fifth wheel plate (94) which supports the front-end weight of the modular passenger semi-trailer (62).

Once the semi-trailer cabin structure module (150) is weldably assembled upon the lower structure module (152), the cabin Doorplate (360) seals the upper portion of the cylinder compartment (184). With the installation of the piston assembly (366) into the cylinder compartment (184), the space above the piston assembly (366) now becomes a closed and sealed air chamber (500) which then can be filled with compressed air which is supplied by the cylinder compartment compressor equipment (516). Once pressurized, the rear-end portion of the modular passenger semi-trailer (62) rises to its normal operating height and is now ready for over-the-road activity.

Details of the location and various operational functions of the cylinder compartment compressor equipment (516) are shown in FIG. 7 and FIG. 7A. The compressor equipment (516) is shown to be located between the right aft spar (176) and the left aft spar (174). Placed in this location, the gasoline powered electrical generator unit (248), a commercially available piece of equipment, receives its combustion and cooling air from the generator air inlet (364) which can be seen in various views found in FIG. 11, FIG. 17 and FIG. 27. As the vehicle is towed down the road, inlet air is scooped by the open forward end of the aft spar compartment (186) and is then forced through the generator air inlet (346) opening and thereafter flowing into the center cavity of the aft spar compartment (188) and thereafter flowing out the generator exhaust slots (158) which are manufactured into the aft spar compartment access door (156), the slots and door (158, 156) both variously illustrated in FIG. 8A and FIG. 7B.

It is to be understood that the cylinder compartment compressor equipment (516) has been designed as an automatic, self-regulating system that needs no operator intervention solely for the convenience of the crew that operates the modular passenger semi-trailer (62), however the illustrated embodiment of the equipment (516) should not limit or restrict either the preferred or alternate embodiments of the invention in that the means to pressurize the cylinder compartment (184) can be achieved in various ways. Because the pneumatic unipoint suspension system is designed to be simple and rugged, complemented with various fail-safe features, some alternate methods can include situations where the compartment (184) can be pressurized by an on-board air cylinder or by an external air pressure source. In those simplified configurations, the air pressure lines (260, 82) that normally connect up to the compressor equipment (516) can be alternately connected up to either an on-board air bottle or to an external air pressure supply source, either alternate method having the capability to raise the vehicle up to its operating height. The various air pressure sense lines (124, 258) could be optionally connected up to an air pressure gauge which could be located in either the passenger cabin area or somewhere in a ground accessible location within the lower structure module (152).

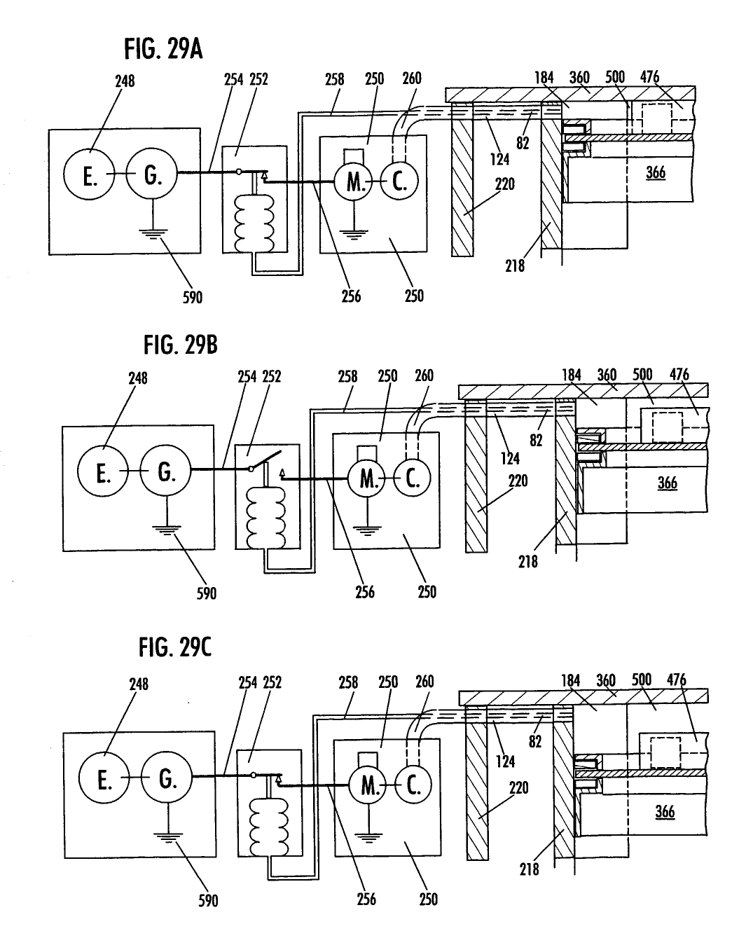

The physical locations of the preferred system and its components is generally shown in FIG. 7 and expanded to reveal more detail of the system in FIG. 7A. These two illustrations, along with FIG. 29A, FIG. 29B and FIG. 29C, can be collectively viewed to understand the three operational conditions within the cylinder compartment (184) that the cylinder compartment compressor equipment (516) is designed to address. All three operational conditions schematically illustrated by FIG. 29A, FIG. 29B and 29C, shows the commercially available gasoline powered electrical generator unit (248) is depicted where the engine component of the unit is symbolized by (E) while the engine-driven electrical generator component of the unit is symbolized by (G) and the mechanical drive-line being symbolized by the straight line which connects the two (E, G). The commercially available electrical powered air compressor (250) is depicted where the electrical motor component of the unit is symbolized by (M) while the motor-driven air compressor component of the unit which is symbolized by (C) and the mechanical drive-line being symbolized by the straight line which connects the two (M, C). The next system component that is commercially available is the low air pressure switch (252) which is symbolized by an air bellows which either opens or closes a single electrical switch which is wired up as a series circuit. Once the electrical generator power cable (254) provides power to the power terminal side of the low air pressure switch (252), the system is armed and ready to operate. Both the electrical generator (G) and the electrical drive motor (M) have a common electrical ground (504) which is connected to the lower module structure (152). In the instance where the low air pressure switch (252) closes, the simplified schematic in FIG. 29A depicts power being directed to the air compressor unit (C) which, now operating, has its pressure output directed through the schematic supply air pressure line (260) that communicates through the provided holes in both the aft spar bulkhead (220) and the aft cylinder wall (218). For illustrative simplicity, the air supply line check valve (318) is omitted in all schematics. Once the air chamber (500) is pressurized, the vehicle is progressively raised until the low air pressure switch (252) achieves its high air pressure setting thereby opening the series electrical switch and terminating the electrically powered operation of the air compressor unit (C). The low air pressure switch (252) continually receives a cylinder compartment (184) pressure feedback through the schematic sense air pressure line (258) which communicates back through holes in the aft cylinder wall (218) and the aft spar bulkhead (220), a process much like the air pressure lines that originally provided the air pressure to the cylinder compartment (184).

As a matter of routine, when the modular passenger semi-trailer (62) is operational, the gasoline powered electrical generator (248) is always running and producing power for all of the modular passenger semi-trailer (62) electrical circuits, all of which are not illustrated in FIG. 7, FIG. 7A, FIG. 29A, FIG. 29B and FIG. 29C for illustrative simplicity, only the air pressure control circuit which is being discussed here, while the air supply line check valve (318) has been omitted for illustrative simplicity. In a more detailed circuit diagram which would entail all the necessary circuitry for the vehicle, there would be an electrical switch or other appropriate control that would either start or stop the gasoline powered electrical generator (248), the control being activated by either the cabin crew or the ground crew as required.

Assuming that electrical power is available, FIG. 29A illustrates an underpressure situation in the cylinder compartment (184). This schematic would symbolize a situation where either the air chamber (500) has not yet been pressurized or the air chamber (500) has suffered a substantial leakage which causes the piston assembly (366) to ‘top out’ within the cylinder compartment (184). The schematic symbolizes a situation where the air chamber (500) has not achieved the predetermined pressure setting for the low air pressure switch (252) which thereby closes the series electrical switch and activates the electrically powered operation of the air compressor unit (C).

Assuming that electrical power is available, FIG. 29B illustrates an overpressure situation in the cylinder compartment (184). This schematic symbolizes the point where the pressure in the air chamber (500) has achieved the predetermined air pressure setting for the low air pressure switch (252) which thereby opens the series electrical switch and terminates the electrically powered operation of the air compressor unit (C).

Assuming that electrical power is available, FIG. 29C illustrates a momentary underpressure situation in the cylinder compartment (184). This schematic symbolizes a situation where the piston assembly (366) rapidly drops and causes an instantaneous low pressure condition in the air chamber (500) which momentarily closes the series electrical switch and activates the electrically powered operation of the air compressor (C). The momentary underpressure situation is demonstrated by FIG. 20 where the wheel unit (84) suddenly encounters a vehicle-wide depression in road surface (192) causing the piston assembly (366) to momentarily drop causing the short-term low air pressure in the air chamber (500).

FIG. 7A provides an overview of the positional relationships of the various components of the cylinder compartment compressor equipment (516). The gasoline powered electrical generator unit (248) provides power to the electrical generator power cable (254) which connects to the low air pressure switch (252) which has an additional low air pressure switch power cable which connects up with the electrical powered air compressor (250). The pressurized air then flows from the compressor (250) into the supply air pressure line (260) which passes through the aft spar bulkhead air pressure supply hole (316) and into the air supply line check valve (318) and thereafter into the air supply line hose (82) and finally passes through the aft cylinder wall air pressure supply hole (312) and finally into the cylinder compartment (184).

Because the pneumatic unipoint (114) suspension system operates at such a low air pressure, the only location where a reverse high-flow pressure leak might occur would be in the air compressor unit (250) which could be caused by an internal mechanical failure, therefore the air supply line check valve (318) is placed in the main air output line showing the direction of free flow for the check valve (318). Whatever air pressure that may exist in the cylinder compartment (184), the pressure signal is routed back to the low air pressure switch (252) by a feed-back system which originates at the aft cylinder wall air pressure sense hole (310) and into the air sense line hose (124) thereafter through the aft spar bulkhead air pressure sense hole (314) and thereafter into the sense air pressure line (258) which finally connects with the low air pressure switch (252). FIG. 8B and FIG. 22 both depict the aft cylinder wall air pressure supply hole (312) while FIG. 15 shows both aft cylinder wall air holes (310, 312) while FIG. 27 shows both aft spar bulkhead air holes (314, 316).

A discussion of the aft spar compartment (188) follows. The aft spar compartment (188), the aft end closed box beam structure in the lower structure module (152), is illustrated by a top view in FIG. 7 and an end, cross-sectioned view in FIG. 27. In that particular drawing, the constructional details have similarities to that of the front spar compartment members which includes the left aft spar (174) and the right aft spar (176). Both spars (174, 176) have compartment-length angle members, specifically aft upper angle one (224), aft upper angle two (226), aft upper angle three (228), aft upper angle four (230), aft lower angle one (266), aft lower angle two (268), aft lower angle three (270) and lower aft angle four (272). The cabin floorplate (360) has breakaway sections to indicate a typical left aft spar cap (550), its counterpart, the lower spar cap, having an identical construction, while the typical right aft spar cap (552) and its counterpart, the lower spar cap, having an identical construction. The final aft spar structural members are the left aft spar web (178) and the right aft spar web (180), spaced between both aft spar members is the central cavity area of the aft spar compartment where the cylinder compartment equipment (516) is located. The final constructional details of the aft spar compartment (188) would be the two air supply holes (314, 316), the aft baseplate (122) and the generator air inlet (364) opening.

What I claim as my invention is:

1. A fail safe, crashworthy a modular passenger semi trailer with a semi trailer cabin structure module, a pneumatic unipoint suspension and a wheel unit disposed within a lower structure module, the improvement comprising:
said modular passenger semi trailer being pulled along a road by a tractor, said modular passenger semi trailer and said tractor being interconnected by a downwardly projecting oversized diameter king pin installed in a towplate compartment, the oversized diameter king pin member being pivotally connected to a tractor fifth wheel plate being generally rearwardly positioned on said tractor, the vehicle load being urged downwardly upon a tractor drive wheels, a vehicle length said semi trailer cabin structure module being framed by a cabin rollcage structure,being comprised of:
(a) a right cabin rollover tube, a left cabin rollover tube, the rollover tube members being vehicle length;
(b) a plurality of cabin bulkheads slidably assembled at spaced intervals and securely attached along said cabin rollover tubes;
(c) a plurality of cabin former assemblies slidably assembled at spaced intervals and securely attached along said cabin rollover tubes, interconnecting, said cabin bulkheads, said cabin former assemblies together forming the first assembled segment of said cabin rollcage structure;
(d) a right side segmented cabin sideplate, a left side cabin sideplate, the cabin sideplate members being vehicle length;
(e) a cabin floorplate being vehicle length, interconnecting, securely affixed to lowermost disposed portions of said right side segmented cabin sideplate, said left side cabin sideplate, forming a vehicle length channel structure together forming the second assembled segment of said cabin rollcage structure, interconnecting, securely attaching the first and second rollcage structure assemblies;
(f) a cabin covering material, being lightweight, rigid, having a plurality of right and left side windows disposed therein and said cabin covering material cooperating with said right side segmented plate having at east two right side cabin doors disposed therein;
(g) a plurality of a typical passenger cabin seats disposed within said enclosed semi trailer cabin structure module.

2. A fail safe, crashworthy said modular passenger semi trailer according to claim 1, said semi trailer cabin structure module is securely affixed and disposed upon a single, top, flat production joint face of said lower structure module.
wherein
said single, top, flat production joint face is comprised of a of plurality of upper faces of the generally vertically disposed longitudinal, transverse and diagonal members of said lower structure module.
said fully assembled and fully occupied modular passenger semi trailer has a manufactured and operational vertical center of gravity below a pendulous longitudinal axis datum line of said modular passenger semi trailer,
wherein the datum line is generally horizontally disposed reference line that is generally parallel to the level surface of the road, the vertical height of the datum line being established at the point of contact of said tractor fifth wheel plate with the lowermost face of generally horizontally disposed portion of the forward baseplate member of a towplate compartment, the datum reference continuing rearwardly and terminating at the apex of the convexed face of the a truncated hemisphere.

4. A fail safe, crashworthy said modular passenger semi trailer according to claim 1, said cabin bulkheads are slidably assembled at spaced intervals, securably fixed along said cabin rollover tubes,
(a) a forward closed cabin bulkhead one cooperating with a forward closed bulkhead two forming said closed forward compartment, serving as the most forward cabin bulkhead,
(b) said closed cabin bulkhead two cooperating with a forward cabin door bulkhead forming a forward cabin compartment,
(c) said forward door cabin bulkhead cooperating with an aft cabin door bulkhead forming a main cabin compartment,
(d) said aft cabin door bulkhead cooperating with an end cabin door bulkhead forming an aft cabin compartment,
wherein the cabin door bulkhead members having a cabin interior door cutout providing passenger interior access to various said cabin compartments, said end cabin door bulkhead having a aft cabin door allowing exterior access to said cabin compartments,
wherein said main cabin compartment is formed by a plurality of said cabin former assembly members, slidably assembled at spaced intervals, securably fixed to the cabin rollover tube members, the cabin former assembly members constituting congruently profiled structural supports, first composing the enclosed interior main cabin compartment and secondly supporting the cabin covering material member,
wherein the cabin sideplate members, being securely attached to the generally vertically disposed, abutting, recessed portions of the cabin former assembly members constitute an elevated rollover bend point for said cabin former assemblies, point being orientated at the juncture of uppermost, horizontally disposed plane of the cabin sideplate members, the cabin bulkhead members acting as fail safe, redundant structures for the cabin former assembly members, the cabin sideplate members further being securely attached to the generally vertically disposed, abutting, recessed portions of the cabin bulkhead members.

5. A fail safe, crashworthy said modular passenger semi trailer according to claim 4, the cabin bulkhead members and the cabin former assembly members cooperate, each using a hole for right cabin rollover tube, a hole for left rollover tube, each said rollover tube hole being commonly disposed within the uppermost portions of each of the cabin bulkhead, cabin former assembly members faces,
wherein
(a) each cabin former assembly member is formed by having a cabin exterior profile bar, a cabin interior profile bar sandwiched and securely affixed to a typical cabin former plate on either side of the cabin exterior, interior profile bar members,
wherein,
(b) cabin bulkhead members and cabin former assembly members have congruent exterior profiles while cabin former assembly members have sufficient congruent cabin interior profiles and overhead clearances allowing for passenger occupancy,
wherein
the cabin bulkhead, cabin former assembly members have the capacity for noncongruent exterior and interior profiles and dimensions, each of the cabin bulkhead, cabin former members having the capacity to cooperatively form said semi trailer cabin structure module with exterior and interior shapes comprised of compound angles, compound curved profiles.

6. A fail safe, crashworthy a modular passenger semi trailer with a semi trailer cabin structure module, a pneumatic unipoint suspension and a wheel unit disposed within a lower structure module, the improvement comprising:
said lower structure module becomes a vehicle length, closed box beam construct once said semi trailer cabin module is juxtaposed, securely attached to said single, top, flat production joint face of said lower structure module, the vehicle length said lower structure module comprising a plurality of abutting, front to rear, closed box beam compartments including said towplate compartment, a forward spar compartment, a forward guideplate compartment, a cylinder compartment, a aft guideplate compartment, a aft spar compartment,
wherein said lower structure module having a manufactured gross weight greater than the gross weight of equipped and fully occupied said passenger semi trailer cabin module facilitating a low vertical vehicle center of gravity, provides a limited freedom of vehicle rotation in response thereto along the reference of said pendulous longitudinal axis datum line, facilitating a self leveling urging of said modular passenger semi trailer as it operates over variable road surface conditions,
wherein the maximum width of said lower structure module being determined and limited by the maximum vehicle width established by federal Department of Transportation standards for passenger carrying and industrial use semi trailer vehicles, the height of said lower structure module being determined by the approximate operational height of topmost disposed portion of said cylinder compartment being added to the approximate height of a wheel unit down to point of the centerline of an axle, said wheel unit occupying lowermost disposed portion of said cylinder compartment, the width and height dimensions resulting for said lower structure module forming an approximately defined rectangular side cross sectional structure,
wherein a plurality of a spar planks provide a finalized, manufactured center of gravity point for the fully assembled said modular passenger semi trailer by the provision of juxtaposing said spar planks upon the lowermost adjacent faces of a right forward spar and a left forward spar, all four said spar planks collectively urging a shifting of the collective generally vertically disposed vertical center of gravity point, the generally horizontally disposed longitudinal and laterally center of gravity points according to,
(a) the weight of each of four said spar planks according to the length and material thickness of each said spar plank;
(b) the weight of each of four said spar planks according to the placement of any individual said spar plank at any of four possible said forward spar placement locations;
(c) the longitudinal, front to rear, placement of each of four said spar planks within said forward spar compartment.

7. A fail safe, crashworthy said lower structure module according to claim 6, the vehicle length, closed box beam structure being formed by a plurality of generally vertical longitudinal and transverse members and generally horizontal members, all members being securely attached to each other at abutting joints, wherein the lower structure module is comprised of:
(a) longitudinal members being a right sideplate, a right internal doubler plate, a left sideplate, a left internal doubler plate, a right forward spar, a left forward spar, a right aft spar, a left aft spar,
(b) laterally transverse members being a forward plank of said towplate compartment; also including a forward diagonal plank one, a forward diagonal plank two, a forward diagonal plank three, a forward diagonal plank four and a closing plank of said towplate compartment; a generally vertically disposed portion of the forward baseplate member, a forward spar compartment bulkhead, said forward cylinder wall, said aft cylinder wall, an aft spar bulkhead, an aft spar compartment end bulkhead,
(c) generally horizontal members being the forward baseplate member forming the lowermost disposed floor face of said towplate compartment, the mid baseplate member forming the lowermost disposed floor face of said forward spar compartment, said forward guideplate compartment, the aft baseplate member forming the lowermost disposed floor face of said aft guideplate compartment, said aft spar compartment, said cabin floorplate,
wherein a right lower sideplate, a left lower sideplate, the sideplate members being vehicle length, generally vertically disposed, the most forwardly disposed portions of each of the lower sideplate member having a formed side profile determined by the horizontal, radiused and vertically disposed side profile of the forward baseplate member and having a generally rearwardly disposed, a right side wheel cutout, a left side wheel cutout, said wheel cutouts being congruently shaped and located in the lower sideplate, internal doubler plate members thereby allowing side access to said wheel unit being captively located in bottom portion of said cylinder compartment,
wherein
(a) said right internal doubler plate being generally vertically disposed, juxtaposed, securely affixed to interior face of said right lower sideplate and said left internal doubler plate being generally vertically disposed, juxtaposed, securely affixed to interior face of said left lower sideplate the internal doubler plate members being of sufficient length to provide a fail safe longitudinal stiffening of a selected portion of said lower structure module, the height of the internal doubler plate members being approximately the height of the lower sideplate members.

8. A fail safe, crashworthy said lower structure module according to claim 6, having disposed within, said towplate compartment being the most forward, generally horizontally disposed compartment overhanging the aft end of said tractor, comprising:
the generally vertically disposed compartment members have congruent heights equal to the top faces of said right lower sideplate, said left lower sideplate, all compartment member top faces constituting said towplate compartment portion of said single, top, flat production joint face of said lower structure module, the compartment becoming a closed box beam construct with the assemblage of the cabin Doorplate member,
(a) said forward baseplate, having a generally horizontally disposed portion forming a lowermost compartment floor face, a forward baseplate radius portion facilitating a transition to the generally vertically disposed member portion comprising the forward transverse member of said forward spar compartment, abutting, juxtaposed, securely affixed to forward edges of the lower sideplate, mid baseplate members of said forward spar compartment,
wherein
said towplate compartment is framed by the generally horizontally disposed members being said forward plank, at most forward transverse location, said closing plank at most rearward transverse location and the longitudinally disposed lower sideplate members forming the sides of the compartment,
wherein
(a) a king pin collar being of cylindrical form, generally horizontally and centrally disposed within towplate compartment, securely affixed upon the topmost face of the forward baseplate member, the collar member having a king pin tapered hole to facilitate the installation of a oversized diameter king pin, the collar member being centralized, secured in a fail safe manner upon the compartment floor face by four said forward diagonal planks, each of the plank members abutting, securely affixed to circumferential face of said king pin collar, each of the plank members radiating into, abutting, securely affixed to each interior corner of said towplate compartment,
(b) said oversized diameter king pin of fail safe design having a king pin tapered shaft section on its upper portion of the downwardly projecting said king pin providing a quick change installation of the king pin member into the king pin collar member, both members being placed concentrically over,
(c) a forward baseplate king pin hole, centrally disposed in the horizontal portion of the forward baseplate member.

9. A fail safe, crashworthy said lower structure module according to claim 6, having disposed within, a said forward spar compartment comprising:
the generally vertically disposed compartment members have congruent heights equal to the top faces of said right lower sideplate, said left lower sideplate, all compartment member top faces constituting said forward spar compartment portion of said single, top, flat production joint face of said lower structure module, the compartment becoming a closed box beam construct with the assemblage of the cabin floorplate member,
wherein the vertically disposed portions of said forward baseplate, said forward spar bulkhead being the primary transverse structural members of said forward spar compartment, the right lower sideplate, right forward spar, left forward spar, left lower sideplate members being the primary longitudinal structural members of said forward spar compartment, said mid baseplate forming the generally horizontally, lowermost disposed portion of compartment floor face, is juxtaposed and securely affixed to the abutting portions of the primary lateral and primary longitudinal structural members of said forward spar compartment,
wherein the four fail safe compartment length, longitudinally disposed primary longitudinal loadbearing members for said forward spar compartment are so formed that the structural failure of any two primary longitudinal loadbearing structures will not affect the operational roadworthiness of said modular passenger, said right forward spar, said left forward spar being spaced apart from each other in a parallel disposition within the forward spar compartment, each of the primary loadbearing members are comprised of a compartment length, generally horizontally disposed plates and a plurality of the right angle, compartment length members, all facilitating compartment fail safe structural stiffening and vehicle weight and balance criteria;
(a) the primary outboard loadbearing member of said forward spar compartment being said right lower sideplate having a forward upper angle six juxtaposed, securely affixed to its topmost inner face and a forward lower angle six juxtaposed, securely affixed to its lowermost inner face, the assemblage constituting the inward facing channel member,
(b) the primary inboard loadbearing member of said forward spar compartment being said right forward spar upper portion being comprised of a right forward spar web being generally vertically disposed having a forward upper angle five being juxtaposed, securely affixed upon right, top face of said right forward spar web, a forward upper angle four juxtaposed, securely affixed upon left, top face of said right forward spar web, the assemblage constituting a right forward top spar cap, said right forward spar lower portion being comprised of a right forward spar web being generally vertically disposed having a forward lower angle five, a spar plank four, being cooperatively juxtaposed, securely affixed upon right, lower face of said right forward spar web, said right forward spar lower portion being comprised of a right forward spar web being generally vertically disposed having a forward lower angle four, a spar plank three, being cooperatively juxtaposed, securely affixed upon left, lower face of said right forward spar web,
(c) the primary inboard loadbearing member of said forward spar compartment being said left forward spar upper portion being comprised of a left forward spar web being generally vertically disposed having a forward upper angle three being juxtaposed, securely affixed upon right, top face of said left forward spar web, a forward upper angle two juxtaposed, securely affixed upon left, top face of said left forward spar web, the assemblage comprising a left forward top spar cap, said left forward spar lower portion being comprised of a left forward spar web being generally vertically disposed having a forward lower angle three, a spar plank two, being cooperatively juxtaposed securely affixed upon right, lower face of said left forward spar web, said left forward spar lower portion being comprised of a left forward spar web being generally vertically disposed having a forward lower angle two, a spar plank one, being cooperatively juxtaposed, securely affixed upon right, lower face of said left forward spar web, the generally horizontally disposed lower portion of said right forward spar, said left forward spar are juxtaposed, securely affixed upon lowermost compartment floor face of said mid baseplate,
(d) the primary outboard loadbearing member of said forward spar compartment being said left lower sideplate having a forward upper angle one juxtaposed, securely affixed to its topmost inner face and a forward lower angle one juxtaposed, securely affixed to its lowermost inner face, the assemblage constituting an inward facing channel member,
(e) the forward right and left spar members, being spaced apart, provide a forward attachment point for a future antijacknife restraint apparatus, the apparatus projecting through a future opening in the vertical portion of the forward baseplate member,
wherein the plurality of the compartment plate and right angle members, and the spar plank members disposed within said forward spar compartment individually cooperate according to weight, balance and strength manufacturing criteria insuring a low vertical center of gravity point for said lower structure module.

10. A fail safe, crashworthy said lower structure module according to claim 6, having disposed within, said forward guideplate compartment and said aft guideplate compartment comprising:
the generally vertically disposed compartment members have congruent heights equal to the top faces of said right lower sideplate, said left lower sideplate, all compartment member top faces constituting said forward guideplate, aft guideplate compartment portions of said single, top, flat production joint face of said lower structure module, the compartments becoming a closed box beam construct with the assemblage of the cabin floorplate member,
wherein said forward guideplate compartment having an open face at its aft, vertically transverse orientated plane, the open face being adjacent to the forward plane of said cylinder compartment, said aft guideplate compartment having an open face at its forward, vertically transverse orientated plane, the open face being adjacent to the aft plane of said cylinder compartment,
wherein said forward guideplate compartment has,
(a) a right forward guideplate, a left forward guideplate, both forward guideplate members vertically and centrally disposed, set apart so as to sandwich
(b) a forward swivel block, a forward cam block, both block members being pivotably mounted on the forward external extension of a wheel unit shaft, both block members being slidably operative between both forward guideplate members,
(c) said aft guideplate compartment has a right aft guideplate, a left aft guideplate, both aft guideplate members vertically and centrally disposed, set apart so as to sandwich
(d) a aft swivel block, a aft cam block, both block members being pivotably mounted on the aft external extension of a wheel unit shaft, both block members being slidably operative between both forward guideplate members, the combined guideplate, cam block and swivel block members providing precise centerline alignment of the wheel unit member with said lower structure module datum line while further captively locating the wheel unit member within the lower portion of said cylinder compartment,
wherein
a right forward guideplate contact face, being generally vertically disposed, is aligned with the aft edge of said mid baseplate, a left forward guideplate contact face, being generally vertically disposed, is aligned with the aft edge of said mid baseplate, a right aft guideplate contact face, being generally vertically disposed, is aligned with the aft edge of said aft baseplate, a left aft guideplate contact face, being generally vertically disposed, is aligned with the aft edge of said aft baseplate,
wherein the open faces of the forward and aft guideplate compartments are reinforced, whereby,
(a) both the uppermost portions of the forward guideplate members abut and are securely attached to the generally horizontally disposed lower face of said cabin floorplate, while the lowermost portions of the forward guideplate members abut and are securely attached to the generally horizontally disposed upper face of said mid baseplate,
(b) both the uppermost portions of the aft guideplate members abut and are securely attached to the generally horizontally disposed lower face of said cabin floorplate, while the lowermost portions of the aft guideplate members abut and are securely attached to the generally horizontally disposed upper face of said aft baseplate, the vertical dispositions of the guideplate members facilitating a reinforcement of the open faced portions of each closed box beam guideplate compartment.

11. A fail safe, crashworthy said lower structure module according to claim 6, having disposed within, said cylinder compartment comprising:
the generally vertically disposed compartment members have congruent heights equal to the top faces of said right lower sideplate, said left lower sideplate, all compartment member top faces constituting said cylinder compartment portion of said single, top, flat production joint face of said lower structure module, the compartment becoming a closed box beam construct with the assemblage of the cabin floorplate member,
(a) said cylinder compartment upper portion forming an airtight enclosure, facilitating a air chamber generally horizontally disposed above a piston assembly, said piston assembly reciprocally movable in the uppermost portion of said cylinder compartment,
(b) the cylinder compartment wall members comprising the inwardly disposed faces of said left internal doubler plate, a cylinder comer one, said forward cylinder wall, a cylinder corner two, said right internal doubler plate, a cylinder comer three, said aft cylinder wall, a cylinder corner four, all cylinder wall members securely affixed to each other, the inwardly, generally vertically disposed cylinder wall faces forming a smooth, operational face, operational air pressure being supplied by
(c) a cylinder compartment compressor equipment, the air pressure entering said air chamber through a aft cylinder wall air pressure supply hole, the operational air pressure sensed by a aft cylinder wall air pressure hole,
wherein
(d) the uppermost disposed portion of said cylinder compartment, the approximate operational height of said forward cylinder wall, said aft cylinder wall is the accumulated distances of;
(e) the operational distance between the generally horizontally disposed lower face of said cabin floorplate, which forms the compartment cylinder head, and the generally horizontally disposed upper face of a piston resilient material pad when there is the predetermined amount of operational air pressure contained in said air chamber;
(f) the mechanical distance as measured from the upper face of said piston resilient material pad to the generally horizontally disposed lower face of the rim of a lower seal carrier piston skirt;
(g) the operational distance that is sufficient for the normally downwardly reciprocal movements of said piston assembly that occurs during all phases of over the road operations of the vehicle, wherein
(h) the uppermost disposed portion of said cylinder compartment is comprised of the primary transverse structural members, said forward cylinder wall, said aft cylinder wall, a typical guideplate cylinder wall cutout in upper portions of the four guideplates reinforcing the central portions of each cylinder wall preventing transverse twisting, bowing distortions of the cylinder walls while stiffening the upper portions of the right side primary longitudinal structural members, said right lower sideplate, said right inboard doubler plate and left side primary longitudinal structural members, said left lower sideplate, said left internal doubler plate
(i) the lowermost disposed portion of the cylinder compartment is open at its lowermost portion to allow the installation of a pneumatic unipoint suspension, said truncated hemisphere, said wheel unit, said lower structure module having its lowermost portions defined by said aft baseplate member forming the lowermost disposed floor face of said towplate compartment, a mid baseplate forming the lowermost disposed floor face of said forward spar compartment and said forward guideplate compartment, a aft baseplate forming the lowermost disposed floor face of said aft guideplate compartment and said aft spar compartment.

12. A fail safe, crashworthy said lower structure module according to claim 6, having disposed within, said aft spar compartment comprising:
the generally vertically disposed compartment members have congruent heights equal to the top faces of said right lower sideplate, said left lower sideplate, all compartment member top faces constituting said aft spar compartment portion of said single, top, flat production joint face of said lower structure module, the compartment becoming a closed box beam construct with the assemblage of the cabin floorplate member, disposed within said aft spar compartment there is,
(a) said aft spar bulkhead, said aft spar compartment end bulkhead being the primary transverse structural members of said aft spar compartment,
(b) said right lower sideplate and said right internal doubler plate, said right aft spar, said left aft spar, said left lower sideplate and said left internal doubler plate being the primary longitudinal structural members of said aft spar compartment, said aft baseplate, forming the generally horizontally, lowermost disposed portion of compartment floor face, is juxtaposed, securely affixed to the lowermost portions of the primary lateral and longitudinal structural members of said aft spar compartment,
wherein the four fail safe,
(c) longitudinally disposed primary longitudinal loadbearing members for said aft spar compartment are so formed that the structural failure of any the two primary longitudinal loadbearing members will not affect the operational roadworthiness of said modular passenger semi trailer, said right aft spar, said left aft spar being oriented apart from each other in a parallel disposition within the compartment,
wherein
(d) both of the outboard primary loadbearing members are comprised of a compartment length, generally horizontally disposed said right lower sideplate, said right inboard doubler plate being juxtaposed, securely attached to each other forming a dual plate redundant structure, generally horizontally disposed said left lower sideplate, said left inboard doubler plate being juxtaposed, securely attached to each other forming a dual plate redundant structure,
(e) both of the inboard primary loadbearing members are comprised of a compartment length generally horizontally disposed plates and a plurality of the right angle, compartment length members all facilitating compartment fail safe structural stiffening and vehicle weight and balance criteria,
(f) the primary inboard loadbearing member of said aft spar compartment being said right aft spar upper portion being comprised of a right aft spar web being generally vertically disposed having a aft upper angle four being juxtaposed, securely affixed upon right, top face of said right aft spar web, a aft upper angle three juxtaposed, securely affixed upon left, top face of said right aft spar web, the assemblage constituting a typical right aft spar cap, said right aft spar lower portion being comprised of a right aft spar web being generally vertically disposed having a aft lower angle four, being cooperatively juxtaposed, securely affixed upon right, lower face of said right aft spar web, a aft lower angle three, being cooperatively juxtaposed, securely affixed upon left, lower face of said right aft spar web,
(g) the primary inboard loadbearing member of said aft spar compartment being said left aft spar upper portion being comprised of a left aft spar web being generally vertically disposed having a aft upper angle two being juxtaposed, securely affixed upon right, top face of said left aft spar web, a aft upper angle one juxtaposed, securely affixed upon left, top face of said left aft spar web, the assemblage constituting a typical left aft top spar cap, said left aft spar lower portion being comprised of a left aft spar web being generally vertically disposed having a aft lower angle two, being cooperatively juxtaposed, securely affixed upon right, lower face of said left aft spar web, a aft lower angle one, being cooperatively juxtaposed, securely affixed upon left, lower face of said left aft spar web, herein the generally horizontally disposed lower portion of said right aft spar, said left aft spar are juxtaposed, securely affixed upon lowermost compartment floor face of said aft baseplate,
wherein the generally horizontally disposed members and a plurality of the topmost right angle members have congruent heights equal to the top faces of said right lower sideplate, said left lower sideplate, all top faces constituting a compartment portion of said single, top, flat production joint face of said lower structure module,
wherein the plurality of the right angle members and the spar web members disposed within said aft spar compartment individually cooperate according to weight, balance and strength manufacturing criteria insuring a low vertical center of gravity point for said lower structure module.

13. A fail safe, crashworthy said lower structure module according to claim 6, having disposed within, said aft spar compartment comprising:
(a) a central cavity portion disposed between said left aft spar and said right aft spar in which there are provided in said central cavity portion of said aft spar compartment:
(b) a gasoline powered electrical generator unit, said generator air inlet opening in a generally, centrally disposed position within said aft spar bulkhead facilitating the entrance of fresh onrushing air to said gasoline powered electrical generator unit into said central cavity to a generator exhaust slots disposed within said aft spar compartment access door,
(c) the output air pressure of a electrically powered air compressor communicated through pressure loop members in which there are provided within the upper portion of said central cavity of said aft spar compartment, pressure loop members comprising:
(d) a supply air pressure line, and, further including in which there are provided within the upper portion of said aft bulkhead compartment, a continuation of the pressure loop members comprising:
(e) a aft spar bulkhead air pressure supply hole;
(f) a air supply line check valve,
(g) a air supply line hose
(h) a aft cylinder wall air pressure supply hole pressurizing said air chamber in the upper portion of said cylinder compartment, said piston assembly is downwardly urged which raises aft end of said modular passenger semi trailer, producing the predetermined amount of operational air pressure within said air chamber, the air pressure being sensed and communicated by the interconnecting feed back loop members in which there are provided within the upper portion of said aft guideplate compartment, the sense loop members comprising:
(i) a aft cylinder wall air pressure sense hole:
(j) a air sense line hose;
(k) a aft spar bulkhead air pressure sense hole, and,
further including in which there are provided within the upper portion of said central cavity of said aft spar compartment, a continuation of the sense loop members comprising:
(l) a sense air pressure line, the output air pressure being automatically regulated by:
(m) a low air pressure switch;
(n) a low air pressure switch power cable;
(o) a electrical generator power cable;
(p) a electrical powered air compressor, and,
wherein the predetermined amount of operational air pressure being sensed will open at a predetermined setting the normally closed said air pressure switch, interrupting the flow of electrical power in said low air pressure switch power cable discontinuing the operation of a electrical powered air compressor, thereby achieving the predetermined amount of operational air pressure in the air chamber,
wherein should the predetermined amount of operational air pressure be lost in said air chamber, that underpressure condition will be sensed through the feed back loop members, thereafter said low air pressure switch will close at a predetermined pressure setting thereby energizing said electrical powered air compressor, the air pump member operation again being reactivated by:
(q) an underpressure event created by an upward motion of said piston assembly moving in response to a slow leakage failure by a upper piston seal and a lower piston seal, both seals being fail safe redundant members, a second operational condition being,
(b) an underpressure event created by a downward motion of said piston assembly moving in response to an rapid reaction of said piston assembly and said wheel unit due to an encounter with a substantial wheel unit wide depression in the road surface,
wherein any underpressure event caused by a collective failure of the piston seal members will urge the piston assembly to move upward in the said cylinder compartment providing an operational condition where a piston resilient material pad will be eventually juxtaposed upon the generally horizontally lower face of said cabin floorplate causing the upward motion of the piston assembly to cease while also providing a fail safe measure of shock absorption of road vibrations, and,
further still, the predetermined amount of operational air pressure for said air chamber may be alternately and manually initially supplied to said air chamber and thereafter be unregulated by either an onboard air pressure source, a external air pressure source, the provided air pressure flowing through the pressure loop members and thereafter being sensed through the feed back loop members which may be further interconnected to an air pressure gauge which may be conveniently located within said modular passenger semi trailer.

14. A fail safe, crashworthy said lower structure module according to claim 6, having disposed within, said cylinder compartment comprising:
the generally vertically disposed compartment members have congruent heights equal to the top faces of said right lower sideplate, said left lower sideplate, all compartment member top faces constituting said cylinder compartment portion of said single, top, flat production joint face of said lower structure module, the compartment becoming a closed box beam construct with the assemblage of the cabin floorplate member, disposed within said cylinder compartment there is said piston assembly comprising:
(a) a piston plate being of substantial size, formed of a generally, horizontally disposed plate having a exterior top profile closely congruent with the interior top profile of said cylinder compartment;
(b) a upper seal carrier being of substantial size, formed of an outwardly facing channel shaped flange having an exterior top profile closely congruent with said piston plate, the flange being juxtaposed, securely attached upon the generally, horizontally disposed top face of said piston plate;
(c) a upper seal being of substantial size and shape, being disposed within said upper seal carrier channel concavity, said upper seal being formed of an appropriate material, appropriate mechanism to prevent the loss of air pressure contained in said air chamber above said piston assembly;
(d) a lower seal carrier piston skirt being of substantial size, formed of an upper outwardly facing channel shaped flange portion having an exterior top profile closely congruent with said piston plate, said lower seal carrier piston skirt being juxtaposed, securely attached upon the generally, horizontally disposed bottom face of said piston plate; the lower piston skirt flange portion being formed and extending downwardly for an approximate distance of three times that of the height of the upper channel shaped flange portion of said lower seal carrier piston skirt;
(e) a lower seal being of substantial size and shape, being disposed within said lower seal carrier channel concavity, said lower seal being formed of an appropriate material, appropriate mechanism to prevent the loss of air pressure contained in said air chamber above said piston assembly;
(f) the first member of the unipoint construct comprising a piston socket being centrally disposed, securely affixed upon the bottom face of said piston plate, said piston socket having a downwardly facing concavity that accepts the upper convexed shaped portion of said truncated hemisphere, and,
(g) the second member of the unipoint construct comprising being congruently shaped, rotatably operative and compressively sandwiched within the downwardly facing concavity of said piston socket, said truncated hemisphere having a flat bottom portion which slidably operates upon the flat, upper face of a platform plate of the said wheel unit,
wherein
said air chamber contains a high air volume, low air pressure, the total force acting downwardly over said piston assembly the total force thereafter being centrally transmitted to the centrally disposed, unipoint said piston socket, unipoint said truncated hemisphere, both unipoint members moving articulately in response to a variety of motions of said wheel unit, both of the unipoint members not transmitting any torque upon said modular passenger semi trailer.

15. A fail safe, crashworthy said lower structure module according to claim 6, having disposed within the bottom portion said cylinder compartment comprising:
(a) a wheel unit bottom plate being generally horizontally disposed, generally rectangular in top cross sectional shape, forming the lowermost floor portion of said wheel unit upon which are abutted, securely attached a plurality of generally vertically disposed members;
(b) a wheel unit forward plate having juxtaposed, securely affixed to its aft face, congruently formed a bearing plate one, forward plate member having an appropriate clearance hole for a wheel unit shaft, the bearing plate one member having an appropriate bearing clearance hole for installation of a shaft bearing one, both clearance holes being concentric to one another and formed along a wheel unit longitudinal roll axis;
(c) a internal support plate one having juxtaposed, securely attached to its aft face, congruently formed a bearing plate two support plate one member having an appropriate clearance hole for said wheel unit shaft, the bearing plate two member having an appropriate bearing clearance hole for installation of a shaft bearing two, both clearance holes being concentric to one another and formed along a wheel unit longitudinal roll axis;
(d) a internal support plate two having juxtaposed, securely attached to its forward face, congruently formed bearing plate three support plate one member having an appropriate clearance hole for said wheel unit shaft, the bearing plate two member having an appropriate bearing clearance hole for installation of a shaft bearing two, both clearance holes being concentric to one another and formed along a wheel unit longitudinal roll axis;
(e) a wheel unit end plate having juxtaposed, securely affixed to its forward face, congruently formed a bearing plate four, forward plate member having an appropriate clearance hole for a wheel unit shaft, the bearing plate one member having an appropriate bearing clearance hole for installation of said shaft bearing four, both clearance holes being concentric to one another and formed along a wheel unit longitudinal roll axis;
(f) said wheel unit platform plate being generally horizontally disposed, generally square in top cross sectional shape, forming the central topmost portion of said wheel unit upon which are abutted, securely attached a plurality of generally vertically disposed support plate one, bearing plate two members abutting, securely affixed to forward edge of generally horizontally said wheel unit platform plate, both members being higher than forward plate, bearing plate one members, support plate two, bearing plate three members abutting, securely affixed to aft edge of generally horizontally said wheel unit platform plate, both members being higher than end plate, bearing plate four members,
(g) a wheel unit forward angled plate being generally horizontally disposed, generally rectangular in top cross sectional shape, forming the forward topmost portion, abutting, securely attached to forward edge of said wheel unit platform plate, sloping downward, abutting, securely attached to the topmost edges of said wheel unit forward plate, said bearing plate one;
(h) a wheel unit aft angled plate being generally horizontally disposed, generally rectangular in top cross sectional shape, forming the aft topmost portion, abutting, securely attached to aft edge of said wheel unit platform plate, sloping downward, abutting, securely attached to the topmost edges of said wheel unit end plate, said bearing plate four;
(i) a wheel unit right sideplate having a side cross sectional profile matching a plurality of edges for top platform plate, forward angled plate, forward plate, bottom plate, end plate and aft angled plate members, abutting, securely attached to this plurality of members forming said wheel unit being a closed box beam structure having a forward cavity, center cavity and aft cavity enclosures,
wherein said wheel unit is comprised of a three fixed through axle design, devoid of conventional suspension apparatus, devoid of conventional suspension hardware,:
(j) a axle tube one, a wheel axle one of fixed through axle design, both the tube and axle members transversely disposed and project out from clearance holes disposed in the lower central portion of forward cavity, the leftmost projection of said axle one supporting a wheel group one comprising dual wheels, tires and brake unit, the rightmost projection of said axle one supporting a wheel group two comprising dual wheels, tires and brake unit,
(k) a axle tube two, a wheel axle two of fixed through axle design, both the tube and axle members transversely disposed and project out from clearance holes disposed in the lower central portion of central cavity, the leftmost projection of said axle two supporting a wheel group three comprising dual wheels, tires and brake unit, the rightmost projection of said axle two supporting a wheel group four comprising dual wheels, tires and brake unit,
(l) a axle tube three, a wheel axle three of fixed through axle design, both the tube and axle members transversely disposed and project out from clearance holes disposed in the lower central portion of central cavity, the leftmost projection of said axle three supporting a wheel group five comprising dual wheels, tires and brake unit, the rightmost projection of said axle three supporting a wheel group six comprising dual wheels, tires and brake unit,
(m) a brake system air supply line comprising of a standard flexible hose assembly, disposed and securely attached to standard air inlet fitting on said wheel unit, the air supply line member supplying brake air pressure to the standard brake actuator units within said wheel unit.

16. A fail safe, crashworthy said lower structure module according to claim 6, having disposed within the bottom portion of said cylinder compartment, said wheel unit comprising:
(a) said wheel unit shaft, being pivotally disposed within said wheel unit, orientated along said wheel unit longitudinal roll axis, the support provided by a typical antifriction roller bearing,
wherein the four roller bearing members disposed in front to rear arrangement, said shaft bearing one disposed within clearance hole in said bearing plate one, said shaft bearing two disposed within clearance hole in said bearing plate two, said shaft bearing three disposed within clearance hole in said bearing plate three, said shaft bearing four disposed within clearance hole in said bearing plate four,
wherein the three shaft tubular spacer members disposed in a front to rear arrangement, pivotal slid over the shaft member provides positional retention of the bearing members, cooperatively defined as,
(b) a shaft tubular spacer one abutting, sandwiched between shaft bearing one, support plate one members, forward rim of spacer one member abutting a roller bearing inner race of the bearing one member,
(c) a shaft tubular spacer two abutting, sandwiched between shaft bearing two, shaft bearing three members, forward rim of spacer two member abutting a roller bearing inner race of the bearing one, bearing two members,
(d) a shaft tubular spacer three abutting, sandwiched between the support plate two members, forward rim of spacer three member abutting a roller bearing inner race of the bearing three member,
(e) said wheel unit shaft, having a forward disposed projection beyond said wheel unit forward plate, provides pivotally assembled a forward cam block, a forward shaft swivel block, the block members slidably assembled over shaft projection, tightened by a forward shaft nut a forward shaft threaded end, the nut member safetied by installation of a forward shaft nut tapered pin installed into a forward shaft tapered hole,
(f) the shaft member being held locationally captive in relationship with said lower structure module is provided by a right forward guideplate contact face being engaged, sandwiched into a forward cam block groove one, a left forward guideplate contact face being engaged, sandwiched into a forward cam block groove two,
(g) said wheel unit shaft, having a aft disposed projection beyond said wheel unit end plate, provides pivotally assembled a aft cam block, a aft shaft swivel block, both the block members slidably assembled over the shaft member, tightened by a aft shaft nut a aft shaft threaded end, the nut member safetied by installation of a aft shaft nut tapered pin installed into a aft shaft tapered hole,
(h) the shaft member being held locationally captive in relationship with said lower structure module is provided by a right aft guideplate contact face being engaged, sandwiched into a aft cam block groove one, a left aft guideplate contact face being engaged, sandwiched into a aft cam block groove two,
wherein a forward cam apex to aft cam apex distance for the cam block members is less than a forward guideplate contact face to aft guideplate contact face distance for the guideplate members provides a freedom of movement of the shaft member as it moves in response to various road face conditions,
wherein said wheel unit shaft assembled with the forward cam block, forward swivel block members being sandwiched, slidably operative between the forward guideplate members, the aft cam block, aft swivel block members being sandwiched, slidably operative between the aft guideplate members, provides said wheel unit with its captive positioning in the lower portion of said cylinder compartment is operatively described.

17. A fail safe, crashworthy said lower structure module according to claim 16, having disposed within the bottom portion of said cylinder compartment, the combined operating characteristics of the pneumatic unipoint suspension, wheel unit, wheel unit shaft and its external cam block, swivel block members comprises:
(a) said wheel unit shaft, being pivotally disposed within said wheel unit, orientated along said wheel unit longitudinal roll axis, support provided by a typical antifriction roller bearing,
(b) said wheel unit, cooperating with the unipoint suspension members, the forward guideplate, aft guideplate members do not utilize any conventional suspension apparatus, conventional suspension hardware;
(c) said wheel unit, is always disposed parallel to and orientated with said pendulous longitudinal axis datum line providing precise said wheel unit alignment with said modular passenger semi trailer as wheel unit member is pushed down the road as it cooperates with both aft guideplate members and while said modular passenger semi trailer completes vehicle turning events;
(d) during braking and acceleration events, due to close operational clearances provided by the cam block members in relationship to the guideplate members, said wheel unit never imparts any braking recoil, acceleration recoil to said modular passenger semi trailer
(e) during towing and turning events, said wheel unit cooperating with the unipoint suspension members, provided by the rotatable, slidable movements of the truncated hemisphere member, torque is never imparted to said modular passenger semi trailer,
(e) during towing and turning events, said wheel unit cooperating with the unipoint suspension members, provided by the rotatable, slidable movements of the truncated hemisphere member, the wheel unit member operates reciprocally along a wheel unit vertical axis within the lower portion of said cylinder compartment,
(f) during towing and turning events, said wheel unit cooperating with the unipoint suspension members, provided by the rotatable, slidable movements of the truncated hemisphere member and the guideplate members cooperating with the shaft cam block members, the wheel unit member operates along a wheel unit longitudinal roll axis, a wheel unit lateral axis within the lower portion of said cylinder compartment,
wherein
(g) the operating travel limits of the wheel unit member moving along said wheel unit lateral axis is provided by a forward shaft upper stop for the forward top limit, the topmost face of the mid baseplate member for the forward bottom limit, a aft shaft forward upper stop for an aft top limit, the topmost face of the aft baseplate member for the aft bottom limit.

18. A fail safe, crashworthy said lower structure module according to claim 6, an alternate embodiment, a modular freight semi trailer with a semi trailer flatbed module, a pneumatic unipoint suspension and a wheel unit disposed within a lower structure module, the improvement comprising:

19. A fail safe, crashworthy a modular vehicle with a upper structure module, one or more said pneumatic unipoint suspensions, one or more said wheel units disposed within said lower structure module, the improvement comprising:
(a) said modular vehicle is described and includes, but is not limited by, various vehicle types such as passenger semi trailers, industrial use semi trailers, busses, articulated busses, motorcoaches, passenger cars, taxicabs, sports utility vehicles, pickup trucks, trailers, trucks, passenger vans, cargo vans, motor homes, recreational vehicles, mobile homes, etc,
wherein vehicle length, said upper structure module can be configured for either passenger or industrial use, said upper structure module having a cabin floorplate section that will cover and seal the uppermost portions of the said lower structure module portion that contains at least one three compartment configuration, the configuration comprising a leading guideplate compartment, a cylinder compartment, a trailing guideplate compartment, the three compartments housing a reciprocally operative, pneumatic pistion assembly being contained in the upper portion of the cylinder compartment, the wheel unit being contained in the lower portion of the three compartments, said wheel unit having a wheel unit shaft and exterior shaft unit members mechanically intervening with the leading, trailing guideplate compartments,
wherein said cylinder compartment, said piston assembly can have a variety of top cross sectional profiles and sizes, the modular vehicle can also have one or more wheel units, any of which may be captively located in the lower portion of the cylinder compartment or allowed to swivel in the lower part of said cylinder compartment, the wheel unit can also be equipped internally with an engine and appropriate transmission which will power the modular vehicle along the road,
wherein the said unipoint suspension may be attached to the wheel unit below it by an appropriate apparatus which will allow the wheel unit to operate along its veritical, longitudinal and vertical axis.
